(19) United States
(12) Patent Application Publication
(10) Pub. No.: US 2014/0162693 A1
(43) Pub. Date: Jun. 12, 2014

(54) METHODS AND SYSTEMS FOR PROVIDING LOCATION BASED SERVICES IN A VENUE

(71) Applicant: QUALCOMM Incorporated, San Diego, CA (US)

(72) Inventors: Andreas Klaus Wachter, Menlo Park, CA (US); Stephen William Edge, Escondido, CA (US); Stuart W. Strickland, Hertfordshire (GB)

(73) Assignee: QUALCOMM Incorporated, San Diego, CA (US)

(21) Appl. No.: 13/917,616

(22) Filed: Jun. 13, 2013

Related U.S. Application Data
(60) Provisional application No. 61/689,926, filed on Jun. 15, 2012.
(60) Provisional application No. 61/732,883, filed on Dec. 3, 2012.
(60) Provisional application No. 61/735,511, filed on Dec. 10, 2012.
(60) Provisional application No. 61/801,591, filed on Mar. 15, 2013.

(51) Int. Cl. H04W 4/04

(52) U.S. Cl. CPC H04W 4/04
USPC 455/456.3

(57) ABSTRACT

Disclosed are systems, methods and devices for application of location based services in a venue using mobile centric and network centric positioning techniques. In particular, call message flows are described for specific use cases. In one particular implementation, a system obtains estimated locations of mobile devices to provide location aware content to applications hosted on the mobile devices. In another implementation, a system may gather statistics regarding mobile devices' entry into, departure from or movement within a venue for development of user analytics.

This application claims the benefit of priority to U.S. Provisional Patent Application Nos. 61/689,926 for “Optimized Indoor Location Server Provision and Discovery,” filed on Jun. 15, 2012, 61/732,883 for “Methods and Systems for Providing Location Based Services in an Indoor Venue,” filed on Dec. 3, 2012, and 61/735,511 for “Methods and Systems for Providing Location Based Services in an Indoor Venue,” filed on Dec. 10, 2012, and 61/801,591 for “Methods and Systems for Providing Location Based Services in an Indoor Venue,” filed on Mar. 15, 2013, the subject matter of which is incorporated herein by reference in their entirety.

### BRIEF DESCRIPTION

1. Field

Embodiments described herein are directed to application of efficient network architectures and message flows among devices to provide a location based service in a venue or other localized area.

2. Information

The global positioning system (GPS) and other like satellite and terrestrial positioning systems have enabled navigation services for mobile handsets in outdoor environments. Likewise, particular techniques for obtaining estimates of positions of mobile device in indoor environments may enable enhanced location based services in particular indoor venues such as residential, governmental or commercial venues.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1A is a system diagram illustrating certain features of a system containing a mobile device, in accordance with an implementation.

FIG. 1B is a system diagram illustrating certain features of an architecture for providing location based services in a venue according to an embodiment.

FIG. 1C is a system diagram illustrating certain features of an architecture for providing location based services in a venue according to an embodiment.

FIG. 2A is a flow diagram of aspects of a process to providing location aware content to a mobile device in a venue according to an embodiment.

FIG. 2B is a message flow diagram identifying events in connection with providing location aware content to a mobile device in a venue according to an embodiment.

FIG. 3A is a flow diagram of aspects of a process to collect visitor analytics for a venue according to an embodiment.

FIG. 3B is a message flow diagram identifying events in connection with collecting visitor analytics for a venue according to an embodiment.

FIG. 4A is a flow diagram of aspects of a process for network initiated positioning in a venue according to an embodiment.

FIG. 4B is a message flow diagram identifying events in connection with an example process for network initiated positioning according to an embodiment.

FIG. 5A is a flow diagram of aspects of a process for network initiated, mobile centric positioning in a venue according to an embodiment.

FIG. 5B is a message flow diagram identifying events in connection with network initiated, mobile centric positioning in a venue according to an embodiment.

FIG. 6A is a flow diagram of aspects of a process for mobile initiated, mobile centric positioning in a venue according to an embodiment.

FIG. 6B is a message flow diagram identifying events in connection with mobile initiated, mobile centric positioning according to an embodiment.

FIG. 6C is a message flow diagram identifying events in connection with network initiated positioning in a venue according to an embodiment.

FIG. 6D is a message flow diagram identifying events in connection with mobile centric network initiated positioning in a venue according to an embodiment.

FIG. 6E is a message flow diagram identifying events in connection with mobile centric mobile initiated positioning in a venue according to an embodiment.

FIG. 7 is a schematic diagram of a network including a location server capable of communicating with a location application server using a mobile location protocol (MLP) according to an embodiment.

FIG. 8 shows a layered protocol stack according to an embodiment.

FIGS. 9 through 11 show example messages flows between a location server and a location services client (LCS) according to an embodiment.

FIG. 12A is a message flow diagram illustrating a process of a method by one or more devices in accordance with an implementation.

FIGS. 12B-12D are flow diagrams of processes according to particular implementations.

FIGS. 12E-12P are message flow diagrams illustrating processes that may be used to implement certain use cases according to particular implementations.

FIG. 13 is a schematic block diagram illustrating an exemplary device, in accordance with an implementation.

FIG. 14 is a schematic block diagram of an example computing platform in accordance with an implementation.

### SUMMARY

Briefly, particular implementations are directed to a method comprising: transmitting one or more messages to at least a portion of an access/location network (ALN) to configure the ALN to obtain measurements in connection with one or more mobile devices entering a venue; receiving one or more measurement reports from said ALN comprising identifiers of mobile devices entering the venue and measurements associated with said identifiers; computing estimated locations of the mobile devices entering the venue based, at least in part, on said measurements; and transmitting a location report to an application server comprising said estimated locations to initiate delivery of location aware content to said mobile devices.

Another particular implementation is directed to an apparatus comprising: a communication interface (i/f) to transmit messages to and receive message from a communication network; and one or more processors to: initiate transmission of one or more messages through said communication interface to at least a portion of an access/location network (ALN) to configure the ALN to obtain measurements in connection with one or more mobile devices entering a venue; obtain one or more measurement reports received at said communication interface from said ALN comprising identifiers of mobile devices entering the venue and measurements associated with said identifiers; compute estimated locations of the mobile devices entering the venue based, at least in part, on said measurements; and initiate transmission of a location report through said communication interface to an application server comprising said estimated locations to initiate delivery of location aware content to said mobile devices.

Another particular implementation is directed to an article comprising: a non-transitory storage medium comprising machine-readable instructions stored thereon which are executable by a special purpose computing apparatus to: initiate transmission of one or more messages to at least a portion of an access/location network (ALN) to configure the ALN to obtain measurements in connection with one or more mobile devices entering a venue; obtain one or more measurement reports received from said ALN comprising identifiers of mobile devices entering the venue and measurements associated with said identifiers; compute estimated locations of the mobile devices entering the venue based, at least in part, on said measurements; and initiate transmission of a location report to an application server comprising said estimated locations to initiate delivery of location aware content to said mobile devices.

Another particular implementation is directed to an apparatus comprising: means for transmitting one or more messages to at least a portion of an access/location network (ALN) to configure the ALN to obtain measurements in connection with one or more mobile devices entering a venue; means for receiving one or more measurement reports from said ALN comprising identifiers of mobile devices entering the venue and measurements associated with said identifiers; means for computing estimated locations of the mobile devices entering the venue based, at least in part, on said measurements; and means for transmitting a location report to an application server comprising said estimated locations to initiate delivery of location aware content to said mobile devices.

Another particular implementation is directed to a method comprising: transmitting one or more messages to at least a portion of an access/location network (ALN) to configure the ALN to obtain measurements in connection with mobile devices entering a venue; receiving one or more measurement reports from said ALN comprising identifiers of mobile devices entering the venue and measurements associated with said identifiers; computing estimated locations of the mobile devices entering the venue based, at least in part, on said measurements; and transmitting a location report to an application server comprising said estimated locations for use in generating visitor analytics for said venue.

Another particular implementation is directed to an apparatus comprising: a communication interface to transmit messages to and receive message from a communication network; and one or more processors to: initiate transmission of one or more messages through said communication interface to at least a portion of an access/location network (ALN) to configure the ALN to obtain measurements in connection with mobile devices entering a venue; obtain one or more measurement reports received at said communication interface from said ALN comprising identifiers of mobile devices entering the venue and measurements associated with said identifiers; compute estimated locations of the mobile devices entering the venue based, at least in part, on said measurements; and initiate transmission of a location report through said communication interface to an application server comprising said estimated locations for use in generating visitor analytics for said venue.

Another particular implementation is directed to an article comprising: a storage medium comprising machine-readable instructions stored thereon which are executable by a special purpose computing apparatus to: initiate transmission of one or more messages to at least a portion of an access/location network (ALN) to configure the ALN to obtain measurements in connection with mobile devices entering a venue; obtain one or more measurement reports received from said ALN comprising identifiers of mobile devices entering the venue and measurements associated with said identifiers; compute estimated locations of the mobile devices entering the venue based, at least in part, on said measurements; and initiate transmission of a location report to an application server comprising said estimated locations for use in generating visitor analytics for said venue.

Another particular implementation is directed to an apparatus comprising: means for transmitting a subsequent one or more messages to the at least a portion of the ALN to configure the ALN to obtain subsequent measurements; means for receiving one or more subsequent measurement reports in response to said subsequent one or more messages; means for computing updated estimated locations of the mobile devices entering the venue based, at least in part, on said measurements; and means for transmitting an intermediate location report to the application server comprising said updated estimated locations.

Another particular implementation is directed to a method comprising: transmitting one or more messages to at least a portion of an access/location network (ALN) to configure the ALN to detect mobile devices entering a venue; receiving one or more reports from said ALN comprising identifiers of one or more mobile devices entering the venue; transmitting one or more messages to at least one of said mobile devices to invoke a positioning session with the at least one of said mobile devices based, at least in part, on said identifiers; obtaining one or more estimated locations of said at least one of said mobile device from said positioning session; and transmitting a location report to an application server comprising said one or more estimated locations to initiate delivery of location aware content to said mobile devices.

Another particular implementation is directed to an apparatus comprising: a communication interface to transmit messages to and receive message from a communication network; one or more processors to: initiate transmission of one or more messages through said communication interface to at least a portion of an access/location network (ALN) to configure the ALN to detect mobile devices entering a venue; obtain one or more reports received at said communication interface from said ALN comprising identifiers of one or more mobile devices entering the venue; initiate transmission of one or more messages through said communication interface to at least one of said mobile devices to invoke a positioning session with the at least one of said mobile devices based, at least in part, on said identifiers; obtain one or more estimated locations of said at least one of said mobile device from said positioning session; and initiate transmission of a location report through said communication interface to an application server comprising said one or more estimated locations to initiate delivery of location aware content to said mobile devices.

Another particular implementation is directed to an article comprising: a storage medium comprising machine-readable instructions stored thereon which are executable by a special purpose computing apparatus to: initiate transmission of one or more messages to at least a portion of an access/location network (ALN) to configure the ALN to detect mobile devices entering a venue; obtain one or more reports received from said ALN comprising identifiers of one or more mobile devices entering the venue; initiate transmission of one or more messages to at least one of said mobile devices to invoke a positioning session with the at least one of said mobile devices based, at least in part, on said identifiers; obtain one or more estimated locations of said at least one of said mobile device from said positioning session; and initiate transmission of a location report to an application server comprising said one or more estimated locations to initiate delivery of location aware content to said mobile devices.

Another particular implementation is directed to a method comprising: transmitting one or more messages to at least a portion of an access/location network (ALN) to configure the ALN to detect mobile devices entering a venue; receiving one or more reports from said ALN comprising identifiers of mobile devices entering the venue; transmitting one or more messages to at least one of said mobile devices to invoke a positioning session with the at least one mobile device based, at least in part, on said identifiers; obtaining one or more estimated locations of the at least one mobile device from said positioning session; transmitting a report to an application server including the one or more estimated locations; and receiving one or more request messages from the application server requesting periodic updates of the estimated location.

Another particular implementation is directed to an apparatus comprising: a communication interface to transmit messages to and receive message from a communication network; one or more processors to: initiate transmission of one or more messages through said communication interface to at least a portion of an access/location network (ALN) to configure the ALN to detect mobile devices entering a venue; obtain one or more reports received at said communication interface from said ALN comprising identifiers of mobile devices entering the venue; initiate transmission of one or more messages through said communication interface to at least one of said mobile devices to invoke a positioning session with the at least one mobile device based, at least in part, on said identifiers; obtain one or more estimated locations of the at least one mobile device from said positioning session; initiate transmission of a report through a communication interface to an application server including the one or more estimated locations; and obtain one or more request messages at said communication interface from the application server requesting periodic updates of the estimated location.

Another particular implementation is directed to an article comprising: a storage medium comprising machine-readable instructions stored thereon which are executable by a special purpose computing apparatus to: initiate transmission of one or more messages to at least a portion of an access/location network (ALN) to configure the ALN to detect mobile devices entering a venue; obtain one or more reports received from said ALN comprising identifiers of mobile devices entering the venue; initiate transmission of one or more messages to at least one of said mobile devices to invoke a positioning session with the at least one mobile device based, at least in part, on said identifiers; obtain one or more estimated locations of the at least one mobile device from said positioning session; initiate transmission of a report to an application server including the one or more estimated locations; and obtain one or more request messages at said communication interface from the application server requesting periodic updates of the estimated location.

Another particular implementation is directed to an apparatus comprising: means for transmitting one or more messages to at least a portion of an access/location network (ALN) to configure the ALN to detect mobile devices entering a venue; means for receiving one or more reports from said ALN comprising identifiers of mobile devices entering the venue; means for transmitting one or more messages to at least one of said mobile devices to invoke a positioning session with the at least one mobile device based, at least in part, on said identifiers; means for obtaining one or more estimated locations of the at least one mobile device from said positioning session; means for transmitting a report to an application server including the one or more estimated locations; and means for receiving one or more request messages from the application server requesting periodic updates of the estimated location.

Another particular implementation is directed to a method comprising, at a mobile device: detecting entry of said mobile device into a venue; at an application hosted on the mobile device, requesting a location engine on the mobile device to request an estimated location of the mobile device in response to detecting said entry; at the location engine, initiating a positioning session with a remote location server to obtain said estimated location and providing the estimated location to the application in a location response; transmitting a service request message to a remote application server including said estimated location and an identifier of said application; and receiving location aware content from said remote application server in response to said service request message.

Another particular implementation is directed to a mobile device comprising: a transceiver to transmit messages to and receive messages from a wireless communication network; and one or more processors to: detect entry of said mobile device into a venue; request a location engine on the mobile device to request an estimated location of the mobile device in response to detecting said entry; at the location engine, initiate a positioning session with a remote location server to obtain said estimated location and provide the estimated location to the in a location response; initiate transmission of a service request message through said transceiver to a remote application server including said estimated location and an identifier of said application; and obtain location aware content received through said transceiver from said remote application server in response to said service request message.

Another particular implementation is directed to an article comprising: a storage medium comprising machine-readable instructions stored thereon which are executable by a special purpose computing apparatus of a mobile device to: detect entry of said mobile device into a venue; request a location engine on the mobile device to request an estimated location of the mobile device in response to detecting said entry; at the location engine, initiate a positioning session with a remote location server to obtain said estimated location and provide the estimated location to the in a location response; initiate transmission of a service request message to a remote application server including said estimated location and an identifier of said application; and obtain location aware content received from said remote application server in response to said service request message.

Another particular implementation is directed to a mobile device comprising: means for detecting entry of said mobile device into a venue; means for requesting a location engine on the mobile device to request an estimated location of the mobile device in response to detecting said entry; at the location engine, means for initiating a positioning session with a remote location server to obtain said estimated location and means for providing the estimated location to the application in a location response; means for transmitting a service request message to a remote application server including said estimated location and an identifier of said application; and means for receiving location aware content from said remote application server in response to said service request message.

Another particular implementation is directed to a method for providing location services in a venue at a Location Based Services Application Server (LBS AS) comprising: transmitting one or more messages to a location server (LS) to configure the LS to detect a presence of a mobile device in the venue; receiving one or more messages from the LS comprising location parameters indicative of a location of the mobile device; and providing location services based on the obtained location parameters.

Another particular implementation is directed to a Location Based Services Application Server (LBS AS) comprising: a communication interface to transmit messages to and receive messages from a communication network; one or more processors to: initiate transmission of one or more messages through said communication interface to a location server (LS) to configure the LS to detect a presence of a mobile device in a venue; obtain one or more messages received at said communication interface from the LS comprising location parameters indicative of a location of the mobile device; and initiate provisioning of location services based on the obtained location parameters.

Another particular implementation is directed to an article comprising: a non-transitory storage medium comprising machine-readable instructions stored thereon which are executable by a special purpose computing apparatus of a Location Based Application Server (LBS AS) to: initiate transmission of one or more messages through a communication network to a location server (LS) to configure the LS to detect a presence of a mobile device in a venue; obtain one or more messages received from the LS through the communication network comprising location parameters indicative of a location of the mobile device; and initiate provisioning of location services based, at least in part, on the obtained location parameters.

Another particular implementation is directed to a Location Based Services Application Server (LBS AS) comprising: means for transmitting one or more messages to a location server (LS) to configure the LS to detect a presence of a mobile device in the venue; means for receiving one or more messages from the LS comprising location parameters indicative of a location of the mobile device; and means for providing location services based on the obtained location parameters.

Another particular implementation is directed to a method for providing location services in a venue at a Location Server (LS) comprising: receiving one or more messages from Location Based Services Application Server (LBS AS) comprising instructions to configure said LS to at least detect a presence of one or more mobile devices in said venue; transmitting one or more messages to at least a portion of an access/location network (ALN) to configure said ALN to detect said presence of said at least one of the one or more mobile devices in the venue based, at least in part, on said instructions; receiving one or more messages from said ALN comprising first location information sent by the ALN, said first location information being indicative of a location of at least one of the one or more mobile devices; obtaining second location of the at least one of the one or more mobile devices based, at least in part, on the first location information; and returning second location information to the LBS AS.

Another particular implementation is directed to location server (LS) comprising: a communication interface to transmit messages to and receive message from a communication network; and one or more processors to: obtain one or more messages received at said communication interface from a Location Based Services Application Server (LBS AS), said received messages comprising instructions to configure said LS to at least detect a presence of one or more mobile devices in said venue; initiate transmission of one or more messages through said communication interface to at least a portion of an access/location network (ALN) to configure said ALN to detect said presence of said at least one of the one or more mobile devices in the venue based, at least in part, on said instructions; obtain one or more messages received at said communication interface from said ALN comprising first location information sent by the ALN, said first location information being indicative of a location of at least one of the one or more mobile devices; obtain second location information of the at least one of the one or more mobile devices based, at least in part, on the first location information; and initiate transmission of second location information to the LBS AS comprising said estimated location based, at least in part, on said first location information.

Another particular implementation is directed to an article comprising: a non-transitory storage medium comprising machine-readable instructions stored thereon which are executable by a special purpose computing apparatus to: initiate transmission of one or more messages to a location server (LS) to configure the LS to detect a presence of a mobile device in the venue; obtain one or more messages received from the LS comprising location parameters indicative of a location of the mobile device; and initiate provision of location services based on the obtained location parameters.

Another particular implementation is directed to a Location Based Services Application Server (LBS AS) comprising: means for transmitting one or more messages to a location server (LS) to configure the LS to detect a presence of a mobile device in the venue; means for receiving one or more messages from the LS comprising location parameters indicative of a location of the mobile device; and means for providing location services based on the obtained location parameters.

Another particular implementation is directed to a method for obtaining a location service in a venue by a mobile device comprising: registering said mobile device with a Location Based Services Application Server (LBS AS); detecting entry of the mobile device to the venue; sending a service request message to the LBS AS in response to detecting the entry; engaging in a positioning session with a location server (LS), wherein the location server obtains an estimate of a location of the mobile device; and receiving the location service from the LBS AS based, at least in part, on said estimate of said location of the mobile device.

Another particular implementation is directed to a mobile device comprising: a transceiver to transmit messages to and receive messages from a communication network; one or more processors to: initiate transmission of one or more messages through said transceiver to register said mobile device with a Location Based Services Application Server (LBS AS); detect entry of the mobile device to a venue; initiate transmission of a service request message through said transceiver to a location base service application server (LBS AS) in response to detecting the entry; engage in a positioning session with a location server (LS), wherein the location server obtains an estimate of a location of the mobile device; and receive the location service from the LBS AS based, at least in part, on said estimate of said location of the mobile device.

Another particular implementation is directed to an article comprising: a storage medium comprising machine-readable instructions stored thereon which are executable by a special purpose computing apparatus of a mobile device to: register said mobile device with a Location Based Services Application Server (LBS AS); detect entry of the mobile device to the venue; initiate transmission of a service request message to the LBS AS in response to detecting the entry; engage in a positioning session with a location server (LS), wherein the location server obtains an estimate of a location of the mobile device; and receive the location service from the LBS AS based, at least in part, on said estimate of said location of the mobile device.

Another particular implementation is directed to an apparatus comprising: means for registering said mobile device with a Location Based Services Application Server (LBS AS); means for detecting entry of the mobile device to the venue; means for sending a service request message to the LBS AS in response to detecting the entry; means for engaging in a positioning session with a location server (LS), wherein the location server obtains an estimate of a location of the mobile device; and means for receiving the location service from the LBS AS based, at least in part, on said estimate of said location of the mobile device.

It should be understood that the aforementioned implementations are merely example implementations, and that claimed subject matter is not necessarily limited to any particular aspect of these example implementations.

### DETAILED DESCRIPTION

A number of location solutions may be used to support an ability to locate a mobile device, such a mobile wireless device that may be a cellphone, smartphone, tablet, laptop, tracking device or some other device. Knowing the location of a mobile device may enable certain services and applications such as services and applications that support an emergency call, navigation or direction finding, just to name a few. Location solutions that support reliable and accurate location of a mobile device in an outdoor environment may include the Secure User Plane Location (SUPL) solution defined by the Open Mobile Alliance (OMA) and various control plane solutions defined by the 3^{rd} Generation Partnership Project (3GPP) and the 3^{rd} Generation Partnership Project 2 (3GPP2). Whereas user plane solutions such as SUPL may rely on data transport (e.g. using TCP/IP) for communication between or among supporting entities, control plane solutions such as those defined by 3GPP and 3GPP2 may rely on signaling interfaces and signaling protocols in existing communications (e.g. wireless networks) to support most or all of such communication. These existing location solutions may rely substantially on positioning methods such as Assisted Global Navigation Satellite System (A-GNSS), Observed Time Difference of Arrival (OTDOA), Advanced Forward Link Trilateration (AFLT) and Enhanced Cell ID (E-CID), wherein a target mobile device that is being positioned makes measurements of radio signals received from satellite vehicles (e.g. for A-GNSS) or wireless network base stations (e.g. for OTDOA, AFLT and E-CID). The target mobile device may then either compute a location estimate from these measurements or transfers the measurements to a location server which computes a location estimate. Prior to measurements being obtained at a target mobile device, a location server may transfer positioning assistance data to the target mobile device to enable the mobile device to acquire and measure radio signals for use in positioning operations and, in some cases, to compute a location estimate based on the measurements. In order to provide assistance data and, as needed, compute a location estimate from measurements provided by a target mobile device, a location server may further employ data related to one more GNSS systems and/or to one or more base stations in a wireless network. GNSS related data may include satellite almanac and ephemeris data and data related to ionospheric and tropospheric delays. GNSS related data may also be applicable to a large region (e.g. a state, country or even the entire World) while base station data may be provisioned for part of or all of a wide area network, and may similarly be valid for a large region such as a state or country. Location services may then be supported based, at least in part, on location determination by a mobile device or location server. Location services, while possibly strongly related to the immediate location of a target mobile device, may be applicable and usable over a large area such as a city, state or country. Thus, the data that may be needed in a location server to support determination of a location estimate and the usability of the subsequent location estimates need not be confined to a small area but may apply to a large area such as a city, state or country.

In contrast, if accurate and reliable location is particularly valued in a venue which may be an indoor environment or a mixed indoor and outdoor environment like a shopping mall, hospital, library, museum, college campus, airport etc., existing position methods and existing location services may no longer be effective. For example, position methods like A-GNSS, AFLT, OTDOA and E-CID may not be accurate and reliable indoors due to signal attenuation, reflection and scattering from buildings, walls and ceilings. Instead, different position methods that may make use of measurements made by a target mobile device of radio signals from access points (APs) used for communication indoors such as WiFi and Bluetooth (BT) APs may enable more accurate and reliable location estimates as ready access to such signals may be available from a large number of such APs inside a venue. However, assistance data enabling measurement of such signals and computation of a location estimate may now be specific to a particular venue and not be widely available (e.g., if the assistance data is proprietary to a venue owner or a location provider for a venue and is not made public or otherwise provided to other location providers. In addition, while certain location services (like navigation and direction finding) used outdoors may continue to be utilized inside a venue, the data to make such services work optimally may rely heavily on knowledge of the particular venue (e.g. may require knowledge of floor plans, building layouts, room assignments, exits and entrances, staircases and elevators, etc.). The specialist and possibly restricted assistance data and other data needed to support positioning and location services inside a venue may not be ideally supported by existing location solutions such as OMA SUPL but may instead require new solutions or extensions to existing solutions.

As discussed below, particular network architectures and message flows may enable efficient provisioning of location based services in particular illustrated use cases. Particular network architectures and message flows may be tailored to specific types of positioning applied in a particular venue including network centric positioning, mobile centric (network initiated) positioning and mobile centric (mobile initiated) positioning. For example, particular message flows may be directed to detection and tracking of devices entering a venue and provision of services to a device based on an estimate of its current location, location history and/or expected or intended future location.

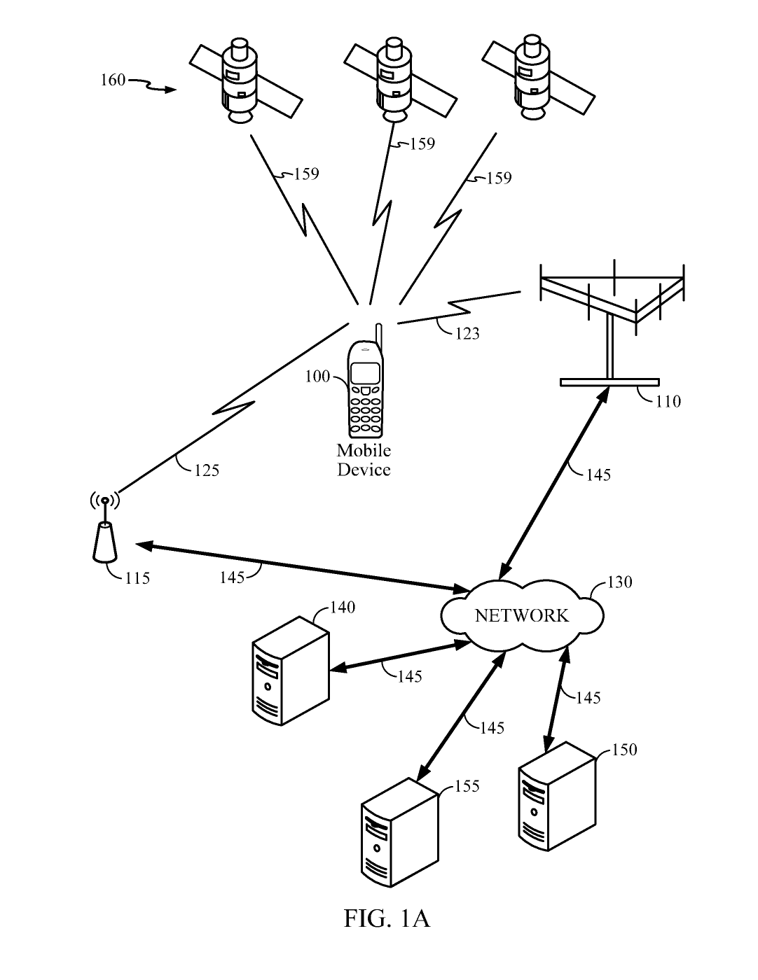

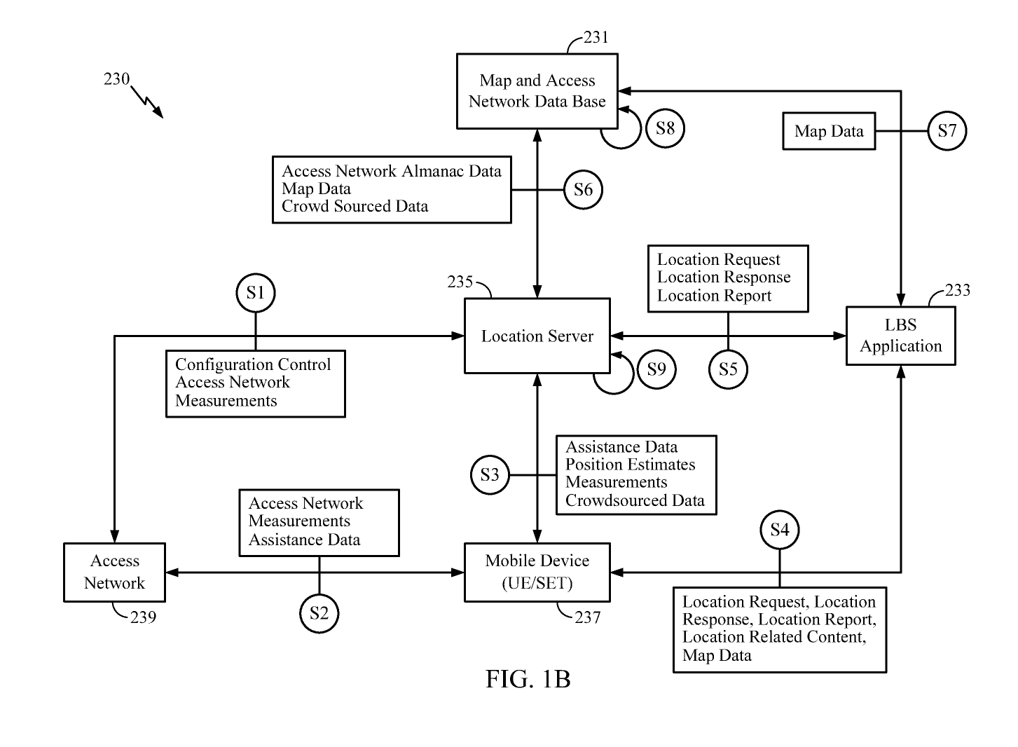

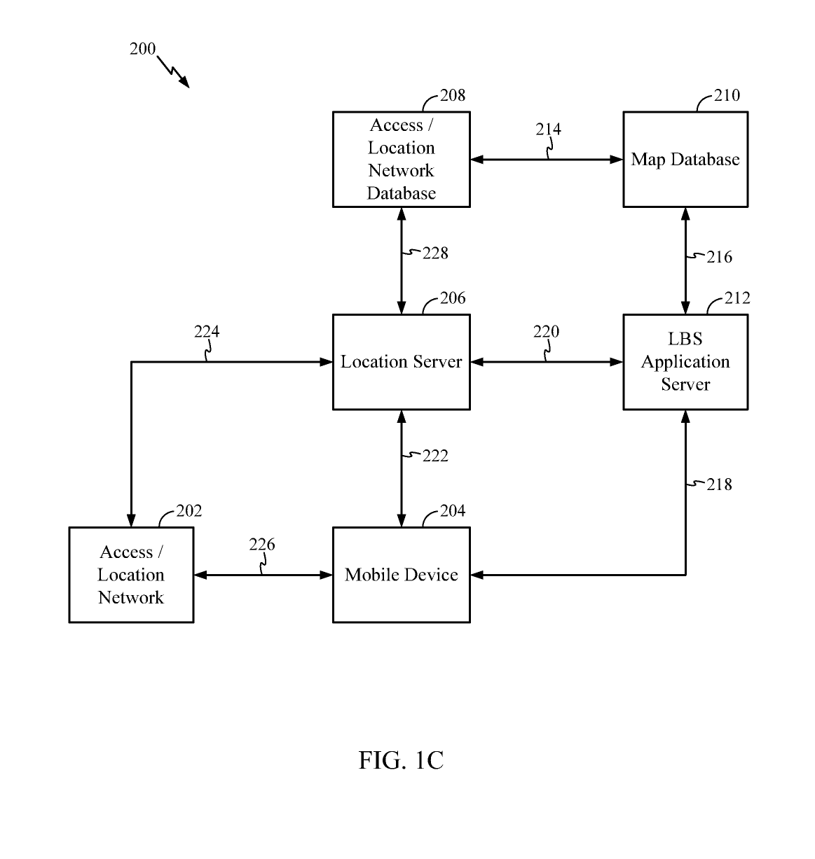

In certain implementations, as shown in FIG. 1A, a mobile device 100 may receive or acquire satellite positioning system (SPS) signals 159 from SPS satellites 160. In some embodiments, SPS satellites 160 may be from one GNSS, such as the US Global Positioning System (GPS), the European Galileo system or the Russian Glonass system. In other embodiments, the SPS Satellites may be from multiple GNSS such as, but not limited to, GPS, Galileo, Glonass, or Beidou (Compass) satellite systems. In other embodiments, SPS satellites may be from any one several regional navigation satellite systems (RNSs) such as, for example, Wide Area Augmentation System (WAAS), European Geostationary Navigation Overlay Service (EGNOS), Quasi-Zenith Satellite System (QZSS), just to name a few examples.

In addition, or alternatively, mobile device 100 may transmit radio signals to, and receive radio signals from, a wireless communication network. In one example, mobile device 100 may communicate with a cellular communication network by transmitting wireless signals to, or receiving wireless signals from, base station transceiver 110 over wireless communication link 123. Similarly, mobile device 100 may transmit wireless signals to, or receive wireless signals from local transceiver 115 over wireless communication link 125.

In a particular implementation, local transceiver 115 may be configured to communicate with mobile device 100 at a shorter range over wireless communication link 125 than at a range enabled by base station transceiver 110 over wireless communication link 123. For example, local transceiver 115 may be positioned in an indoor environment. Local transceiver 115 may comprise an AP and may provide access to a wireless local area network (WLAN, e.g., IEEE 802.11 network) or wireless personal area network (WPAN, e.g., Bluetooth network). In another example implementation, local transceiver 115 may comprise a femto cell transceiver or home base station capable of facilitating communication on wireless communication link 125 according to a cellular communication protocol. Of course it should be understood that these are merely examples of networks that may communicate with a mobile device over a wireless link, and claimed subject matter is not limited in this respect.

Examples of network technologies that may support wireless communication link 123 are Global System for Mobile Communications (GSM), Code Division Multiple Access (CDMA), Wideband CDMA (WCDMA), Long Term Evolution LTE), High Rate Packet Data (HRPD). GSM, WCDMA and LTE are technologies defined by 3GPP. CDMA and HRPD are technologies defined by 3GPP2. Examples of radio technologies that may support wireless communication link 125 are IEEE 802.11 and BT in the case that local transceiver 115 is an AP and CDMA, LTE, WCDMA and HRPD in the case that local transceiver 115 is a femto cell or home base station.

In a particular implementation, base station transceiver 110 and local transceiver 115 may communicate with servers 140, 150 and/or 155 over a network 130 through links 145. Here, network 130 may comprise any combination of wired or wireless links and may include base station transceiver 110 and/or local transceiver 115 and/or servers 140, 150 and 155. In a particular implementation, network 130 may comprise Internet Protocol (IP) infrastructure capable of facilitating communication between mobile device 100 and servers 140, 150 or 155 through local transceiver 115 or base station transceiver 110. In another implementation, network 130 may comprise cellular communication network infrastructure such as, for example, a base station controller or packet based or circuit based switching center (not shown) to facilitate mobile cellular communication with mobile device 100. In a particular implementation, network 130 may comprise local area network (LAN) elements such as WiFi APs, routers and bridges and may in that case include or have links to gateway elements that provide access to wide area networks such as the Internet. In other implementations, network 130 may be a LAN and may or may not have access to a wide area network but may not provide any such access (if supported) to mobile device 100. In some implementations network 130 may comprise multiple networks (e.g., one or more wireless networks and/or the Internet).

In particular implementations, and as discussed below, mobile device 100 may have circuitry and processing resources capable of computing a position fix or estimated location of mobile device 100. For example, mobile device 100 may compute a position fix based, at least in part, on pseudorange measurements to four or more SPS satellites 160. Here, mobile device 100 may compute such pseudorange measurements based, at least in part, on pseudorange code phase detections in signals 159 acquired from four or more SPS satellites 160. In particular implementations, mobile device 100 may receive from server 140, 150 or 155 positioning assistance data to aid in the acquisition of signals 159 transmitted by SPS satellites 160 including, for example, almanac, ephemeris data, Doppler search windows, just to name a few examples.

In other implementations, mobile device 100 may obtain a position fix by processing signals received from terrestrial transmitters fixed at known locations (e.g., such as base station transceiver 110) using any one of several techniques such as, for example, AFLT OTDOA. In these particular techniques, pseudoranges or timing differences may be measured at mobile device 100 relative to three or more of such terrestrial transmitters fixed at known locations based, at least in part, on pilot or other positioning related signals transmitted by the transmitters and received at mobile device 100. Here, servers 140, 150 or 155 may be capable of providing positioning assistance data to mobile device 100 including, for example, information on signals to be measured (e.g., signal timing) and locations and identities of terrestrial transmitters to facilitate positioning techniques such as AFLT and OTDOA. For example, servers 140, 150 or 155 may include a base station almanac (BSA) which indicates locations and identities of cellular base stations and/or APs in a particular region or regions such as a particular venue and may provide information related to base station and AP transmitted signals such as transmission power and signal timing.

A mobile device (e.g. mobile device 100 in FIG. 1A) may be referred to as a device, a wireless device, a mobile terminal, a terminal, a mobile station (MS), a user equipment (UE), a SUPL Enabled Terminal (SET) or by some other name and may correspond to a cellphone, smartphone, laptop, tablet, PDA, tracking device or some other portable or moveable device. Typically, though not necessarily, a mobile device may support wireless communication such as using GSM, WCDMA, LTE, CDMA, HRPD, WiFi, BT, WiMax etc. A mobile device may also support wireless communication using a LAN, DSL or packet cable for example. A mobile device may be a single entity or may comprise multiple entities such as in a personal area network where a user may employ audio, video and/or data I/O devices and/or body sensors and a separate wireline or wireless modem. The location of a mobile device (e.g., mobile device 100) may be referred to as a location estimate, position or position estimate and may be geographic and thereby provide location coordinates for the mobile device (e.g., latitude and longitude) which may or may not include an altitude component (e.g., height above sea level, height above or depth below ground level, floor level or basement level). Alternatively, a location of a mobile device may be expressed as a civic location (e.g. as a postal address or the designation of some point or small area in a building such as a particular room or floor). A location of a mobile device may also be expressed as an area or volume (defined either geographically or in civic form) within which the mobile device is expected to be located with some probability or confidence level (e.g., 67% or 95%). A location of a mobile device may further be a relative location comprising, for example, a distance and direction or relative X, Y (and Z) coordinates defined relative to some origin at a known location which may be defined geographically or in civic terms or by reference to a point, area or volume indicated on a map, floor plan or building plan. In the description contained herein, the use of the term location may comprise any of these variants unless indicated otherwise.

The network architecture described previously in relation to FIG. 1A may be considered as a generic architecture that can fit a variety of outdoor and indoor location solutions including the standard OMA SUPL and 3GPP and 3GPP2 control plane location solutions. For example, server 140 may function as a SUPL location platform (SLP) to support the SUPL location solution or as an enhanced Serving Mobile Location Center (E-SMLC) to support the 3GPP control plane location solution with LTE access on wireless communication link 123 or 125. However, as described above, such frameworks for obtaining a location solution and the positioning methods they support may not be effective to support location services in an indoor environment or mixed indoor and outdoor environment of particular venues. Hence adaptations to the architecture shown in FIG. 1A and to the positioning methods that are supported may be as described further on herein.

In particular environments such as indoor environments or urban canyons, mobile device 100 may not be capable of acquiring signals 159 from a sufficient number of SPS satellites 160 to perform positioning according to the A-GNSS position method and may not receive signals from a sufficient number of base station transceivers 110 to perform AFLT or OTDOA to compute a position fix. In these circumstances, mobile device 100 may be capable of computing a position fix based, at least in part, on signals acquired from local transmitters (e.g., local transceiver 115 such as WLAN access points positioned at known locations). For example, mobile devices may obtain a position fix by measuring ranges to three or more indoor terrestrial wireless access points which are positioned at known locations. Such ranges may be measured, for example, by obtaining a Media Access Control (MAC) ID address from signals received from such access points and obtaining range measurements to the access points by measuring one or more characteristics of signals received from such access points such as, for example, received signal strength (RSSI) or round trip time (RTT) for signal propagation to and from an AP. In alternative implementations, mobile device 100 may obtain an indoor position fix by applying characteristics of acquired signals to a radio map indicating expected RSSI and/or RTT values at particular locations in an indoor area. In particular implementations, a radio map may associate identities of local transmitters (e.g., a MAC address which is discernible from a signal acquired from a local transmitter), expected RSSI from signals transmitted by the identified local transmitters, an expected RTT from the identified transmitters, and possibly standard deviations from these expected RSSI or RTT. In alternative implementations, angles of arrival or departure may be used in lieu of or in combination with measurements of range or signature recognition in a radio map for estimating a location of a mobile device. It should be understood, however, that these are merely examples of values that may be stored in a radio map, and that claimed subject matter is not limited in this respect.

In particular implementations, mobile device 100 may receive positioning assistance data for indoor positioning operations from one or more of servers 140, 150 or 155. For example, such positioning assistance data may include locations and identities of transmitters positioned at known locations to enable measuring ranges to these transmitters based, at least in part, on a measured RSSI and/or RTT, for example. Other positioning assistance data to aid indoor positioning operations may include radio maps, magnetic maps, locations and identities of transmitters, routeability graphs, building layouts and floor plans indicating permitted locations, common locations and improbable locations (e.g. associated with walls and building infrastructure) just to name a few examples. Other positioning assistance data received by the mobile device may include, for example, local maps of indoor areas for display or to aid in navigation. Such a map may be provided to mobile device 100 as mobile device 100 enters a particular indoor area. Such a map may show indoor features such as doors, hallways, entry ways, walls, etc., points of interest such as bathrooms, pay phones, room names, stores, etc. By obtaining and displaying such a map, a mobile device may overlay a current location of the mobile device (and user) over the displayed map to provide the user with additional context.

In one implementation, a routeability graph and/or digital map may assist mobile device 100 in defining feasible areas for navigation within an indoor area and subject to physical obstructions (e.g., walls) and passage ways (e.g., doorways in walls). Here, by defining feasible areas for navigation, mobile device 100 may apply constraints to aid in the application of filtering measurements for estimating locations and/or motion trajectories according to a motion model (e.g., according to a particle filter and/or Kalman filter). In addition to measurements obtained from the acquisition of signals from local transmitters, according to a particular embodiment, mobile device 100 may further apply a motion model to measurements or inferences obtained from inertial sensors (e.g., accelerometers, gyroscopes, magnetometers, etc.) and/or environment sensors (e.g., temperature sensors, microphones, barometric pressure sensors, ambient light sensors, camera imager, etc.) in estimating a location, change of location or motion state of mobile device 100.

According to an embodiment, mobile device 100 may access indoor navigation assistance data through servers 140, 150 or 155 by, for example, requesting the indoor assistance data through selection of a universal resource locator (URL). In particular implementations, servers 140, 150 or 155 may be capable of providing indoor navigation assistance data to cover many different indoor areas including, for example, floors of buildings, wings of hospitals, terminals at an airport, portions of a university campus, areas of a large shopping mall, just to name a few examples. Also, memory resources at mobile device 100 and data transmission resources may make receipt of indoor navigation assistance data for all areas served by servers 140, 150 or 155 impractical or infeasible. A request for indoor navigation assistance data from mobile device 100 may then indicate a rough or course estimate of a location of mobile device 100. Mobile device 100 may then be provided with indoor navigation assistance data covering areas including and/or proximate to the rough or course estimate of the location of mobile device 100 which may reduce the memory requirements of mobile device 100 and use of data transmission resources while still providing mobile device 100 with valuable navigation and other positioning assistance data.

In another implementation, server 140 may provide an expected transmission power level of local transceiver 115 to many devices that may include, but not necessarily be limited to, mobile device 100. Mobile device 100 may determine a separate transmission power level of local transceiver 115 by measuring a travel time of a signal transmitted between mobile device 100 and local transceiver 115. Mobile device 100 may measure the signal strength of the signal transmitted by local transceiver 115 and acquired at mobile device 100. By combining the measured travel time of the signal with the measured signal strength, mobile device 100, or another device, such as server 140, for example, may estimate the transmission power level for local transceiver 115. In this embodiment, measured signal strength, and measured RTT values and/or estimated transmission power may be transmitted to server 140. Mobile device 100, or server 140, may update local transceiver 115 transmission power level at server 140, for example. Other devices obtaining or measuring location relevant information, such as, but not limited to RTT results, received signal strengths, or transmission power levels, from server 140, may then receive an updated transmission power level for local transceiver 115 from server 140 to assist positioning using measurements of signals from local transceiver 115. Mobile device 100 may similarly provide measurements to server 140 that enable estimation of the location of local transceiver 115 (e.g., measurements of the location of mobile device 100 and of signals received from local transceiver 115 at the measured location of mobile device 100). Location server 140 may then use these measurements to determine or update an estimated location for local transceiver 115 and send this location to other devices to assist these devices in computing their estimated location using measurements of signals by these devices from local transceiver 115.

In a particular implementation, an access network (AN) or an access location network (ALN) may comprise devices positioned and configured to transmit or received signals to assist in positioning operations such as, for example local transceivers 115 or base station transceivers 110 described above. Signals transmitted and received to assist in positioning operations may be designed primarily to support communication of audio, video, data and control information as part of normal communications operations but may provide the additional benefit of supporting positioning by having measurable attributes such as signal strength, signal angle of arrival, signal timing or other signal characteristics. Relating to an AN or ALN, an AN database or ALN database (ALN DB), respectively, may be maintained in a server such as server 140, 150 or 155. Similarly, entities such as a location based services application server (LBS AS), location server (LS), map database (Map DB) may be provided or maintained by one or more of servers 140, 150 or 155. In addition, a mobile station (MS) may be detected in a venue and interact with one or more of the above referenced entities over wireless communication links. In one example, an MS may be implemented as a mobile device 100 discussed above. In particular examples, an MS may comprise circuitry or processors for hosting one or more applications capable of communicating with one or more of the aforementioned elements in performing location based services.

In implementations that use SUPL as a location solution, a location server such as server 140, 150 or 155 in FIG. 1A may comprise a home SLP (H-SLP) or a discovered SLP (D-SLP) for mobile device 100. An H-SLP may be provided for mobile device 100 by a home wireless network operator or by some other preferred location provider, and may comprise a location server with which mobile device 100 is provisioned to receive location services while in a home area (e.g., home network coverage area) or while unable to obtain location services from some other location server if not in a home area. A D-SLP may be a location server supporting location services in some other area such as a particular building, a venue, a city, a state or some foreign country for a user and may have unique data (e.g., unique positioning assistance data that can be transmitted to mobile device 100) to support location services in this area. A D-SLP may support better location services (e.g., may enable more accurate and reliable location) than an H-SLP inside the area served by the D-SLP. It may then be an advantage for mobile device 100 to discover a D-SLP while in certain environments, such as inside a venue, in order to obtain improved location services. Hence, a D-SLP may be used for SUPL location in any extension or modification of the architecture in FIG. 1A that is intended to support location services for a venue or other indoor environment.

SUPL is a location solution based on interaction between a SET and an SLP using TCP/IP as a transport mechanism in which SUPL messages, defined according to the SUPL User Plane Location Protocol (ULP) defined by OMA, are exchanged between a SET and an SLP to set up and manage SUPL location sessions and to transport positioning assistance data, location parameters (e.g., location estimate and/or measurements for use in computing a location estimate) and SUPL and positioning capabilities. A SUPL session may employ one or more positioning protocols that may convey at least a portion of positioning assistance data transferred from an SLP to a SET and some or all of the location measurement and/or location estimate information transferred from the SET to the SLP. Certain SUPL messages (e.g., a SUPL POS message) may carry one or more embedded messages defined according to a positioning protocol as a means of invoking and supporting positioning within a SUPL session. Examples of positioning protocols supported by SUPL include Radio Resource Location Services (LCS) Protocol (RRLP), Radio Resource Control Protocol (RRC), LTE Positioning Protocol (LPP), IS-801 and LPP Extensions (LPPe). Typically, LPPe may extend LPP such that an LPP positioning protocol message may contain an embedded LPPe message. RRLP, RRC and LPP are defined by 3GPP, IS-801 is defined by 3GPP2 and LPPe is defined by OMA, all in publicly available documents.

FIG. 1B is a schematic diagram of an architecture 230 to provide location based services in a venue according to an embodiment. Architecture 230 may be implemented using elements of a network as shown in FIG. 1A and may comprise a modification and/or extension of the architecture shown in FIG. 1A that is more suitable for supporting location services in a particular venue or other indoor environment. FIG. 1B shows an architecture 230 that includes a Mobile Device (or SET) 237, access network 239, Location Server 235, Map and Access network database 231, and location based services (LBS) application 233. Mobile device 237 may be any device that uses location based services, for example SUPL location services, such as a mobile phone, tablet, computer, or a global positioning system (GPS) device and may correspond to mobile device 100 in FIG. 1A. Access network 239 may include wireless and Bluetooth access points, as well as any other network component such as a cellular base station or transceiver that enables a mobile device 237 to communicate with a network such as the Internet and/or some internal intranet associated with a venue or building. Access network 239 may correspond to base station transceiver 110 and local transceiver 115 in FIG. 1A. Mobile device 237 and location server 235 may support SUPL, but there may be other implementations of architecture 230 in which mobile device 237 and location server 235 support other location service solutions such as solutions defined by the Internet Engineering Task Force (IETF) or 3GPP or 3GPP2.

Location server 235 may comprise an SLP server, such as a D-SLP or H-SLP server as described above, but may comprise any location server that provides location services in a manner consistent with the embodiments described herein. Location server 235 may correspond to one or more of servers 140, 150 and 155 in FIG. 1A. Map and access network database 231 may comprise data such as map data, location information (e.g., positioning assistance data including base station almanac data for access network 239 and/or assistance data for A-GNSS), information on points of interest, or other data that may be used by a location service. This information may be derived from a third party service, a crowd sourced database (which may collect location related information provided by mobile devices such as mobile device 237), or from any suitable source that provides information relevant to location services. Map and access network database 231 may correspond to one or more of servers 140, 150 and 155 in FIG. 1A. LBS application 233 may comprise an application, program, server computer, or service that uses location information. Examples include map programs on computing devices that show current locations using location services, and that provide directions based on a current location. LBS application 233 may further use information obtained from AN database 231 as well as location information obtained from location server 235 to provide application information to a mobile device 237. LBS application 233 may provide various location related services to mobile device 237 and/or to the user of mobile device 237 such as direction finding and navigation within a particular local area (e.g., building or venue) and/or provision of information about a particular local area that may be related to mobile device 237 being inside the local area or being at or nearby to some particular location in the local area. Such location related information may include information descriptive or indicative of a particular sales event inside a shopping mall, the whereabouts of a particular product or service of interest to the user of mobile device 237, the whereabouts of a nearby vacant car parking space, etc. LBS application 233 may be supported on or may comprise one or more of servers 140, 150 and 155 in FIG. 1A.

Additional examples of data flows within architecture 230 are shown in elements S1 through S9 of FIG. 1B, which show illustrative non-limiting examples of communications links, which may also be referred to as interfaces, between the above listed portions of FIG. 1B. Interfaces S1, S5, S6, S7, S8 and S9 may comprise logical or physical interfaces. In the case of a physical interface Sn (where n is a number in the range 1, 5, 6, 7, 8 and 9), the two entities joined by Sn may comprise physically separate entities and may be linked wirelessly, by a wireline connection (e.g. a cable or LAN) or via one or more intermediate entities such as network 130 in FIG. 1A. In the case of a logical interface Sn, the two entities joined by Sn may be different parts (e.g. different programs or processes) within the same physical entity. As an example, location server 235 and LBS application 233 may be physically separate entities if interface S5 is physical or may be parts of the same entity if interface S5 is logical. Interfaces S2, S3 and S4 to mobile device 237 may comprise physical interfaces. With interface S1, access network 239 may provide access network measurements made of signals transmitted from mobile device 237 to location server 235 to enable location server 235 to locate mobile device 237. Further, with interface S1, location server 235 may configure access network 239 to make particular measurements of mobile device 237 and provide them to location server 235 (e.g. measurements or information related to detection of mobile device 237 and/or the timing, strength and/or direction of arrival of signals received from mobile device 237). With interface S2, access network 239 may transfer to mobile device 237, for support of location service, positioning assistance data which access network 239 may have been configured with or may have obtained from location server 235. Transfer of assistance data over interface S2 from access network 239 to mobile device 237 may occur point to point and/or may make use of broadcast messages transmitted from access network 239 to multiple devices (including but not limited to mobile device 237). Positioning assistance data transferred may provide descriptions or characteristics of one or more transmitters (e.g., access points) in or outside of access network 239 whose signals may be measured by mobile device 237 to estimate its location. With S2, access network 239 may also transfer to mobile device 237 measurements made by access network 239 of signals received from mobile device 237. In addition, with S2 mobile device 237 may transfer to access network 239 location related measurements of signals received by mobile device 237 from access network 239, and access network 239 may make measurements of signals received from mobile device 237. With interface S3, as part of the primary function of a system for providing positioning services, location server 235 may transfer location related positioning assistance data to mobile device 237 and mobile device 237 may transfer positioning measurements, location estimates, and/or crowd-sourced measurements to location server 235. The various interactions and transfers on S3 may occur according to the SUPL ULP protocol in some embodiments. In further embodiments, SUPL ULP used on S3 may employ LPP and/or LPP/LPPe as positioning protocols as defined and allowed by the SUPL location solution defined by OMA in SUPL versions 2.0, 2.1 and 3.0. With interface S4, LBS application 233 may send to mobile device 237 a location request, map data and/or location related content such as navigation and direction finding data. In addition on S4, mobile device 237 may send to LBS Application 233 a location response and/or a location report (e.g., in response to a location request from LBS Application 233) and may also or instead send a request to LBS Application 233 for map data and/or other location related content. With interface S5, LBS application 233 may send to location server 235 a location request (e.g., related to mobile device 237) and/or a configuration request related to reporting the presence and/or location of mobile device 237. Further on S5, location server 235 may send to LBS Application 233 a location response and/or location report (e.g., in response to a location request and/or configuration request received earlier from LBS Application 233). To support the interactions on the S5 interface, the Mobile Location Protocol (MLP) defined by OMA in publicly available documents may be used in some embodiments. MLP may also be used in some embodiments to support interactions on interface S4. With interface S6, access network database 231 may transfer to location server 235 map data and/or access network related data (e.g., access network almanac data for access network 239 that may contain the locations and/or transmission characteristics of APs and/or base stations and/or femto cells in access network 239). Further in S6, location server 235 may transfer to Map and Access Network Database 231 location related measurement data (e.g. signal strength and/or round trip time measurements together with the location or an estimate of the location at which the measurements were made) which may concern access points and/or base stations in access network 239 and may have been obtained, at least in part, by location server 235 from access network 239 and/or via crowdsourcing from one or more mobile devices 237. Similarly, with interface S7, LBS application 233 may request and obtain map data from map and access network database 231. With interface S8, multiple various map and access network databases may share information—e.g. may transfer map data, access network almanac data and/or crowd sourced location data from one database to another as a means of providing additional access to such data to other instances of architecture 230 at other locations. Such information may be crowd-sourced or gathered from expert resources, and may thus initially be received at a single database before being shared with a network of map and access network databases. Similarly, with interface S9, multiple location servers may share information with each other—e.g. may share access network almanac data and/or map data received from one or more Map and Access Network Databases 231. Each of interfaces 51 through S9 may also provide support for security including, for example, the ability of two entities communicating via an interface Sn (where n is any number 1 through 9) to identify and authenticate one another, identify and authenticate other entities, authorize certain services and perform billing.

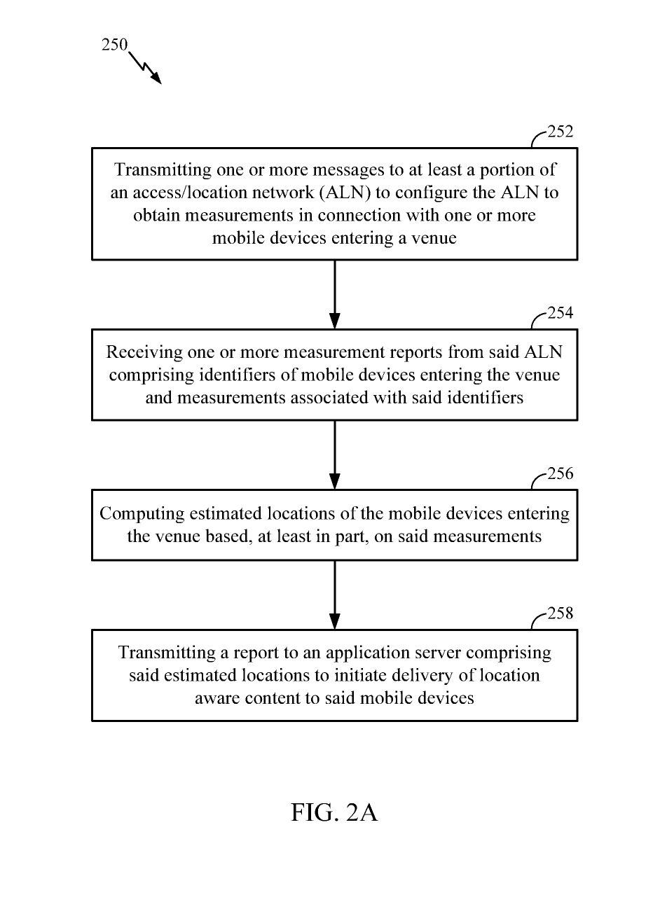

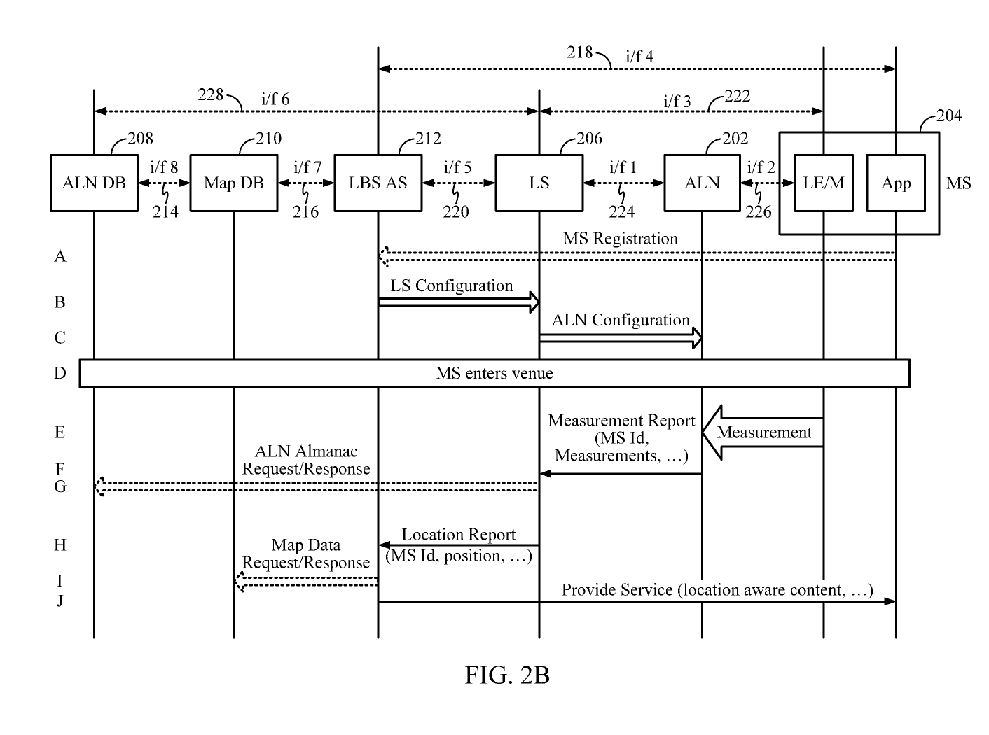

Architecture 230 in FIG. 1B may comprise an extension and/or modification of the architecture illustrated in FIG. 1A in which one or more of Map and Access Network Database 231, LBS Application 233, Location Server 235, access network 239 and mobile device 237 correspond to certain elements in FIG. 1A as mentioned above. This extension and/or modification of FIG. 1A shown in FIG. 1B may enable enhanced location services inside a venue or other indoor environment whereas the architecture in FIG. 1A may support only an existing location solution such as SUPL or a 3GPP/3GPP2 control plane solution that is less suitable for a venue. In particular, exemplary instances of location support (e.g., as described later with reference to FIGS. 2B, 3B, 4B, 5B, 6B, 6C, 6D and 6E) by architecture 230 and a refinement of architecture 230 described later in FIG. 1C show how architecture 230 may support location services inside a venue in an efficient manner.

In architecture 230, location server 235 may primarily support positioning of mobile device 237 whereas LBS Application 233 may primarily support services that use as input location information for mobile device 237 (e.g. current location, current velocity, current heading, location history) and may then provide additional services dependent on this (e.g., navigation assistance, direction finding, information of interest related to a particular location etc.) to mobile device 100 and/or to other entities such as a venue owner or some other external client. The functional partitioning of location server 235 and LBS Application 233 may be convenient to enable different providers (e.g., which may include different vendors, network operators, location providers, and/or venue owners) to provide their own specialized support for location services that may depend, at least in part, on data, resources, equipment and expertise uniquely available to each such provider and not available to other providers. With such a functional split, LBS Application 233 may need to rely on mobile device 237 and/or location server 235 to supply location related information for mobile device 237 (e.g., estimates or approximations of the location of mobile device 237, indications of reliability or uncertainty in such estimates or approximations, indications of certain location related events for mobile device 237 such as mobile device 237 entering or leaving a certain geographic area, etc.). Mobile device 237 may rely on LBS Application 233 (and not location server 235) for services dependent on location such as navigation and direction finding assistance. Location server 235 (and possibly mobile device 237) may rely on LBS Application 233 for instructions and configuration details indicating when and under what circumstances location information for mobile device 237 is to be obtained and provided to LBS Application 233. Mobile device 237 may further rely on location server 235 for assistance in obtaining its location (e.g., for transfer of location assistance data and/or computation of a location estimate). Location server 235 may rely on access network 239 for location related measurements and/or location estimates for mobile device 237 and access network 239 may rely on location server 235 for instructions and configuration details indicating when and how to report location measurements and/or location estimates for mobile device 237. These mutual dependencies and associated interactions may not be present or supportable in the more generic architecture described earlier for FIG. 1A without the extensions and modifications exemplified in FIG. 1B.

FIG. 1C is a schematic diagram of an architecture 200 to provide location based services in a venue according to an alternative embodiment. The systems depicted in FIGS. 1B and 1C may provide alternative implementations of embodiments described herein and may match corresponding elements of each architecture. It should be understood that corresponding elements may perform similar, but not necessarily identical, functions in each system. Also, functions of map and access network data base 231 may be performed by access/location network database 208 (in FIG. 1C and described below) and map database 210 (in FIG. 1C and described below). Architecture 200 may be implemented using elements of a network as shown in FIG. 1A and/or as shown in FIG. 1B. For example, mobile device 204 in FIG. 1C may be implemented as mobile device 100 in FIG. 1A. Location server (LS) 206, access/location network database (ALN DB) 208, map database (map DB) 210, LBS Application Server (LBS AS) 212 and Location Server (LS) 206 may be implemented as, or as a part of, servers 140, 150 and/or 155 in FIG. 1A. Access/Location Network (ALN) 202 may be implanted, at least in part, by base station transceiver 110 and/or local transceiver 115 in FIG. 1A and/or similar transceivers that serve a venue of interest. ALN 202 may comprise entities whose primary or only role is to support locating mobile device 204 (e.g. by transmitting positioning related radio signals to be measured by mobile device 204 or by measuring radio signals transmitted by mobile device 204) as well as entities whose primary or only role is to facilitate communication between mobile device 204 and other entities including but not limited to entities in FIG. 1C such as LS 206 and LBS AS 212. Additional correspondence between or among elements in the architectures depicted in FIGS. 1A, 1B and 1C may be as shown in Table 1 below, where elements that may correspond to one another are shown in different columns for the same row. For example, in row 5 of Table 1, for the element type LBS Application (shown in column 1), corresponding elements may comprise servers 140, 150, 155 in FIG. 1A (column 2), application 233 in FIG. 1B (column 3) and LBS AS 212 in FIG. 1C (column 4). Note that in the case of FIG. 1A, the correspondence is less exact because FIG. 1A does not distinguish different types of server 140, 150, 155 or different types of communication link 145.

| Element Type | FIG. 1A | FIG. 1B | FIG. 1C |
|---|---|---|---|
| Mobile Device | 100 | 237 | 204 |
| Location Server | 140, 150, 155 | 235 | 206 |
| Access Network or AP | 110, 115 | 239 | 202 |
| LBS Application | 140, 150, 155 | 233 | 212 |
| Map Database | 140, 150, 155 | 231 | 210 |
| Access Network | 140, 150, 155 | 231 | 208 |
| Database | | | |
| Interface/Communication | 123, 125 | S2 | 226 |
| Link | | | |
| Interface/Communication | 145 | S1 | 224 |
| Link | | | |
| Interface/Communication | 123/125, 145 | S3 | 222 |
| Link | | | |
| Interface/Communication | 123/125, 145 | S4 | 218 |
| Link | | | |
| Interface/Communication | 145 | S5 | 220 |
| Link | | | |
| Interface/Communication | 145 | S6 | 228 |
| Link | | | |
| Interface/Communication | 145 | S7 | 216 |
| Link | | | |
| Interface/Communication | 145 | S8 | 214 |
| Link | | | |

TABLE 1—Possible correspondence between Elements in FIGS. 1A, 1B and 1C[SE: the table allows entities and interfaces in the 3 figures to be related. It also allows the subsequent message flows which explicitly only address FIG. 1C to address the 2 other figures. The table shows a possible correspondence only (use of “may”). What would be the downside? Note that I have added a caveat above in the case of FIG. 1A.]

In particular implementations, a presence and location of mobile device 204 in a venue or other indoor environment may be detected, measured or tracked using a mobile centric (MC) approach and/or a network centric (NC) approach. In an MC approach, for example, a receiver at mobile device 204 may obtain measurements for use in detecting a presence or estimating a location of mobile device 204. In an NC approach, receivers at stationary network elements (e.g., as elements of ALN 202) may acquire signals transmitted by mobile device 204 for detection of a presence of mobile device 204 in a venue and estimating or tracking a location of mobile device 204 in the venue. LS 206 may employ network centric and/or mobile centric positioning depending on capabilities of mobile device 204, ALN 202 and LS 206. LBS AS 212 may also query mobile device 204 for its location if LS 206 and/or ALN 202 do not support network centric positioning or if mobile device 204 may provide an estimate of its location more accurately. Also, measurements indicated herein as being obtained using MC and NC approaches may be combined (e.g., at an LS) to mitigate measurement errors and improve accuracy of position estimates.

Message interfaces between entities in architecture 200 may include message interfaces 214, 216, 218, 220, 222, 224, 226 and 228. As shown, message interfaces 214, 216, 218, 220, 222, 224, 226 and 228 may be bi-directional or uni-directional and may function as described previously with reference to FIG. 1B using the correspondences shown in Table 1 and/or as described further on herein. Message interfaces 214, 216, 218, 220, 222, 224, 226 and 228 may be implemented on any suitable communication link infrastructure such as IP infrastructure, wireless communication links, just to provide a couple of examples. Message interfaces 214 and 216 may transmit requested map data to ALN Database 208 and LBS AS 212, respectively, for example in response to requests from these entities. Message interface 218 may transmit location aware content or map data from LBS AS 212 to mobile device 204. Message interface 220 may transmit a location request message from LBS AS 212 to LS 206, and a location response or location report from LS 206 to LBS AS 212 in response to the location request message. In a mobile centric approach, message interface 218 may similarly transmit a location request message from LBS AS 212 to mobile device 204, and a location response or location report from mobile device 204 to LBS AS 212 in response to the location request message. In a network centric approach, on the other hand, message interface 218 may transmit a location request message from mobile device 204 to LBS AS 212, and a location response or location report from LBS AS 212 (which may convey a location estimate for mobile device 204 obtained by LBS AS 212 from LS 206) to mobile device 204 in response to the location request.

Message interface 222 may transmit positioning assistance data from LS 206 to mobile device 204. In a particular implementation where mobile device 204 computes an estimate of its location (e.g., using one or more of the above described techniques), message interface 222 may transmit the computed location estimate from mobile device 204 to location server 206. In another implementation, message interface 222 may transmit access network related measurements (which may be obtained by mobile device 204 and/or by ALN 202 and conveyed to mobile device 204) from mobile device 204 to LS 206, and transmit an estimated location of mobile device 204 (e.g., computed based, at least in part on the access network measurements) from LS 206 to mobile device 204. Such access network related measurements may include, but are not necessarily limited to, the aforementioned measurements of RTT, RSSI and angles of arrival for signals transmitted by mobile device 204 and received and measured by ALN 202 and/or signals transmitted by ALN 202 and received and measured by mobile device 204.

Message interface 226 (which may also comprise a signal interface and not explicitly convey messages) may transmit messages and/or radio signals between ALN 202 and mobile device 204 on wireless access communication links, for example. Any radio signals transmitted on message interface 226 may be measured by a recipient entity and/or initiate a response that may be measured by the initial sending entity in order to obtain RSSI, RTT, pseudoranges, timing differences or other measurements that may enable location aspects (e.g. location coordinates) of mobile device 204 and/or elements of ALN 202 (e.g., an AP in ALN 202) to be obtained. Message interface 226 may also transmit location assistance data that is broadcasted or unicasted from ALN 202 to mobile device 204, wherein the positioning assistance data may be obtained by ALN 202 from LS 206 or may be otherwise provisioned in ALN 202 (e.g., by a network management entity not shown in FIG. 1C). Message interface 224 may transmit messages from LS 206 to ALN 202 including, for example, messages to configure ALN 202 to detect and obtain measurements from mobile devices in the venue and to provide positioning assistance data to elements in ALN 202 for use by ALN 202 (e.g. to locate mobile device 204) or to be conveyed to mobile device 204 (e.g. via broadcast or unicast). In a network centric application, message interface 224 may also transmit measurements from ALN 202 to LS 206 to, for example, detect, or compute an estimated location of, mobile devices in a venue. Message interface 228 may transmit messages from ALN database 208 to LS 206 which may convey positioning assistance data including base station almanac data for ALN 202 to LS 206, and may transmit crowdsourced data (e.g., including measurements and other data related to locations, identities and transmission characteristics for access points (e.g., 802.11 access points) in ALN 202 collected by LS 206 from client mobile devices in the venue such as mobile device 204) from LS 206 to ALN database 208.

In particular implementations, devices in ALN 202 (e.g., IEEE 802.11 access points, femto cell transceivers or Bluetooth devices) may be configured by LS 206 using message interface 224 to detect and report the presence or location of mobile device 204 in a venue. For example, LS 206 may configure devices to detect and report on detected mobile devices entering a venue in a default mode (e.g. report on all detected mobile devices every 30 seconds). LS 206 may configure devices to report on specific devices in other modes—(e.g., report at a higher frequency or if specific predefined trigger conditions occur such as some change in measured signal round-trip time (RTT) or measured RSSI, for example).

In particular implementations, LBS AS 212 may configure LS 206 to report on newly detected mobile devices (e.g., as reported to LS 206 by ALN 202) in a default mode (e.g., report on all mobile devices every 30 seconds). LBS AS 212 may also configure LS 206 to provide reports for specific mobile devices or for all mobile devices in response to other trigger conditions. Trigger conditions and trigger detection may be implemented within LS 206 including complex trigger conditions such as detecting when a mobile device enters or leaves a specific portion of a venue (e.g. a particular shop in a shopping mall or a particular gate area in an airport) or detecting when a mobile device has moved a certain distance from some previously reported location. LS 206 may in turn configure some trigger conditions in ALN 202 and/or in mobile device 204 which may then report back to LS 206 data associated with these trigger conditions (e.g., detection of mobile device 204) entering a venue or periodic location of mobile device 204. However, in some implementations, LS 206 may support the more complex trigger conditions while delegating the handling of simpler trigger conditions to ALN 202 and/or mobile device 204 in order to (i) reduce resource usage in ALN 202 and/or mobile device 204, (ii) conserve battery life in mobile device 204 and possibly ALN 202, (iii) simplify implementation (and possibly cost) of ALN 202 and/or mobile device 204 and/or (iv) avoid frequent upgrades to and replacement of elements in ALN 202 and mobile device 204. Possible configured triggers in LS 206, ALN 202 and mobile device 204 may include, for example, a single mobile device entering, leaving or remaining within a geofence (which may be some defined fixed area or some non-fixed area defined relative to the current location of another mobile device), a minimum or maximum number of mobile devices entering, leaving or remaining within a geofence, the presence and/or location of a mobile device or set of mobile devices during a specific time window or at a specific time, just to provide a few examples.

Mobile device 204 may be detected entering a venue area and by one or more elements in ALN 202 (e.g., access points (APs) using existing low level IEEE 802.11 or Bluetooth (BT) signaling). For example, APs in ALN 202 may be configured to make measurements of signals transmitted by particular mobile devices expected to be in the venue area. Here, APs in ALN 202 may transmit messages to LS 206 (e.g., messages specifying a MAC address for a detected mobile device 204 and optional measurements of signals received from mobile device 204). LS 206 may then compute an estimated location for mobile device 204 and store the location and other data such a time of day and MAC address for mobile device 204 and/or report this data to LBS AS 212. For any particular mobile device of interest, LS 206 may maintain an identity (e.g., identifiers such as MAC address, IP address), last known location, location history, current heading and speed, last serving AP or mobile device capabilities. In one particular implementation in which interaction between LS 206 and mobile device 204 is defined, at least in part, according to OMA SUPL, capabilities of mobile device 204 may include being capable of executing certain positioning protocols such as LPP and LPPe and certain positioning methods such as A-GNSS, OTDOA, AFLT and/or E-CID. LS 206 may transfer information regarding mobile devices detected in a venue (e.g., from contents of messages received from mobile devices or ALN 202) to LBS AS 212 (e.g., if configured for this as discussed above). LBS AS 212 may also store information received from LS 206 for use in, for example, delivery of location aware content to mobile devices (e.g. mobile device 204) and/or maintaining, developing or updating analytics data regarding visitors to a venue.

In a particular implementation, mobile device 204 may discover LBS AS 212 using any one of several techniques such as, for example: (i) a generic application hosted on mobile device 204 obtaining a URL or IP address for the LBS AS 212 via broadcast information received from ALN 202; (ii) a user downloading a dedicated application to be hosted on mobile device 204 that is configured in advance to interact with LBS AS 212 for one or more venues as soon as the application is notified (e.g. via user input) that a particular venue has been detected by mobile device 204 or by the user of mobile device 204; or (iii) a user accessing LBS AS 212 via a user interface browser (e.g., by accessing a venue specific website) in response to the user being aware of being inside a particular venue. For any particular such technique for discovering LBS AS 212, a user may initiate communication from mobile device 204 to LBS AS 212 via interaction with either an application hosted on mobile device 204 or via a mobile browser or by other means. In a particular implementation, mobile device 204 and LBS AS 212 may interact in order to: (i) optionally authenticate mobile device 204 by LBS AS 212, (ii) optionally authenticate the LBS AS 212 by mobile device 204, (iii) optionally provide LBS AS 212 with an identity of mobile device 204 (e.g., IP address, MAC address, International Mobile Subscriber Identity (IMSI), public user SIP address, logon identity or billing related identity), (iv) optionally indicate to the user or an application hosted on mobile device 204 services (e.g., including location based services) available from the LBS AS 212 to mobile device 204, (v) optionally provide user permission for being located (e.g., in association with provision of certain agreed services), (vi) optionally provide some initial map data to mobile device 204, (vii) optionally provide an address of LS 206 to mobile device 204 (e.g., if not broadcast by elements of ALN 202, or available from an H-SLP or D-SLP), and (viii) optionally provide location determination and positioning capabilities of mobile device 204 to LBS AS 212 (e.g. capabilities related to support of interface 222 including possibly support of SUPL, LPP and LPPe on interface 222). Following this interaction, LBS AS 212 may transmit messages to LS 206 providing information obtained from mobile device 204 such as an IP address, MAC address and/or other identity for mobile device 204, the capability of mobile device to support positioning related interaction (e.g. via SUPL) with LS 206 using interface 222 and possibly an initial location for mobile device 204 if received by LBS AS 212 from mobile device 204. LBS AS 212 may also store attributes of mobile device 204 (e.g., identifiers, estimated location, location determination capabilities, etc.) to enable provisioning of agreed or preferred services and support future location determination requests. The interaction between LBS AS 212 and mobile device 204 described here may be associated with or facilitated by a registration of mobile device 204 with LBS AS 212 (e.g., which may be established prior to mobile device 204 entering a venue supported by LBS AS 212) in which (e.g., following the registration) LBS AS 212 maintains some data for mobile device 204 even while mobile device 204 is not within a venue supported by LBS AS 212. Such a registration may simplify and speed up the interaction just described between mobile device 204 and LBS AS 212 and enable improved service support by LBS AS 212 to mobile device 204.

In a particular implementation, an estimated location of mobile device 204 may enable or help enable an application or browser hosted on mobile device 204 to support some service provided by a particular venue (e.g., provided by LBS AS 212 in FIG. 1C) or some service provided independently of any particular venue. Here, for example, the browser or application hosted on mobile device 204 may request an estimate of a location of mobile device 204 using a suitable high level operating system (HLOS) application programming interface (API), which may lead to a request (e.g., from the HLOS) to a positioning engine or location engine on mobile device 204. A positioning engine or location engine may obtain an estimated location of mobile device 204 using various positioning methods such as A-GNSS, OTDOA, AFLT and/or use of WiFi AP and/or BT AP measurements and/or use of inertial sensors contained within mobile device 204 (e.g. accelerometers, gyroscopes, barometers, etc.) which may entail interaction with an H-SLP and/or interaction with a venue D-SLP, for example (e.g., LS 206 in FIG. 1C). Positioning engine involvement in venue support may include venue D-SLP discovery by mobile device 204 from either the H-SLP for mobile device 204 or from another D-SLP already discovered from and/or authorized by the H-SLP for mobile device 204 if a venue D-SLP (e.g., LS 206) can provide better location support than an H-SLP or another D-SLP for mobile device 204. Here, if an application hosted on mobile device 204 interacts with LBS AS 212 in order to obtain venue related location services (such as positioning assistance data and location related content data) and this application relies on an estimated location of mobile device 204 in order to make use of such location services (e.g. to determine the location of mobile device 204 on a venue map provided by LBS AS 212), then the application may have an additional option of requesting an estimated location of mobile device 204 from LBS AS 212 (e.g., as a fallback to positioning engine failure or as a first choice if preferred by the application). In such a case, LBS AS 212 may request mobile device 204 location from LS 206 and LS 206 may request ALN 202 to perform network centric positioning of mobile device 204 with the location result or measurements being passed back from ALN 202 to LS 206 and with any computed location estimate then being passed back to mobile device 204 via LBS AS 212.

In a particular implementation, LBS AS 212 may request LS 206 to periodically locate some or all mobile devices (e.g., as described above). This may enable various venue services and collection of statistics on all users and/or on selected users (e.g., in order to determine which shops are most popular in a shopping mall, where congestion occurs in an airport, where additional seating may be needed in a hospital). LS 206 may authenticate LBS AS 212 once only for multiple requests (e.g., may establish a secure session on which the multiple requests and their responses may be conveyed) or may authenticate LBS AS 212 for each individual request. LBS AS 212 may similarly authenticate LS 206 once only for multiple requests or for each individual request. LS 206 may request updated measurements from ALN 202 in order to obtain new location estimates for mobile devices of interest as discussed above and/or may rely on earlier configuration of ALN 202 by LS 206 whereby ALN 202 provides new location reports to LS 206 for mobile devices (e.g., mobile device 204) without the need for further requests from LS 206. LS 206 may also obtain location information (e.g. location estimates and/or location measurements) directly from mobile devices (e.g. mobile device 204) using interface 222. LS 206 may then return obtained location information (e.g., location estimates, location history) for mobile devices such as mobile device 204 to LBS AS 212 to enable LBS AS 212 to provide location related services to these mobile devices.

In a particular implementation, a user (e.g., via an application or browser hosted on mobile device 204) may periodically request services (e.g., map data, venue information) from LBS AS 212. LBS AS 212 may also or instead periodically push services to the user without the need for a user request (e.g. via a browser or application hosted on mobile device 204) and as triggered by certain events (e.g., a user entering or leaving some geofence or following some change in environmental conditions). Mobile device 204 may obtain a position fix to make use of such services using a mobile centric approach or network centric approach as discussed above.

Following a timeout period following a last detection of mobile device 204 in a venue by ALN 202 and/or after determination that a location of mobile device 204 is outside the venue, LS 206 and LBS AS 212 may delete some or all stored attributes of mobile device 204 from their current data set. Here, in some instances, all data may be deleted in LS 206 while some data may be retained in LBS AS 212 (e.g., as agreed upon with the user and as allowed by a privacy policy). Retained data may, for example, be helpful to future authentication and billing support and for providing future services.

In particular implementations, as pointed out above, mobile device 204 may be registered with an LBS AS 212 where the LBS AS 212 has knowledge of a unique identifier (ID) of mobile device 204 (e.g. an IMSI, public SIP user ID, MAC address). Subsequent specific service requests issued by LBS AS 212 to LS 206 that may request location information (e.g., a location estimate) for mobile device 204 or that may configure LS 206 to provide such location information responsive to certain trigger events occur (such as mobile device 204 entering or leaving some geofence) may be specific to that particular unique ID (or may be specific to the IDs for a set of mobile devices if location information is needed for mobile devices in this set). If a particular mobile device is not registered with LBS AS 212 (e.g., where a unique ID of the mobile device is not known by LBS AS 212), subsequent services requests by LBS AS 212 to LS 206 may be generic as opposed to specific to a particular unique ID of mobile device 204 and may then be applicable to any mobile device. For any generic or specific service request, LBS AS 212 may request that LS 206 respond to one or more particular types of predefined events. In one implementation, LBS AS 212 may request that LS 206 provide estimated locations of one or more identified mobile devices or of any mobile device at fixed times (e.g., periodically). In another implementation, LBS AS 212 may request that LS 206 report detections of an identified mobile device 204 or of any mobile device entering or leaving a specific geographic target area. Such a particular report may comprise, for example, a simple event notification or may include more information such as, for example, an estimated location of mobile device 204 and/or an identity of mobile device 204. In another particular implementation in connection with ALN 202, LBS AS 212 may request that LS 206 report detection of an identified mobile device 204 or any mobile device entering or leaving an area covered or serviced by ALN 202. This particular report may comprise a simple event notification or may include more information such as, for example, an estimated location of the mobile device 204 and/or an identity of mobile device 204. In another particular implementation, LBS AS 212 may request that LS 206 provide reports in support of analytics (e.g., statistics on a rate of individuals entering and/or leaving a predefined area or statistics on the number of individuals within a predefined area). Here, LBS AS 212 may request that LS 206 provide a report in response to the occurrence of certain specific analytic events. For instance if a number of mobile devices (or the rate of arrivals and/or departures) within an area or ALN 202 exceeds a certain threshold, LS 206 may provide a report. Such a report may include a simple event notification or more information such as the location or locations of the mobile devices associated with the event and/or their identities. In order to provide location related event notifications and information to LBS AS 212, LS 206 may request location information from ALN 202 and/or mobile device 204, and/or may configure ALN 202 and/or mobile device 204 to provide location related event notifications and additional information to LS 206.

Exemplary message communication flows are now described referring to FIGS. 2B, 3B, 4B, 5B, 6B, 6C, 6D, 6E and 12A that show interactions between or among elements in the architectures described above with reference to FIGS. 1A, 1B and 1C that support different types of location related services in a venue or other indoor environment in a manner similar to that previously described and/or in a manner that extends and improves the location services previously described. Elements in FIGS. 2B, 3B, 4B, 5B, 6B, 6C, 6D, 6E and 12A are shown as corresponding to elements in the architecture 200 of FIG. 1C via the use of like element numbers. Hence FIGS. 2B, 3B, 4B, 5B, 6B, 6C, 6D, 6E and 12A may directly represent message interactions between elements in FIG. 1C. However, using the correspondence of elements shown in Table 1, FIGS. 2B, 3B, 4B, 5B, 6B, 6C, 6D, 6E and 12A may also represent message interactions between elements in FIG. 1A and/or FIG. 1B. It should be noted that interfaces (or communication links) in FIGS. 2B, 3B, 4B, 5B, 6B, 6C, 6D, 6E and 12A are indicated by the abbreviation “i/f” and that mobile device (or MS) 204 is shown as comprising a location engine and modem functional component (LE/M) and an application (App) that may in some implementations be the true endpoints of certain interfaces supported by mobile device (or MS) 204. The sequence of events shown in and described for FIGS. 2B, 3B, 4B, 5B, 6B, 6C, 6D, 6E and 12A may occur in the order shown and described or may occur in some other order in some implementations. In addition, some events may occur concurrently in which case some events may start before other events and finish during or after these other events.

FIG. 2B is a message flow diagram exemplifying network centric positioning according to an embodiment and may exemplify aspects of location support in architecture 200 in FIG. 2C and/or architecture 230 in FIG. 1B. In one implementation, the message flow in FIG. 2B may be executed by a location server (e.g. LS 206) in communication with other entities such as one or more mobile devices (e.g. mobile device 204), an LBS AS (e.g. LBS AS 212), elements of an ALN (e.g. ALN 202), just to provide a few examples. In FIG. 2B, at event A, an application (App) on a mobile device 204 may register with an LBS AS 212 to provide the LBS AS 212 with information to return location aware content, for example, whenever mobile device 204 is inside a venue supported by LBS AS 212. Such location aware content may include, for example, information about locally available goods and services, data about objects in the local environment, such as museum exhibits, or local routing information. Such information may include, for example, a unique identifier or address for the mobile device 204. At event B, the LBS AS 212 may transmit one or more messages to an LS 206 to configure the LS 206 for detecting and locating mobile devices (including mobile device 204) that enter a venue. At event C, the LS 206 may configure an ALN 202 for detecting mobile devices and performing measurements that may assist the LS 206 in detecting and estimating locations of mobile devices entering the venue. In one implementation, an LS 206 may transmit one or more messages to one or more elements of an ALN 202 to configure the ALN 202 to obtain measurements in connection with mobile devices entering a venue. In some implementations, event A may occur after events B and C.

In particular implementations, nodes (e.g. APs, femto cells) in an ALN 202 may be used to provide access services to mobile devices (e.g., data and voice communication services) in addition to obtaining measurements for positioning operations. In one embodiment, an LS 206 may transmit messages at event C to configure an ALN 202 to obtain location measurements so as to reduce or avoid any degradation in a quality of access services provided to mobile devices. For example, a message transmitted at event C to a node in an ALN 202 may configure the node to operate on a different frequency channel to obtain measurements of signals transmitted by a particular mobile device or type of mobile device, and then return to a normal channel of operation to resume providing access services to other mobile devices.

Following configuration of the ALN 202, at event D, a mobile device 204 may enter the venue. At event E, the configured ALN 202 may detect a presence of the mobile device 204 in the venue (e.g., by detecting radio signals transmitted by mobile device 204 as part of normal mobile device 204 operation to either secure communications access from ALN 202 or request information from ALN 202 relevant to obtaining communications access) and may collect measurements in connection with the mobile device 204. Such measurements may include, for example, but are not necessarily limited to, the aforementioned measurements of RTT, RSSI and angles of arrival or departure. After obtaining measurements, at event F, ALN 202 may transmit a Measurement Report to LS 206. The received Measurement Report may contain identifiers of the mobile devices (e.g. mobile device 204) detected by ALN 202 and associated measurements. After receiving the measurements in event F, LS 206 may request and obtain ALN 202 Almanac data from ALN DB 208 at event G in order to calculate the position of the mobile devices (e.g., mobile device 204). Event G may be optional and may only be performed if the LS 206 requires ALN Almanac data but does not yet have this data. If event G is performed, the LS 206 may cache the received data for later use and thereby not need to perform event G if the message flow in FIG. 2B is performed at a later time. The ALN DB 208 may in turn obtain Map Data from Map DB 210 in order to provide the LS 206 with the Almanac Data (e.g. if the almanac data provides locations of APs and/or femto cells in ALN 202 relative to a venue map and possibly further provides AP and/or femto cell signal strength values relative to a venue map). In this case the ALN DB 208 requests (and obtains) the Map Data from the Map DB 208 (not shown in FIG. 2B). At event H, the LS 206 may compute estimated locations of the mobile devices (e.g., mobile device 204) entering the venue based, at least in part, on measurements contained in the received measurement report in event F and any ALN 202 almanac data obtained at event G or previously available to LS 206. Further at event H, the LS may then transmit a report to the LBS AS 212 comprising computed estimated locations of mobile devices (e.g., mobile device 204) that have entered the venue for use in delivering location aware content to the mobile devices. The LBS AS may then deliver location aware content to located mobile devices in the venue (e.g. mobile device 204) at event J. Depending on the type of location aware content to be provided to an application on a mobile device 204, the LBS AS 212 may obtain Map Data. Here, at event I, the LBS AS 212 may request (and obtain) Map Data from the Map DB 210.

FIG. 2A is a flow diagram of a process that may be executed by LS 206 in connection with the message flow of FIG. 2B. At block 252, one or more messages may be transmitted to at least a portion of ALN 202 to configure ALN 202 to obtain measurements in connection with one or more mobile devices entering the venue. At block 254, one or more measurement reports may be received from ALN 202 comprising identifiers of mobile devices entering the venue and measurements associated with the identifiers. At block 256, estimates of locations of the mobile devices entering the venue may be computed based, at least in part, on measurements received at block 254. At block 258, a report may be transmitted to LBS AS 212 comprising estimated locations to initiate delivery of location aware content to the mobile devices.

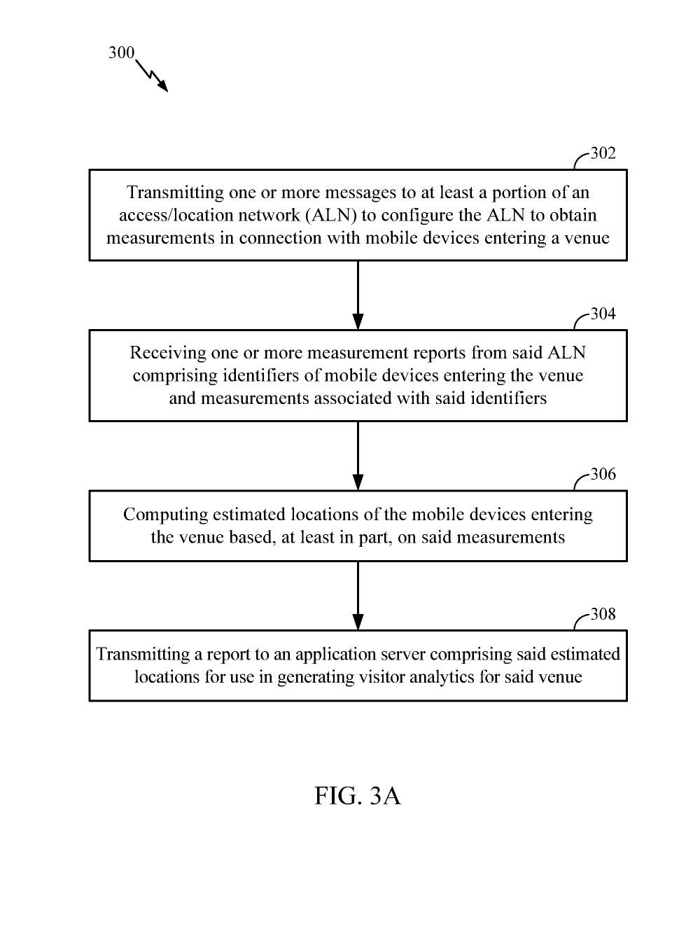

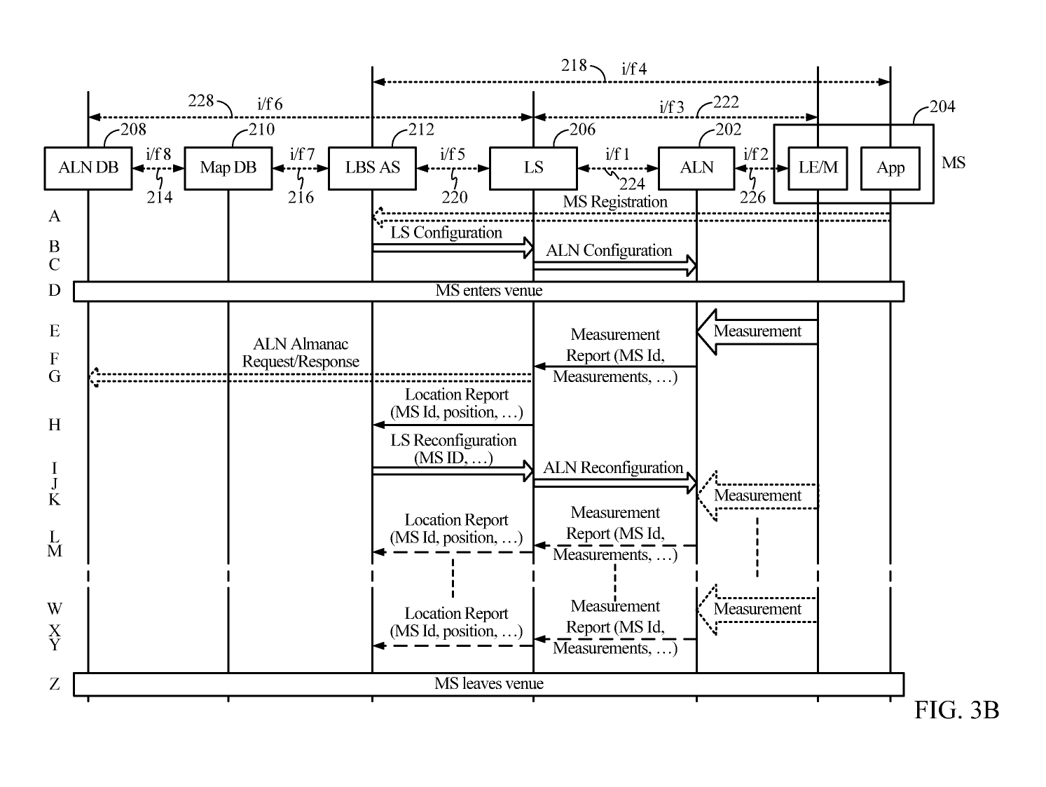

FIG. 3B is a message flow diagram exemplifying network centric positioning for the collection of venue visitor analytics data according to an embodiment. Data collected may include visitor density over time throughout the venue, paths traversed through the venue, presence or collocation of uniquely identifiable visitors, visitor dwell times at specific locations in the venue, and the number of visitors within or nearby to a particular location or area, just to provide a few examples. At event A, an application on a mobile device 204 may register with an LBS AS 212 (e.g. prior to entering a venue or after entering a venue) to provide the LBS AS 212 with parameters enabling the LBS AS 212 to return location aware content, for example. Such parameters may include, for example, a unique identifier or address for the mobile device (e.g., a MAC address and/or IMSI and/or an identification of the mobile device user). Event A may be optional and may only be performed if the LBS AS 212 relies on information in advance for mobile device 204 such as the identity of mobile device 204. At event B, the LBS AS 212 may transmit one or more messages to an LS 206 to configure the LS 206 for detecting and locating mobile devices (such as mobile device 204) that enter a venue. At event C, the LS 206 may configure an ALN 202 for detecting mobile devices and performing measurements that may assist the LS 206 in detecting and estimating locations of mobile devices entering the venue. In one implementation, LS 206 may transmit one or more messages to one or more elements (e.g., APs and/or femto cells) of ALN 202 to configure ALN 202 to obtain measurements in connection with mobile devices entering a venue. In some implementations, event A may occur after events B and C.

Following configuration of ALN 202, at event D, a mobile device 204 may enter the venue. At event E, the configured ALN 202 may detect a presence of the mobile device 204 in the venue (e.g., from receipt of radio signals transmitted by mobile device 204) and may collect measurements in connection with the mobile device 204. Such measurements may include, for example, the aforementioned measurements of RTT, RSSI and angles of arrival or departure. After obtaining measurements, at event F the ALN 202 may transmit a Measurement Report to the LS 206. The received Measurement Report may contain identifiers of the mobile devices (e.g., mobile device 204) detected by ALN 202 and associated measurements. After receiving the measurements in event F, the LS 206 may request and obtain ALN 202 Almanac data from the ALN DB 208 at event G in order to calculate the position of the mobile devices (e.g. mobile device 204). Event G may be optional and may only be performed if the LS 206 requires ALN Almanac data but does not yet have this data. If event G is performed, the LS 206 may cache the received data for later use and thereby not need to perform event G if the message flow in FIG. 3B is performed at a later time. The ALN DB 208 may in turn obtain Map Data from Map DB 210 in order to provide the LS 206 with the Almanac Data (e.g., if the almanac data contains locations of APs and/or femto cells in ALN 202 relative to a venue map and possibly further provides AP and/or femto cell signal strength values relative to a venue map). In this case the ALN DB 208 requests (and obtain) the Map Data from the Map DB 208 (not shown in FIG. 3B). At event H, LS 206 may compute estimated locations of the mobile devices (e.g., mobile device 204) entering the venue based, at least in part, on measurements contained in the received measurement report in event F and any ALN 202 almanac data obtained at event G or previously available to LS 206. Further at event H, LS 206 may then transmit a report to LBS AS 212 comprising computed estimated locations of mobile devices (e.g., mobile device 204) that have entered the venue for use in collecting or maintaining analytics data at LBS AS 212 in connection with visitors to the venue.

With knowledge of identifier(s) of mobile device(s) having entered the venue obtained at event H, LBS AS 212 may transmit a message to the LS 206 at event I to configure the LS 206 for obtaining periodic updates to the estimated locations of the mobile devices (e.g., mobile device 204). In response, the LS 206 at event J may transmit one or more messages to the ALN 202 as part of a procedure to configure the ALN 202 to obtain periodic measurements in connection with the mobile devices (e.g. mobile device 204) having entered the venue. Events K, L, M and events W, X, Y may exemplify one or more repetitions of events E, F, H whereby ALN 202 makes further location related measurements of mobile devices that have entered the venue (e.g., mobile device 204), provides the measurements to LS 206. LS 206 may then compute locations for the mobile devices and provide the computed locations, and possibly the mobile identities, to LBS AS 212 to enable LBS AS 212 to gather further analytics data. Events corresponding to event G may also be performed if LS 206 employs ALN 202 almanac data to help compute mobile device locations.

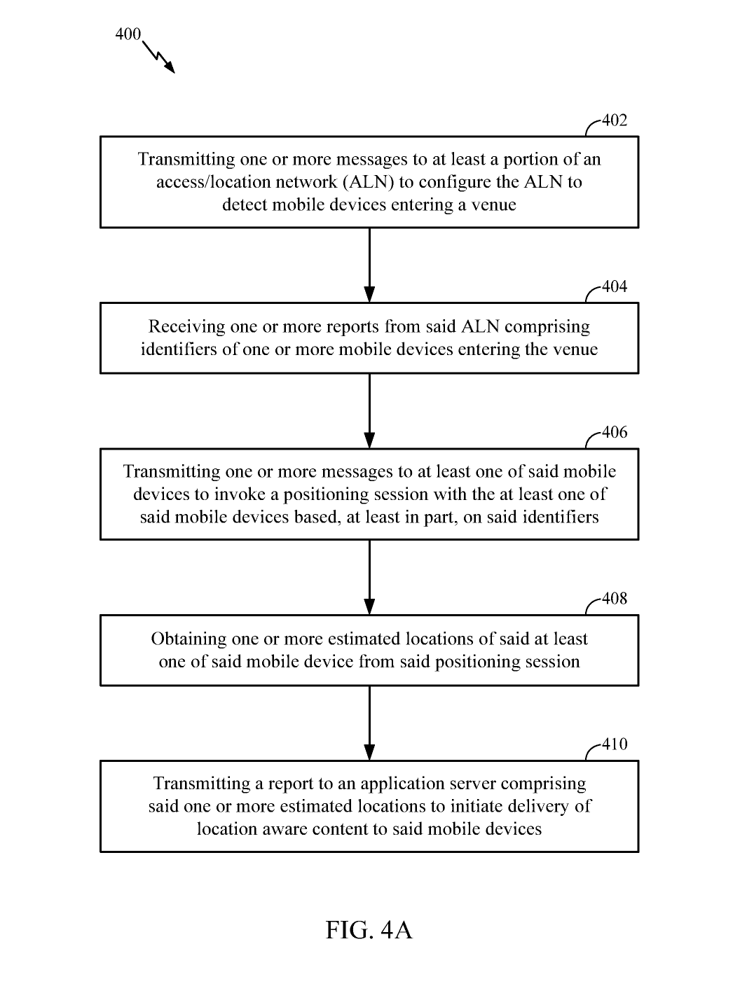

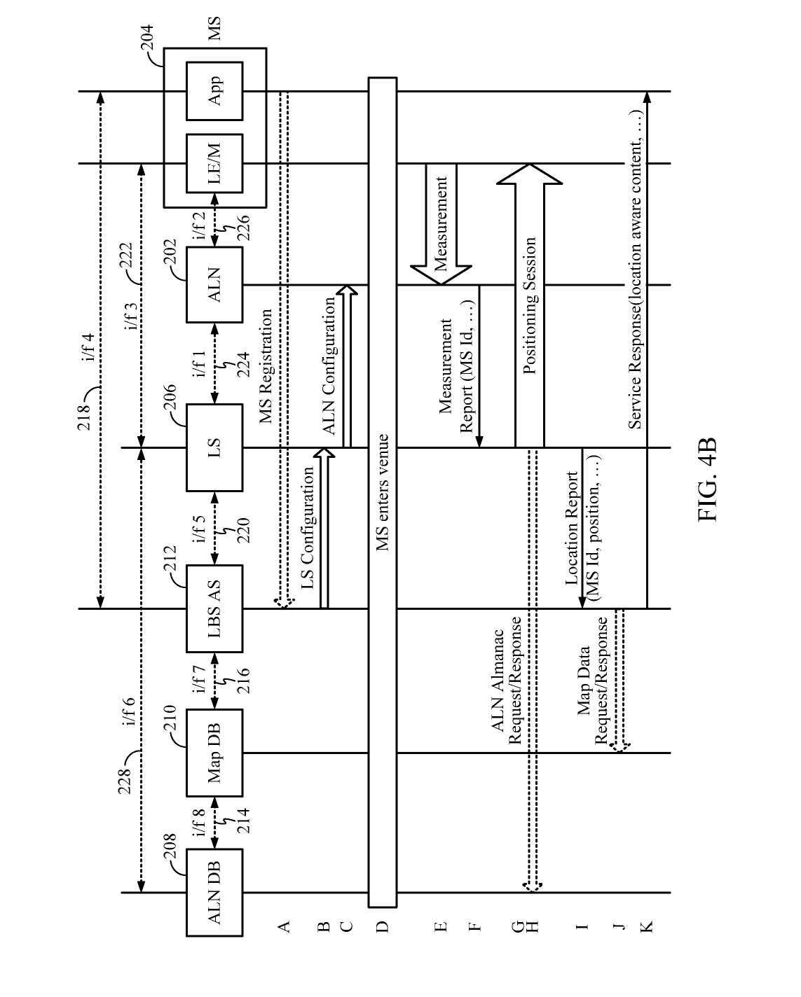

FIG. 3A is a flow diagram of a process that may be executed by LS 206 in connection with the message flow of FIG. 3B. At block 302, one or more messages may be transmitted to at least a portion of ALN 202 to configure ALN 202 to obtain measurements in connection with one or more mobile devices entering the venue. At block 304, one or more measurement reports may be received from ALN 202 comprising identifiers of mobile devices entering the venue and measurements associated with the identifiers. At block 306, estimates of locations of the mobile devices entering the venue may be computed based, at least in part, on measurements received at block 304. At block 308, a report may be transmitted to LBS AS 212 comprising estimated locations for use in generating visitor analytics for the venue. FIG. 4B is a message flow diagram that exemplifies network initiated, mobile centric positioning for the delivery of location aware content to mobile devices in a venue. Here, events A through F may occur as described above for events A through F in the particular implementation of FIG. 2B and/or of FIG. 3B. Thus at event F, the LS 206 may receive one or more reports from the configured ALN 202 comprising at least identifiers of one or more mobile devices (e.g., mobile device 204) that have entered the venue.

With knowledge of an identifier (e.g. an IP address and/or a MAC address) of a mobile device 204 having entered the venue, LS 206 may transmit one or more messages to the mobile device 204 (e.g. using the identifier to send and route the messages to mobile device 204 possibly via ALN 202) to invoke a positioning session with the mobile device's location engine at event G. The positioning session may be a SUPL session or a location session defined according to some other location solution such as a solution defined by IETF, 3GPP or 3GPP2. In the course of the positioning session, the mobile device 204 may obtain location measurements that may be used in computing an estimated location of the mobile device (e.g., measurements of acquired SPS signals, RTT or RSSI for signals received from APs and/or femto cells in ALN 202). In one implementation of a positioning session, a location engine on the mobile device may compute an estimate of the location of the mobile device based, at least in part, on the obtained measurements. The mobile device may then transmit the estimated location to the LS 206. In an alternative implementation of a positioning session, the mobile device may transmit location measurements collected at the mobile device 204 to the LS 206 so that the LS 206 may compute the estimated location of the mobile device 204. At event I, the LS 206 may transmit a report to an LBS AS 212 comprising an identifier of the mobile device and the computed estimate of the mobile device's location for use in delivery of location aware content to the mobile device.

Optionally, at event H, in the course of a positioning session at event G with mobile device 204, LS 206 may request ALN Almanac data from the ALN DB 208 in order to (i) assist the LS 206 in calculating an estimated location of mobile device 204 (e.g., if mobile device 204 had provided location measurements of ALN 202 to LS 206 during event G) and/or (ii) provide ALN 202 related data such as almanac data to mobile device 204 to assist measurements of ALN 202 and possibly estimating its location from these measurements. In one implementation, the ALN DB 208 may request and obtain Map Data from the Map DB 210 in order to provide the LS with the ALN Almanac Data.

Depending on a type of location aware content to be provided to an application hosted on the mobile device 204, at event J the LBS AS 212 may request (and obtain) Map Data from the Map DB 210. The LBS AS 212 may deliver location aware content to the mobile device 204 at event K.

FIG. 4A is a flow diagram of a process that may be executed by LS 206 in connection with the message flow of FIG. 4B. At block 402, one or more messages may be transmitted to at least a portion of ALN 202 to configure ALN 202 to detect mobile devices entering the venue. At block 404, one or more reports may be received from ALN 202 comprising identifiers of one or more mobile devices entering the venue. At block 406, one or more messages may be transmitted to at least one of the mobile devices to invoke a positioning session based, at least in part, on identifiers in the one or more received reports. At block 408, one or more estimated locations of the at least one of the mobile devices may be obtained by the positioning session invoked at block 406. At block 410, LS 206 may transmit a report to LBS AS 212 comprising the one or more estimated locations obtained at block 408 to enable LBS AS 212 to initiate delivery of location aware content to the mobile devices.

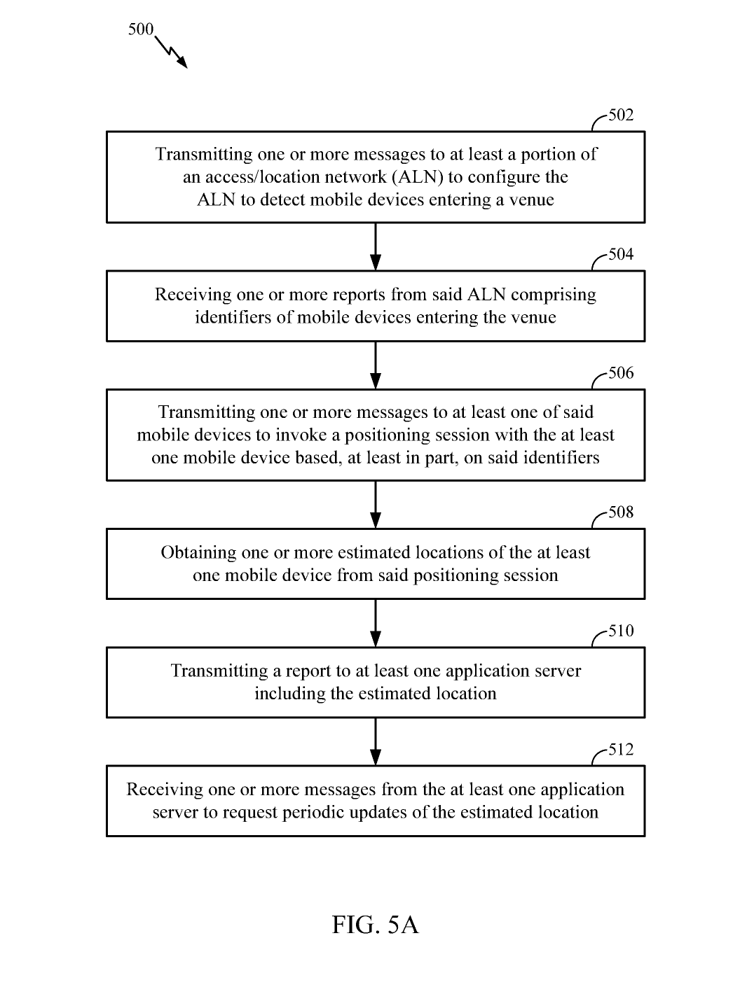

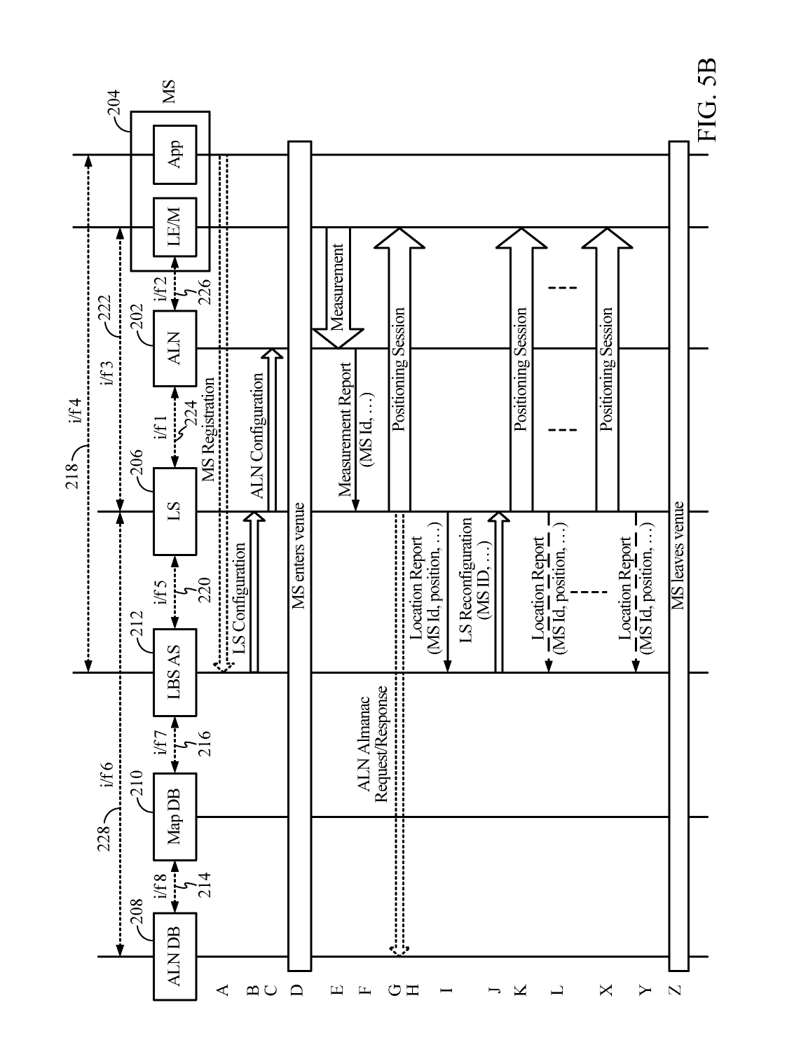

FIG. 5B is a message flow diagram that exemplifies network initiated, mobile centric positioning of mobile devices in a venue with periodic updates. Events A through I as indicated in FIG. 5B may occur as events A through I in FIG. 4B described above. Thus at event I, LS 206 may transmit a report to LBS AS 212 comprising an identifier of a mobile device 204 and the computed estimate of the mobile device's location.

At event J, LBS AS 212 may transmit one or more messages to LS 206 to configure LS 206 to obtain periodic or triggered updates of estimated locations of mobile device 204 (and possibly of other mobile devices). In order to obtain periodic or triggered updates of estimated locations, LS 206 may instigate one or more repetitions of events G, H and I, as exemplified by events K and L and events X and Y, for the case that no additional ALN Almanac data (in a repetition of event H) may be required. In the course of these events, an estimated location of the mobile device 204 may be periodically determined and reported to LBS AS 212 by LS 206 at events L and Y. The mobile device 204 may leave the venue at event Z after which location reporting may cease.

FIG. 5A is a flow diagram of a process that may be executed by LS 206 in connection with the message flow of FIG. 5B. At block 502, one or more messages may be transmitted to at least a portion of ALN 202 to configure ALN 202 to detect mobile devices entering the venue. At block 504, one or more reports may be received from ALN 202 comprising identifiers of one or more mobile devices entering the venue. At block 506, one or more messages may be transmitted to at least one of the mobile devices to invoke a positioning session based, at least in part, on identifiers in the one or more received reports. At block 508, one or more estimated locations of the at least one of the mobile devices may be obtained by the positioning session invoked at block 506. At block 510, LS 206 may transmit a report to LBS AS 212 comprising the one or more estimated locations obtained at block 508. At block 512, one or more messages may be received from LBS AS 212 requesting periodic or triggered updates of the estimated locations.

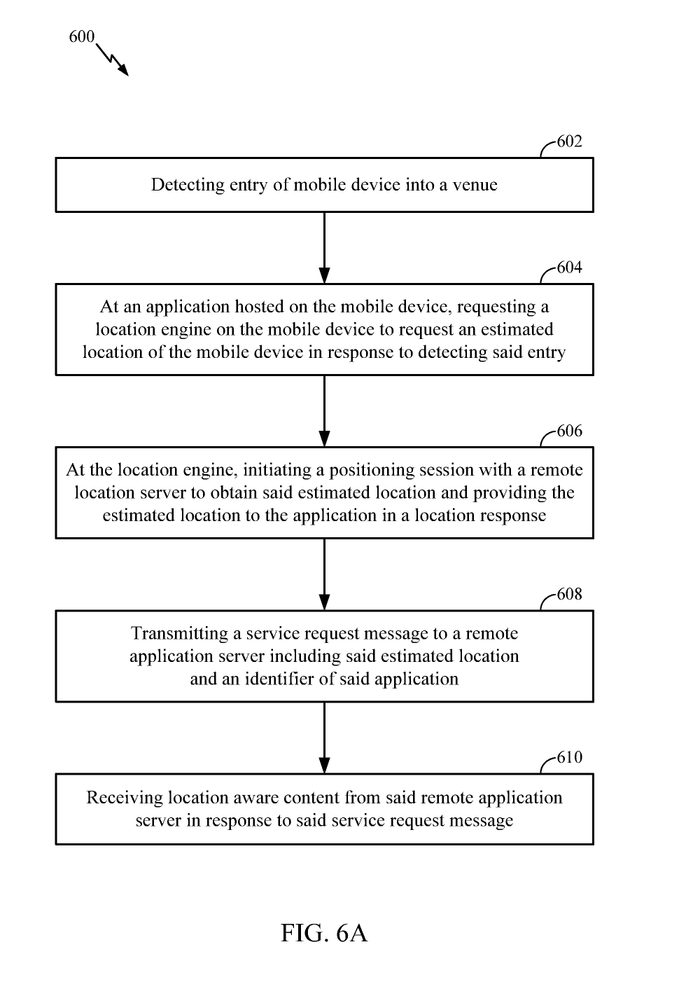

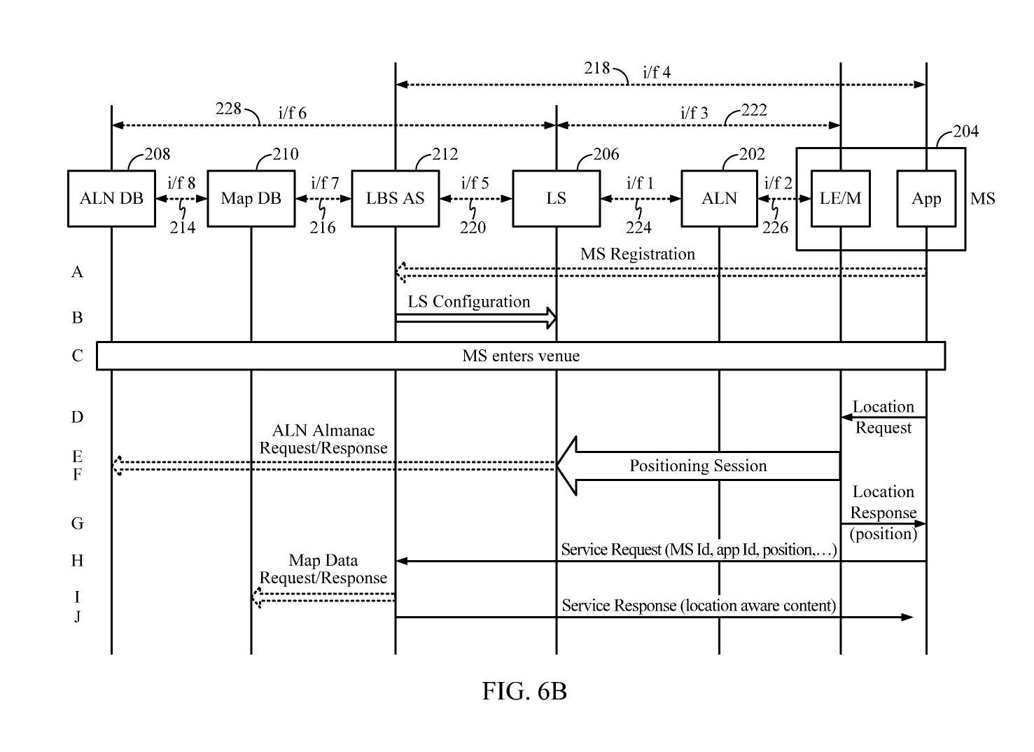

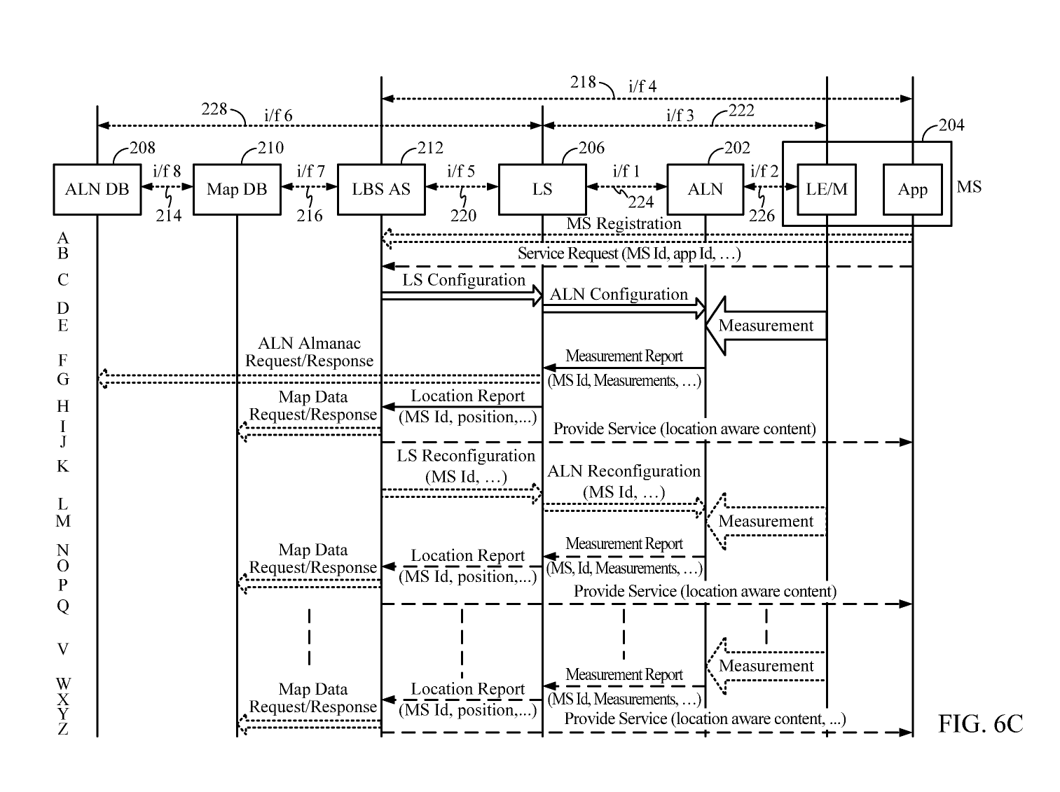

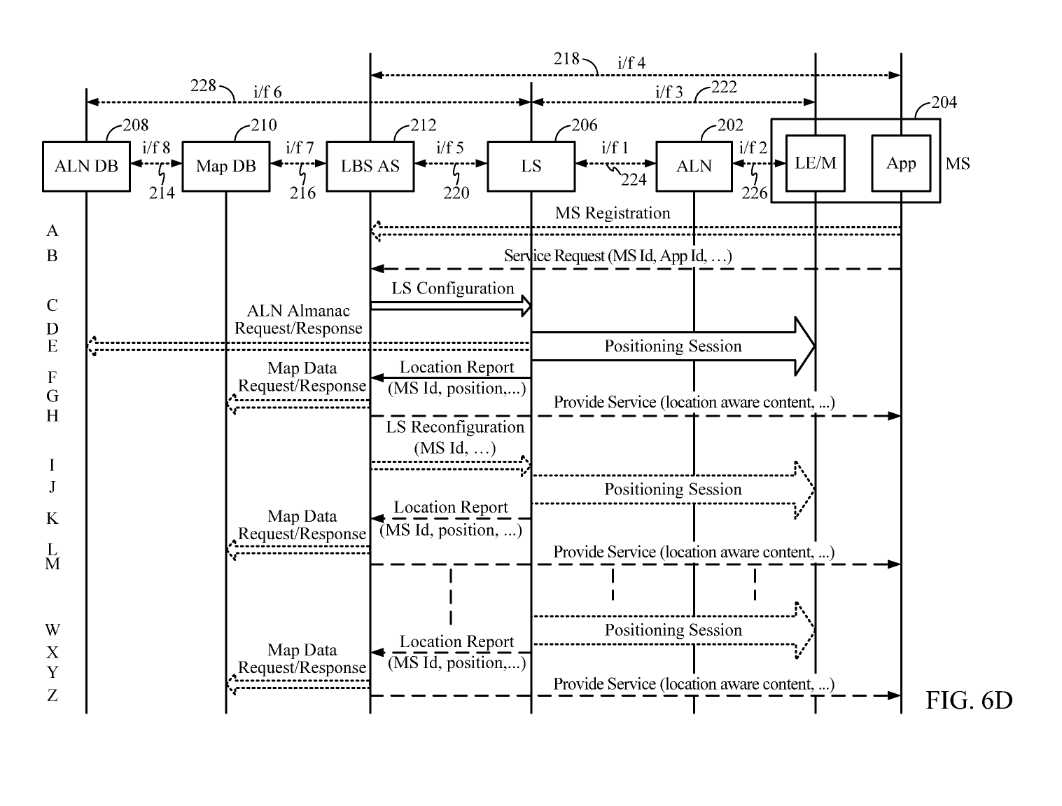

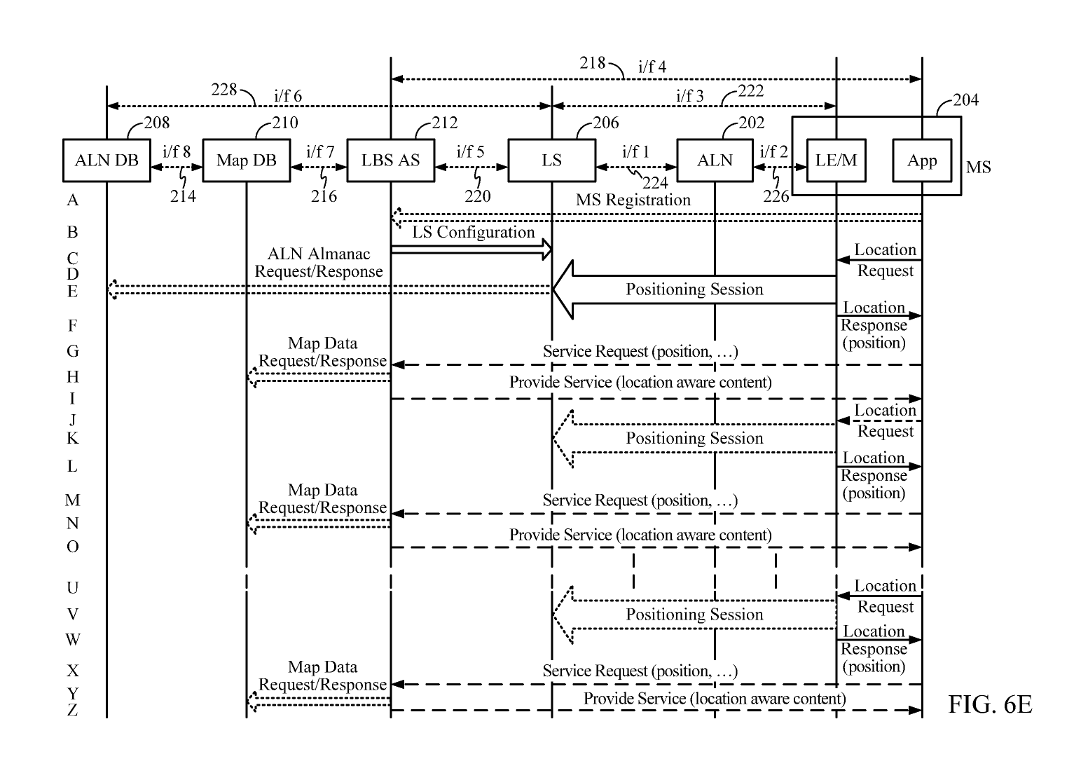

FIG. 6B is a message flow diagram that exemplifies mobile initiated, mobile centric positioning of mobile devices in a venue. At event A, an application hosted on a mobile device 204 may transmit a message to an LBS AS 212 to register the application with the LBS AS 212 in order to, for example, enable the LBS AS 212 to deliver location aware content to the application in the future. The registration may provide the LBS AS 212 with an identifier for the application and/or for the mobile device 204. At event B, to invoke a configuration procedure, the LBS AS 212 may transmit one or more messages to an LS 206 to instruct the LS 206 to report position results to the LBS AS 212. In this scenario, the configuration request prepares the LS 206 for the mobile initiated position session at event E discussed below. The mobile device may enter the venue at event C and autonomously detect its entry to the venue. Here, the mobile device may detect its entry by, for example, acquisition of a signal transmitted by a radio frequency (RF) ID tag, an AP or femtocell in ALN 202 (e.g., where the transmitted signal may identify the venue or contain information that may be associated by mobile device 204 with the venue), or by user input (e.g., user interaction with the application in event A), just to provide a couple of examples.

At event D, in response to detecting entry into the venue, an application hosted on mobile device 204 (e.g., the same application as in event A) may request a location engine on mobile device 204 to obtain an estimated location of mobile device 204. At event E, the location engine on mobile device 204 may initiate a positioning session with LS 206 to obtain an estimated location of mobile device 204 and provide the estimated location to the application in a response message at event G. Mobile device 204 may first need to discover LS 206 (e.g., from information received from ALN 202, from a home location server of mobile device 204 such as an H-SLP, from some D-SLP authorized by the H-SLP or during registration at event A). The positioning session in event E may be a SUPL session or a location session defined according to some other location solution such as a solution defined by IETF, 3GPP or 3GPP2. According to an embodiment, in the course of the positioning session initiated at event E, LS 206 may request ALN Almanac data from an ALN DB 208 at event F in order to (i) facilitate computation of an estimated location of mobile device 204 and/or (ii) provide ALN data to mobile device 204 to assist mobile device 204 in making location measurements (e.g., of ALN 202) and/or in computation of the estimated location (e.g., from measurements obtained by the mobile device 204 of ALN 202). In another implementation, ALN DB 208 may request and obtain Map Data from Map DB 210 to enable providing LS 206 with ALN Almanac Data.

At event H, in order to obtain location aware content, the application hosted on the mobile device 204 may transmit a service request message to the LBS AS 212 including the estimated location of the mobile device obtained at event G and an identifier of the application hosted on the mobile device 204 and/or an identifier of the mobile device 204 and/or of the user of mobile device 204. At event I the LBS AS 212 may optionally request and receive Map Data from the Map DB 210 in response to the service request message in event H. At event J, the LBS AS 212 may transmit the requested location aware content to the mobile device 204 which is received by the application hosted on the mobile device.

FIG. 6A is a flow diagram of a process 600 that may be executed by mobile device 204 in connection with the message flow of FIG. 6B. At block 602, entry of mobile device 204 into a venue may be detected. In response to detection of entry of mobile device 204 into the venue, at block 604 an application hosted on mobile device 204 may request a location engine on mobile device 204 to request an estimated location of mobile device 204. At block 606, the location engine may then initiate a positioning session with a remote server to obtain the estimated location and provide the estimated location to the application in a location response. At block 608, a service request message may be transmitted to a remote application server including the estimated location and an identifier of the application. In response to the request message at block 610, location aware content may be received form the remote application server.

FIG. 6C exemplifies network centric support of service provision to a mobile device 204 within a venue according to an embodiment. Service provision may support any type of service offered by a venue including, for example, provision of location related information and/or provision of directions and/or navigation assistance. At event A, an application (App) on mobile device (MS) 204 may register with LBS AS 212 and may provide an identity of the mobile device (e.g., MAC address, IMSI), optionally an identity of the App and means to authenticate the App identity (e.g. if only certain trusted Apps are permitted to receive location services from the venue), information relating to supported and/or preferred services and privacy and/or information on the positioning capabilities of the mobile device (e.g., capability to support SUPL). This event is optional and may occur as needed. Depending on the scenario, this event may occur before or after events C and D. In scenarios where an App on mobile device 204 requests service from the venue without providing the location of mobile device 204, the App sends a Service Request to the LBS AS 212 at event B. The Service Request may identify the specific service being requested (e.g. navigation assistance, directions, map data for the venue, asset or user tracking in which the location of mobile device 204 is periodically updated by LBS AS 212 or mobile device 204 to an asset or user tracking system) and may contain the identity of the mobile device 204 (e.g., a MAC address, IP address, IMSI) and/or of the App and/or information on the positioning capabilities of the mobile device (e.g. capability to support SUPL). Possible triggers for event B may include the App detecting it is within the venue (e.g., in response to detection of signals transmitted by ALN 202) or the user invoking the App in response to the user being aware of entering the venue. In some implementations, the Service Request at event B may indicate user permission for the LBS AS 212 to share the location of mobile device 204 with certain third parties (e.g., the venue owner) in return for location service provided later to the user (e.g. at events J, Q and Z in FIG. 6C). In some implementations, the registration at event A and/or the service request at event B may provide geofence information to LBS AS 212 associated with particular service preferences for the App such as (i) being notified if mobile device 204 enters or leaves a certain geographic area, (ii) receiving certain services or privileges when inside a certain area (such as being able to download certain information) or (iii) being notified when another user (e.g. a child) exits a geofence area defined relative to mobile device 204. At event C, the LBS AS 212 may configure the LS 206 to report position results by invoking an LS 206 configuration procedure. The LS 206 configuration procedure may request a single position or multiple positions for particular trigger events (e.g. events related to entering or exiting a geofence) and can address a single MS (e.g., mobile device 204), a set of MSs (e.g., all MSs currently registered with the LBS AS 212) or all MSs detected inside the venue. The MSs for which location information is requested in event C may be identified using some MS identity such as a MAC address, IP address and/or IMSI. Event C may occur before event A (e.g., to configure position results for all MSs), after event A but before event B (e.g., to configure position results for all registered MSs) as well as after event B (e.g., to configure specific position results for the service request in event B). The trigger events configured in step C may include detection of mobile device 204 entry to the venue, detection of mobile device 204 entry to or exit from a particular geofence area, a periodic time interval after each of which location information is to be returned to LBS AS 212 and/or a change in an estimated location of mobile device 204 by some threshold relative to a previously reported location.

In line with LS 206 configuration performed at event C, LS 206 may perform an ALN configuration procedure at event D to instruct ALN 202 to perform measurements enabling detection of the presence and possibly location of mobile device 204 and/or of other mobile devices. The configuration in event D may include providing an identity of mobile device 204 to ALN 202, providing a time interval for reporting mobile device 204 location measurements to LS 206 and a change in mobile device 204 signal measurements for which mobile device 204 signal measurements are to be reported to LS 206. At event E, ALN 202 detects mobile device 204 and performs measurements of mobile device 204. After ALN 202 obtains measurements of mobile device 204, it reports the measurements to the LS 206 in a Measurement Report at event F. The Measurement Report may contain the mobile device 204 identity (e.g., MAC address, IP address) and the measurements. After receiving the measurements in event F, LS 206 may request and obtain ALN 202 almanac data from ALN 202 DB at event G in order to calculate the position of mobile device 204. Event G may be optional and may only be performed if LS 206 requires ALN Almanac data for ALN 202 and has not already obtained this data from ALN DB 208 and stored it for later use. ALN DB 208 may also require Map Data in order to be able to provide the LBS AS 212 with the Almanac Data. In this case ALN DB 208 requests (and obtains) the required Map Data from Map DB 210.

At event H, LS 206 calculates the mobile device 204's position based on the measurements received in event F and any ALN almanac data received at event G. and sends a Location Report to LBS AS 212. The Location Report may contain the mobile device 204 identity (e.g. MAC address, IP address) and position and an indication of any trigger events applicable to mobile device 204 such as mobile device 204 having entered or left a particular geographic area. In some implementations, LS 206 may not perform event H immediately but instead await further repetitions of event F (not shown in FIG. 6C). This may occur, for example, if LS 206 was configured by LBS AS 212 at event C to provide the location report at event H only when mobile device 204 satisfies some trigger condition (e.g. such as mobile device 204 having entered or left a particular geographic area) and further repetitions of event F are needed before the particular trigger event occurs and is detected by LS 206. If LBS AS 212 requires Map Data in order to respond to the initial service request (i.e., event B) and did not previously obtain and store the data, it may request (and obtain) the required Map Data from Map DB 210 at event I. If a location estimate of mobile device 204 and/or location aware content needs to be provided to the mobile device 204 (App) in response to event B or as a consequence of detecting the mobile device 204 in the venue at event E or as a consequence of any trigger events indicated at event H, LBS AS 212 sends a Provide Service to the mobile device 204 (App) at event J. The Provide Service contains the location estimate of mobile device 204 and/or the location aware content (e.g. venue map data, directions and/or venue information relevant to mobile device 204's current location). In the case of an asset or user tracking service, LBS AS 212 or mobile device 204 may then update an asset or user tracking service with a location estimate of mobile device 204 (not shown in FIG. 6C).

If LBS AS 212 needs to reconfigure the LS 206 (e.g., to obtain location reports for the mobile device 204 more frequently or for different trigger events than instructed in event C), LBS AS 212 may send new configuration instructions to LS 206 at event K regarding reporting the location of mobile device 204 (e.g. may provide new trigger conditions such as mobile device 204 entering or leaving some geofence). If event K was performed, LS 206 may reconfigure ALN 202 in line with the LBS AS 212 reconfiguration of event K (e.g., LBS AS 212 may request location reports from ALN 202 related to mobile device 204 at a higher frequency or in response to the occurrence of certain event triggers such as a certain change in signal measurements (e.g. RTT, RSSI) related to mobile device 204). Events E, F, G, H, I and J described previously may then be repeated one or more times (e.g. at events M, N, O, P, Q and at events V, W, X, Y, Z wherein repetition of event G is omitted) to provide updated location information for mobile device 204 to LBS AS 212 and provide new service to mobile device 204 (e.g. new map data, new venue information).

FIG. 6D exemplifies mobile centric network initiated support of service provision to a mobile device 204 within a venue. Service provision may support any type of service offered by a venue including, for example, provision of location related information and provision of directions and/or navigation assistance. FIG. 6D may support the same venue services as the embodiment of FIG. 6C except that the embodiment of FIG. 6D may employ mobile centric network initiated positioning instead of network centric positioning as in FIG. 6C. Events A, B and C in FIG. 6D may occur as described previously for FIG. 6C. Thus, at event C, LS 206 may receive configuration instructions from LBS AS 212 for mobile device 204 and possibly for other mobile devices. In response to event C, LS 206 may initiate a Positioning Session with mobile device 204 (LE/M) at event D in order to obtain an estimated location of mobile device 204. The positioning session may comprise a SUPL session (and may then employ LPP and LPPe for positioning) or may comprise a location session defined according to some other location solution such as a solution defined by IETF, 3GPP or 3GPP2. In the course of the Positioning Session, LS 206 may request and obtain ALN Almanac data from ALN DB 208 at event E to enable computation of the estimated position of the mobile device 204 and/or provide ALN 202 data to the mobile device 204 to enable mobile device 204 to obtain measurements and possibly estimate its location. Event E may be optional and only performed if LS 206 or mobile device 204 employs ALN Almanac data and if the LS 206 has not already obtained this data from ALN DB 208 and stored it for later use. If event E occurs, ALN DB 208 may employ Map Data in order to provide LS 206 with the Almanac Data. In this case ALN DB 208 may request (and obtains) the Map Data from Map DB 210. In some implementations, the positioning session at event D may support triggered positioning in which LS 206 obtains a location estimate for mobile device 204 only when certain trigger events occur such as mobile device 204 entering or leaving a particular geofence area. In these implementations LS 206 and/or mobile device 204 may monitor for occurrence of the trigger events by periodically obtaining a location estimate for mobile device 204 and determining whether the location estimate satisfies a trigger condition. In the case of a SUPL positioning session, mobile device 204 may monitor any trigger conditions by obtaining positioning assistance data as needed from LS 206 in order to periodically compute a location estimate for mobile device 204 and communicate a position estimate to LS 206 when any trigger event has been detected.

At event F, LS 206 may report a computed location estimate for mobile device 204 to the LBS AS 212 in a Location Report which may include mobile device 204's identity and an indication of any trigger events applicable to mobile device 204 such as mobile device 204 having entered or left a particular geographic area. In some implementations, LS 206 may not perform event F immediately but may instead await further repetitions of event D (not shown in FIG. 6D). This may occur, for example, if LS 206 was configured by LBS AS 212 at event C to provide the location report at event F only when mobile device 204 satisfies some trigger condition (e.g. such as mobile device 204 having entered or left a particular geographic area) and further repetitions of event D are needed before the particular trigger event occurs and is either detected by LS 206 or reported to LS 206 by mobile device 204. If the LBS AS 212 employs Map Data in order to respond to the initial service request (event B) and did not previously obtain and store the data, LBS AS 212 may request (and obtain) the required Map Data from Map DB 210 at event G. If a location estimate for mobile device 204 and/or location aware content is to be provided to mobile device 204 (App) in response to event B or event A or as a consequence of any trigger events indicated at event F, LBS AS 212 may send a Provide Service message to mobile device 204 (App) at event H. The Provide Service message contains a location estimate for mobile device 204 and/or the location aware content (e.g. directions or information related to the venue). In the case of an asset or user tracking service, LBS AS 212 or mobile device 204 may then update an asset or user tracking service with a location estimate of mobile device 204 (not shown in FIG. 6D).

If LBS AS 212 is to reconfigure the LS 206 (e.g., to obtain location reports for the mobile device 204 more frequently or for different trigger events than instructed in event C), LBS AS 212 may send new configuration instructions to LS 206 at event I regarding reporting the location of mobile device 204 (e.g. may provide new trigger conditions for reporting such as mobile device 204 entering or leaving some geofence). If event I was performed, events D, E, F, G and H described previously may be repeated one or more times (e.g., as shown at events J, K, L, M and W, X, Y, Z where repetition of event E is not shown) to provide updated location information for mobile device 204 to LBS AS 212 and provide new service to mobile device 204 (e.g., new map data, new venue information).

FIG. 6E exemplifies mobile centric mobile initiated support of service provision to a mobile device 204 within a venue according to an embodiment. Service provision may support any type of service offered by a venue including, for example, provision of location related information and provision of directions and/or navigation assistance. FIG. 6E may support the same venue services as FIGS. 6C and 6D except that FIG. 6E may employ mobile centric mobile initiated positioning instead of network centric positioning as in FIG. 6C or mobile centric network initiated positioning as in FIG. 6D. Events A and B in FIG. 6E may occur as described previously for events A and C, respectively, in FIGS. 6C and 6D. The LS 206 Configuration procedure in event B may then prepare the LS 206 for single position or multiple positions for particular trigger event sessions and may address a single mobile device 204 (e.g., the mobile device 204 in event A), a set of MSs (e.g., MSs currently registered with the LBS AS 212) or all MSs detected inside the venue. In this scenario, the configuration request in event B may prepare LS 206 for the position session in event D initiated by mobile device 204.

An App on the mobile device 204 (e.g., the App associated with event A) may require a position and send a Location Request to the LE/M on the mobile device 204 at event C. Possible triggers for this event may include the App detecting that mobile device 204 is within the venue (e.g., based on detection of signals from ALN 202 received by mobile device 204) or the user invoking the App in response to the user being aware of entering the venue. The App may also be aware that it can obtain the estimated location of mobile device 204 locally on the mobile device 204. At event D, mobile device 204 (LE/M) may initiate a Positioning Session with the LS 206 in order to obtain the mobile device 204's estimated position. Mobile device 204 may first discover the LS 206 (e.g., from information received from the ALN 202, from a home location server of the mobile device 204 such as an H-SLP, from some D-SLP authorized by the H-SLP or during the registration event A). The positioning session in event D may comprise a SUPL session (and may then employ LPP and LPPe for positioning), or may comprise a location session defined according to some other location solution such as a solution defined by IETF, 3GPP or 3GPP2.

In the course of a Positioning Session at event D, LS 206 may request and obtain ALN 202 Almanac data from ALN DB 208 at event E in order to calculate an estimated position of mobile device 204 and/or provide ALN 202 data to the mobile device 204 to assist measurements and possibly location derivation by mobile device 204. Event E may be optional and may only be performed if LS 206 or mobile device 204 employs ALN 202 Almanac data and if the LS 206 has not already obtained this data from the ALN DB 208 and stored it for later use. If event E occurs, ALN DB 208 may employ Map Data in order to provide the LS 206 with the Almanac Data. In this case the ALN DB 208 may request (and obtain) the Map Data from the Map DB 210.

After obtaining an estimated position of the mobile device 204 at event D, the LE/M on mobile device 204 may send the estimated position to the App in a Location Response at event F. If the App on mobile device 204 is to receive location aware content from LBS AS 212 (e.g., based on the position result obtained in event F or based on the trigger that invoked event C), the mobile device 204 (App) may send a Service Request to LBS AS 212 indicating the type of service requested at event G. The service request may include the mobile device 204 identity (e.g., MAC address, IP address, IMSI), the identity of the user of mobile device 204 and/or the estimated position obtained in event F.

If LBS AS 212 employs Map Data as a result of the Service Request received in event G and did not previously obtain and store the data, LBS AS 212 may request (and obtain) Map Data from Map DB 210 at event H. If event G was performed, LBS AS 212 may send a Provide Service with the requested location aware content to the mobile device 204 (App) at event I. Events C through I may then be repeated one or more times to enable the App on mobile device to request new services from LBS AS 212 at later times (e.g., if the location of mobile device 204 has changed or if the user makes an additional request for new service to the mobile device 204). These repeated events are shown in FIG. 6E at events J through O and events U through Z wherein repetition of event E is not shown.

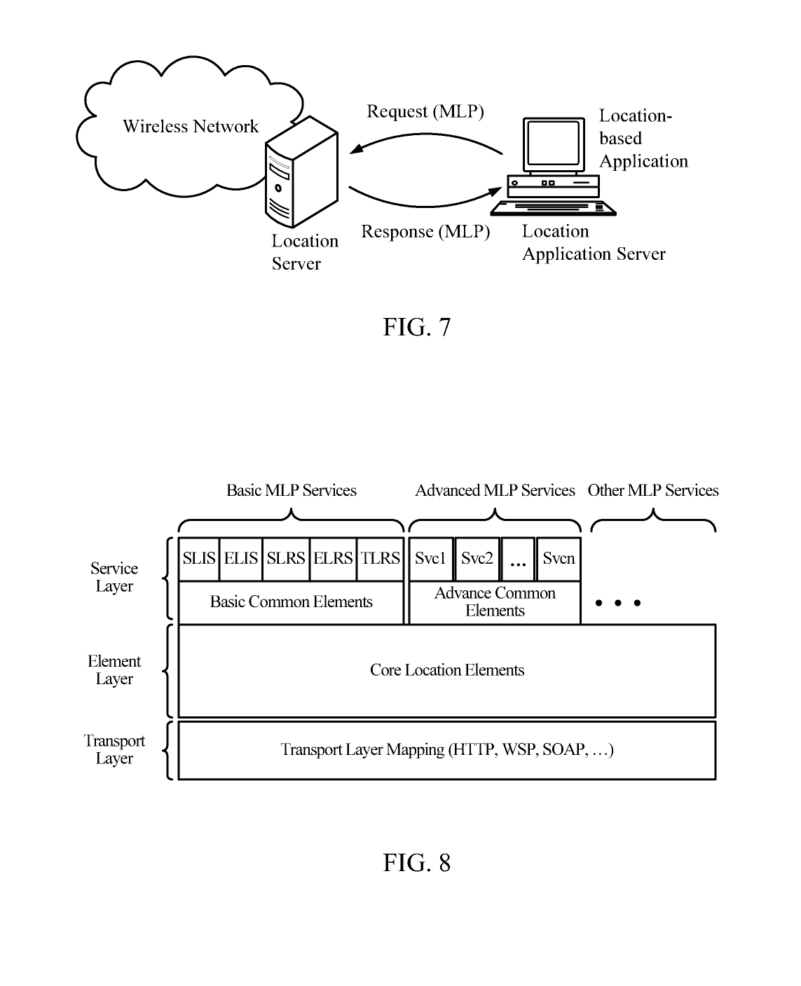

As pointed out in particular implementations above, an LS and LBS AS may communicate and/or interoperate at least in part according to aspects of OMA. FIG. 7 is a schematic diagram of a network including an LS (e.g., LS 206 in FIG. 1C) capable of communicating with an LBS AS (e.g., LBS AS 212 in FIG. 1C) using a mobile location protocol (MLP) defined according to OMA according to an embodiment. Here, an LS server may service mobile devices (e.g., mobile device 204 in FIG. 1C) on a wireless network (e.g., mobile devices as discussed above) and communicate with an LBS AS according to MLP. Here, the LBS AS may transmit MLP requests to the LS and receive MLP responses. According to an embodiment, an MLP may be implemented as an XML based protocol having a layered architecture as shown in FIG. 8. MLP may be used by the LBS AS to configure location reporting from the AS as exemplified in FIGS. 2B, 3B, 4B, 5B, 6B, 6C, 6D and 6E (e.g., as described for event B in FIGS. 2B, 3B, 4B, 5B and 6B).

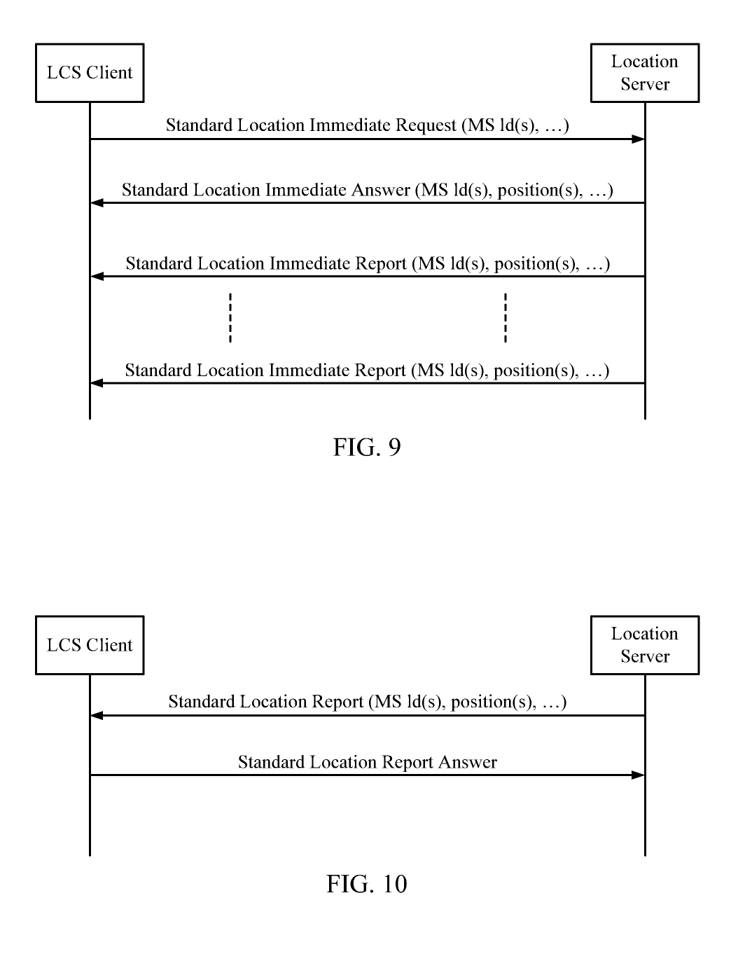

In one particular application as shown in FIG. 9, an MLP service may be used by a location services (LCS) client in order to request an estimated location of one or more target mobile devices if a response is required immediately or within a set time window. In particular implementations, an LBS AS receiving updates from an LS regarding states of mobile devices in a venue may comprise an LCS client. In this case the LCS client (e.g., LBS AS 212) may send a Standard Location Immediate Request (SLIR) to an LS (e.g., LS 206) including unique identifiers of the target mobile devices (e.g., an identifier for mobile device 204). The LS may acknowledge the request with a Standard Location Immediate Answer (SLIA) possibly including an estimated location result for each target mobile device. If the SLIA does not contain all requested estimated location results (it may not contain any), the LS may transmit one or more subsequent Standard Location Immediate Reports (SLIREP) containing the estimated location results until all estimated locations that have been requested are reported.

In another particular application as shown in FIG. 10, an MLP service may be used for unsolicited positioning reporting of one or more mobile devices. Here, an LS may initiate position reporting by sending a Standard Location Report (SLREP) including the position of one or more mobile devices and their identities. An LCS client may acknowledge receipt of the position report with a Standard Location Report Answer (SLRA).

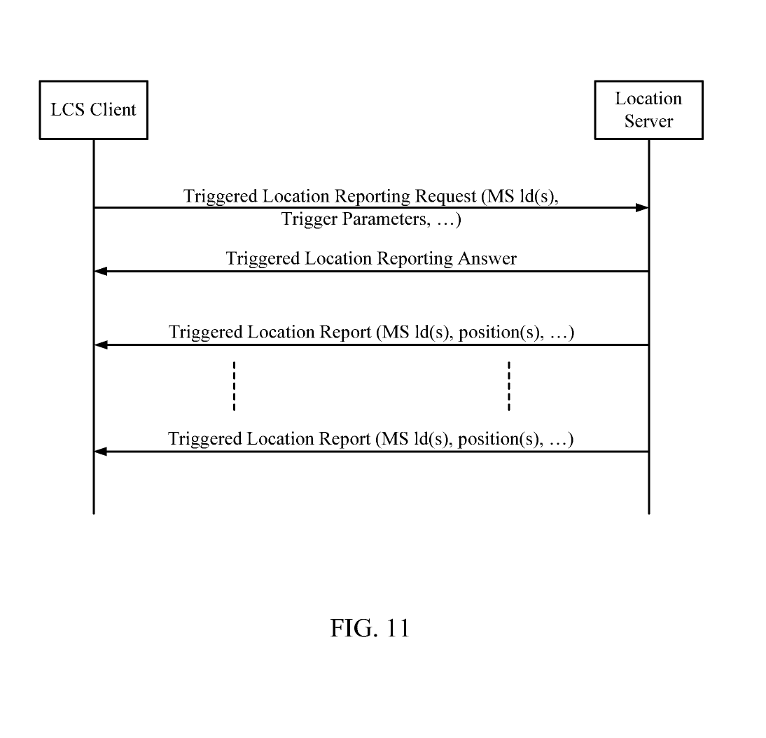

In another particular implementation as shown in FIG. 11, an MLP service may be used by an LCS client (e.g., LBS AS 212) to track the position of one or more target mobile devices. Here, tracking may be based on time (e.g., periodic location reporting), geographical area (e.g., entering or leaving a ‘geofence’) or other events. In this case the LCS client may transmit a Triggered Location Reporting Request (TLRR) to the LS (e.g., LS 206) including unique identifiers (e.g., MAC addresses, IP addresses, IMSIs) of the target mobile devices to be tracked and particular events for which location information is requested to be returned. The LS may acknowledge the TLRR with transmission of a Triggered Location Reporting Answer (TLRA). As events occur, the Location Server may report to the LCS Client in Triggered Location Report (TLREP) messages including type and (optionally) position of the event and associated mobile device identities for requested target mobile devices. Different event types that may be requested to be reported may include: (i) “time” where the LS is requested to report the positions of a mobile device or devices at fixed times (e.g., periodically); (ii) “area” where the LS is requested to report an MS's entry into or departure from a specific geographic target area (e.g., for which a report may be a simple event notification or may include more information such as for example the position of an MS); (iii) “ALN” where the LS is requested to report an MS's entry to or departure from an area covered by a specific ALN (e.g., for which a report may be a simple event notification or may include more information such as for example the position of the MS); and (iv) “analytics” where the LS is requested to report the occurrence of certain analytic events such as the number of MSs (or the rate of arrivals/departures) within a geographic area or ALN coverage area exceeding a certain threshold.

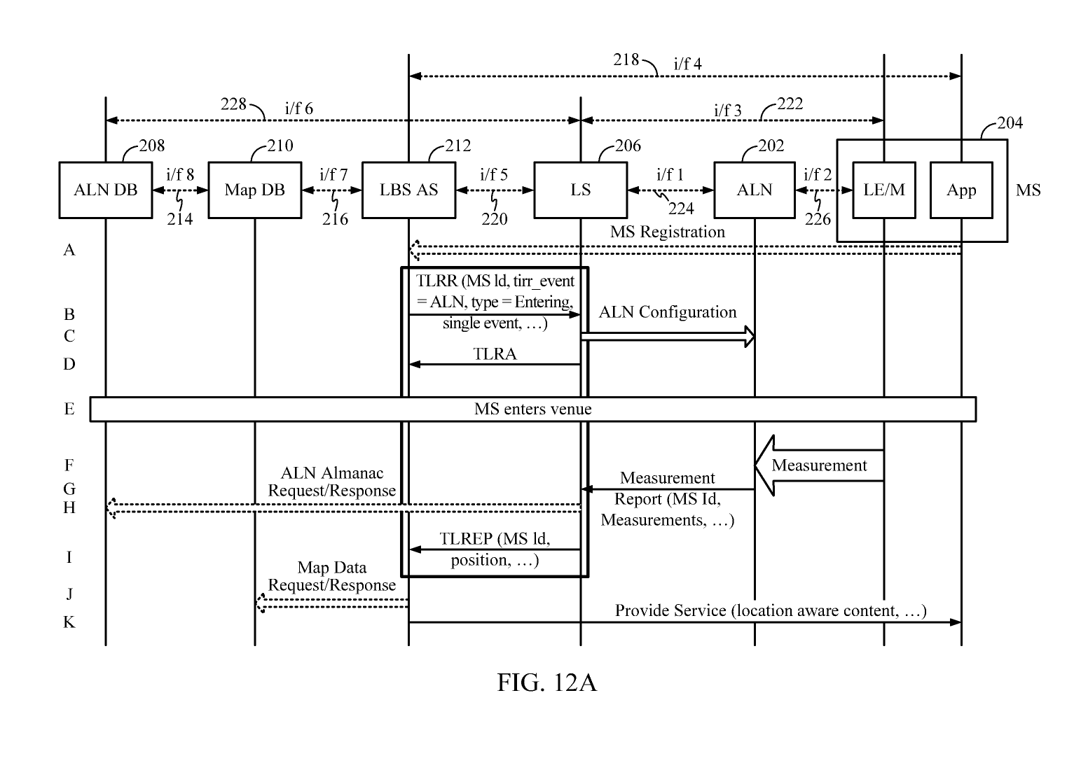

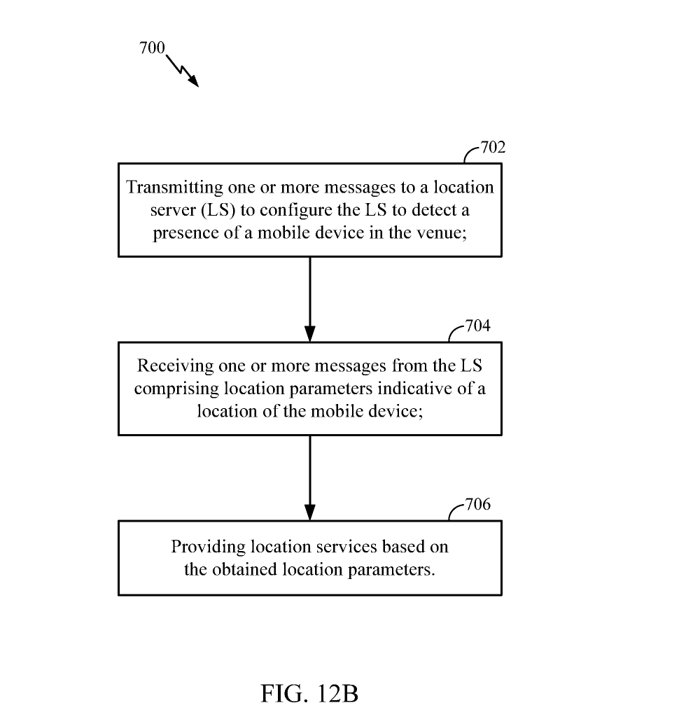

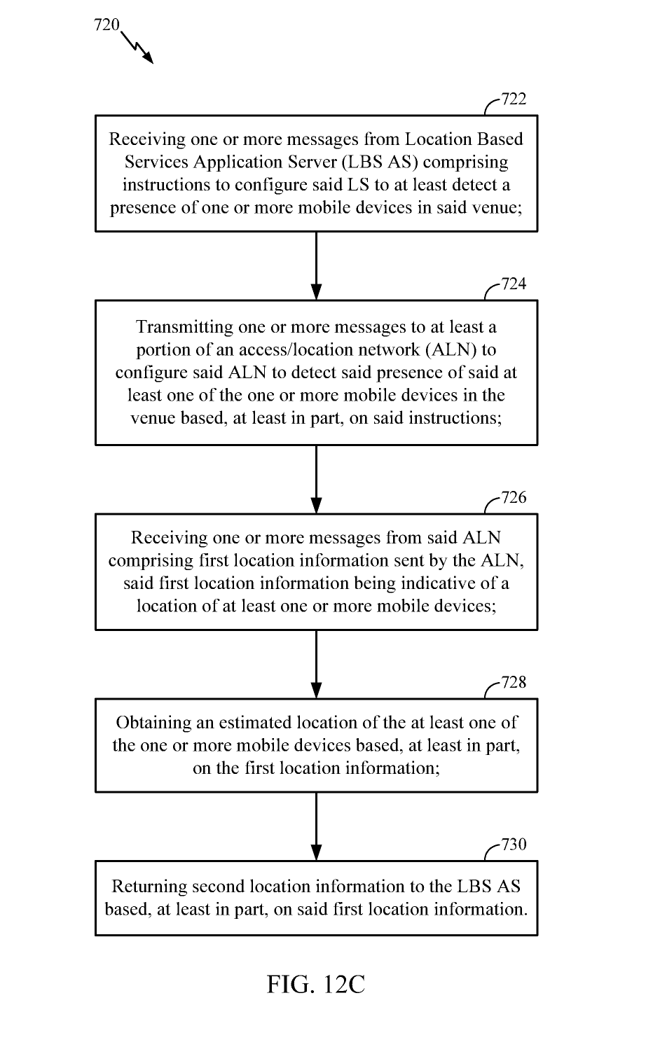

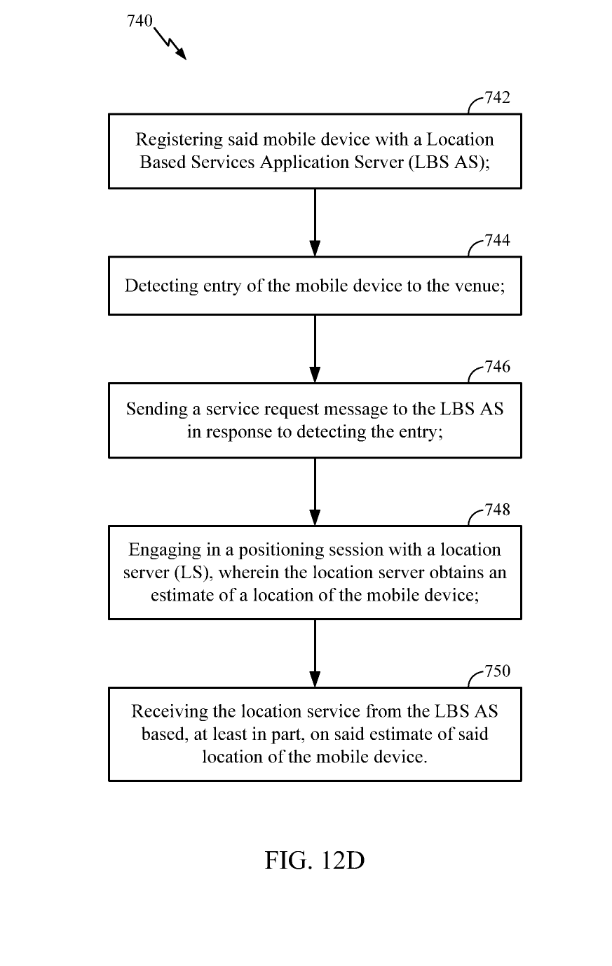

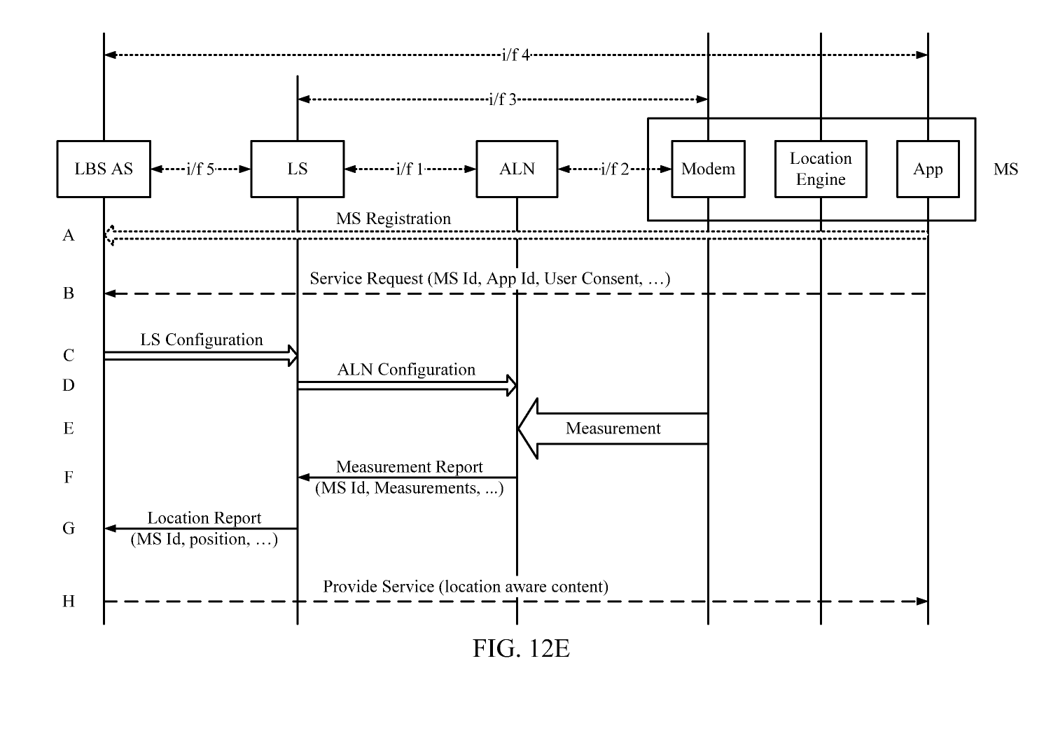

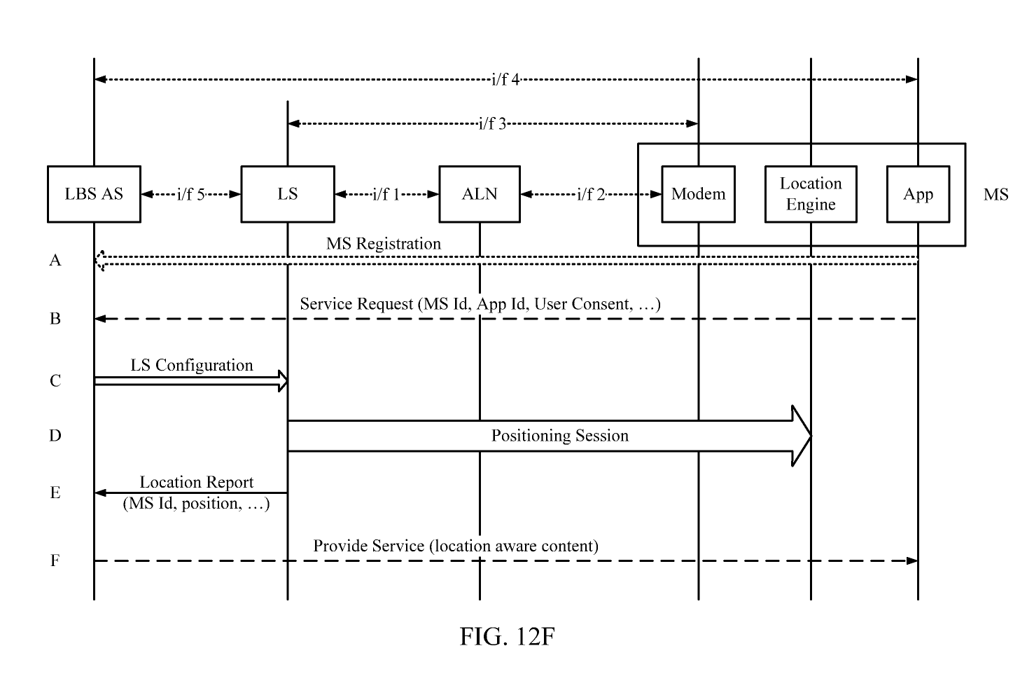

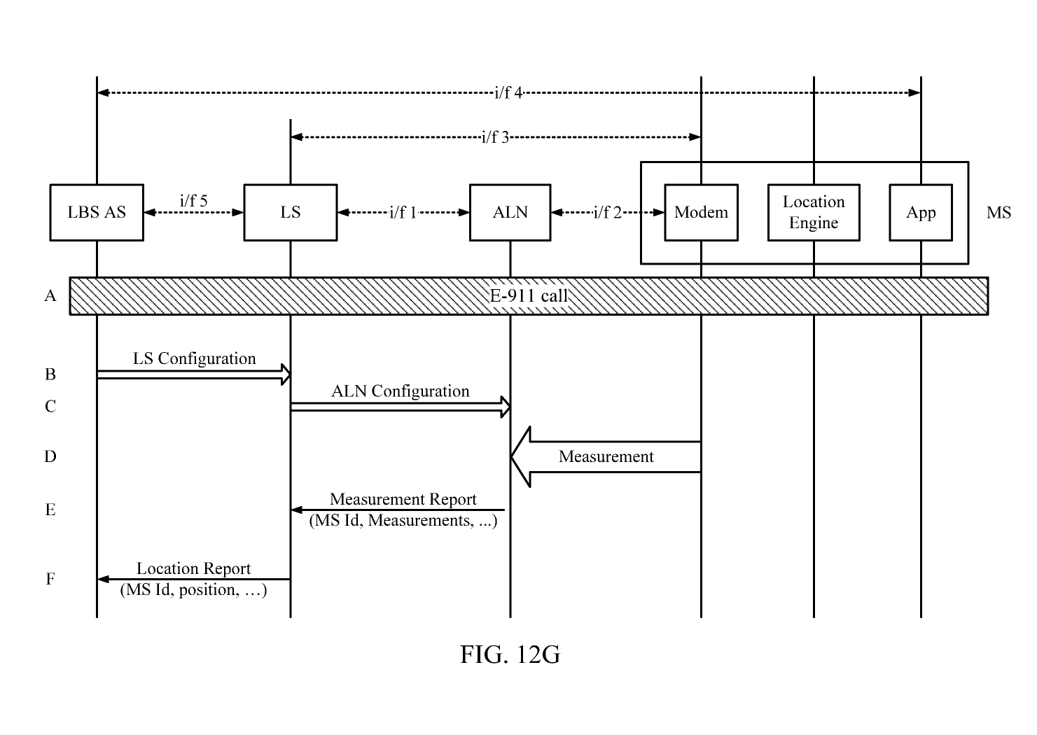

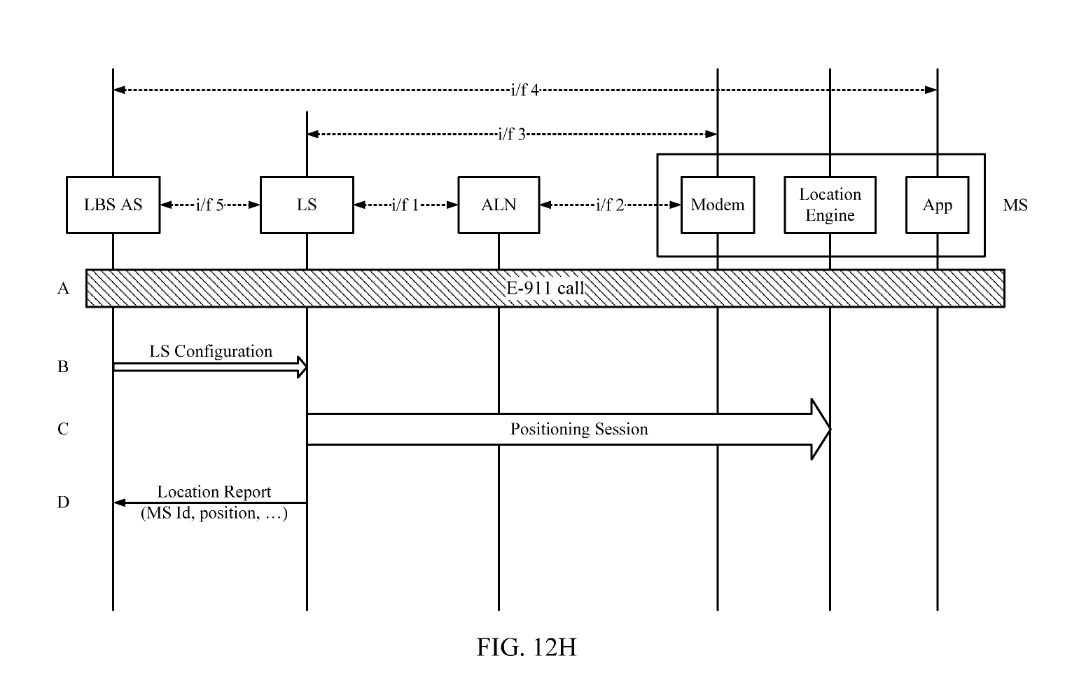

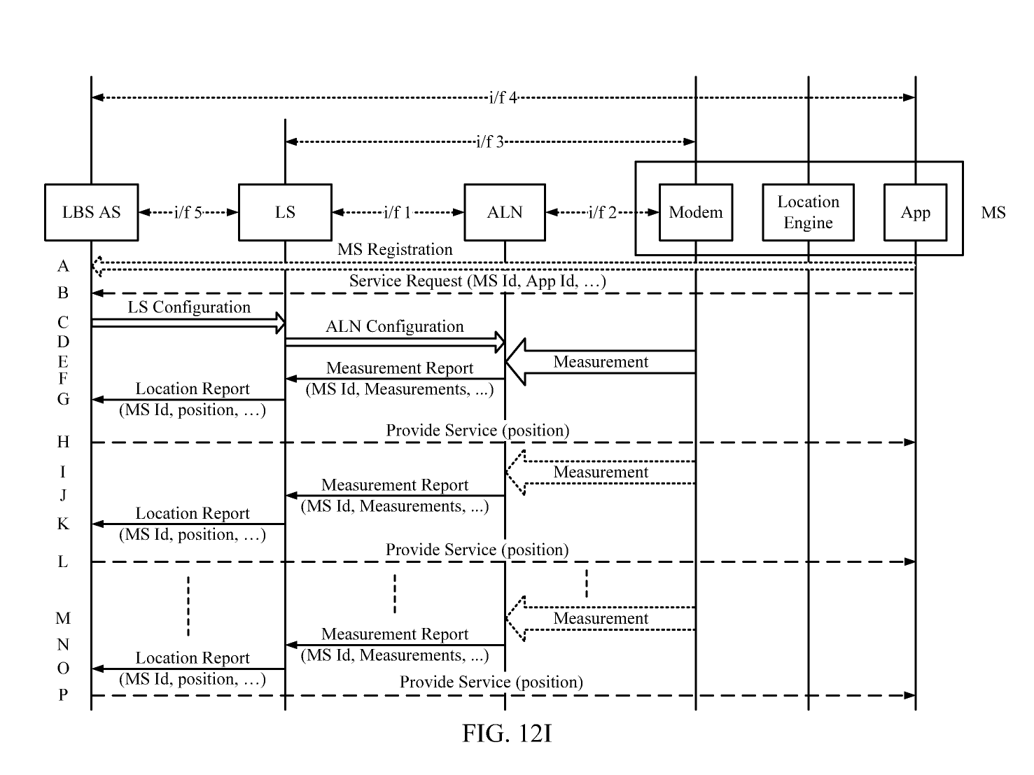

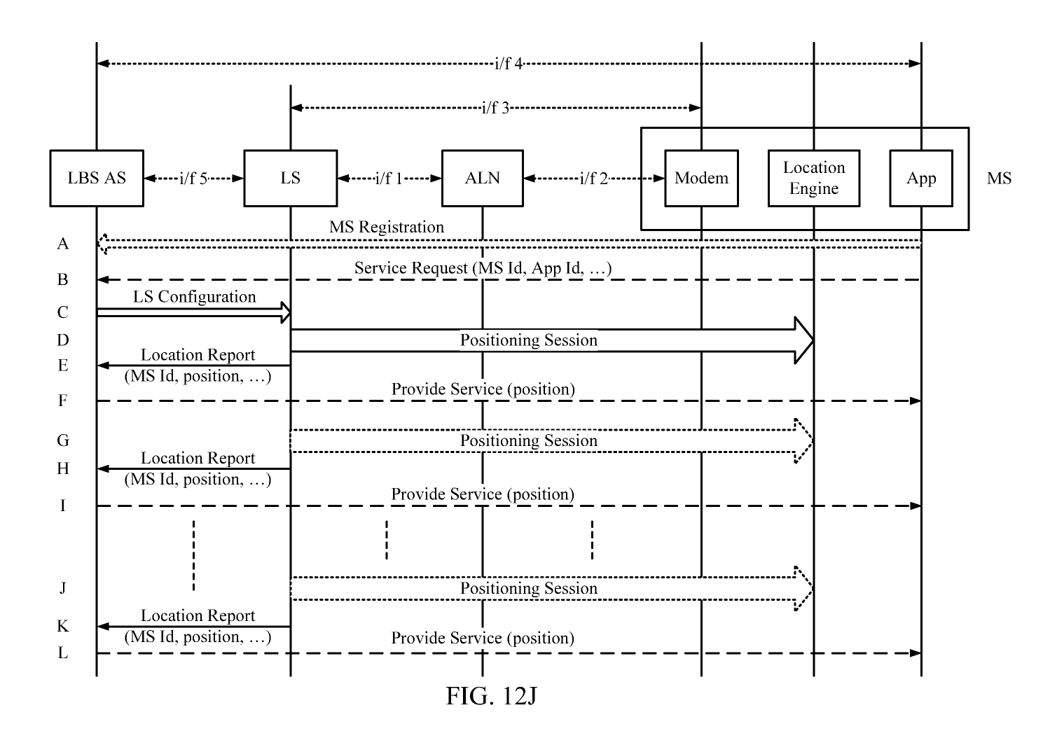

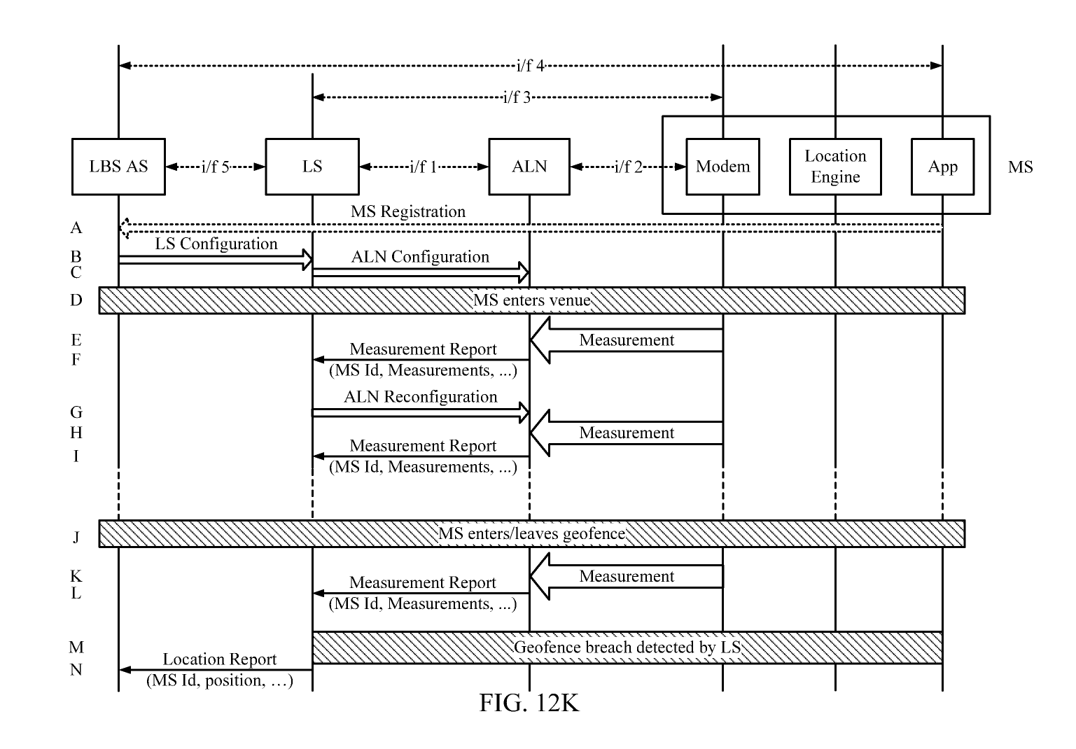

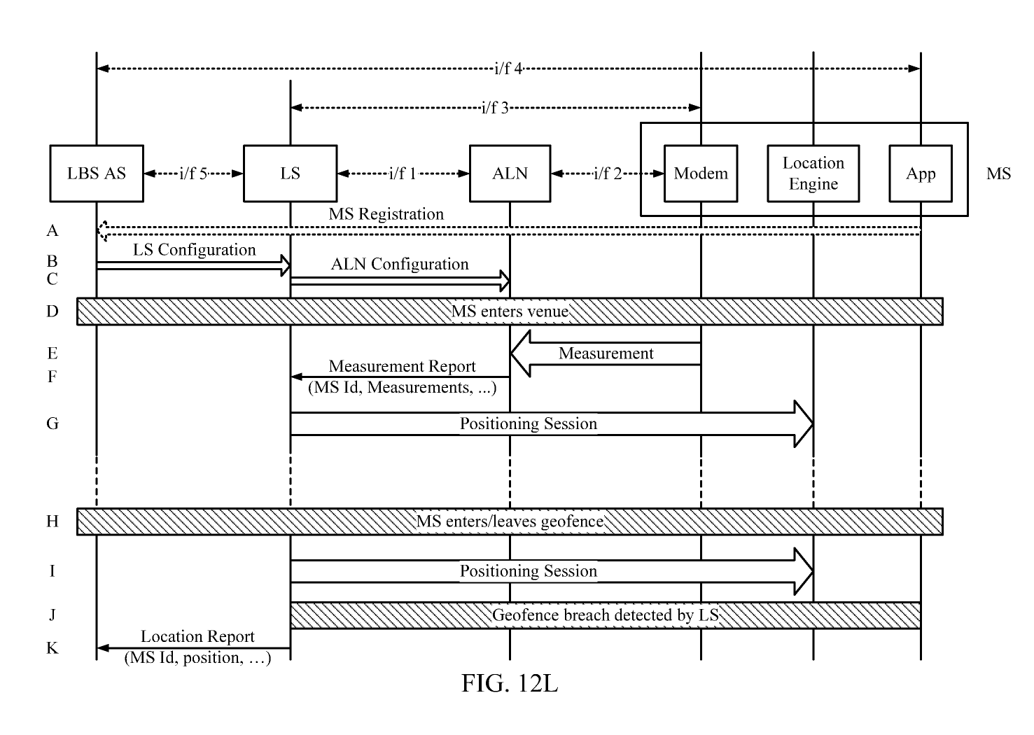

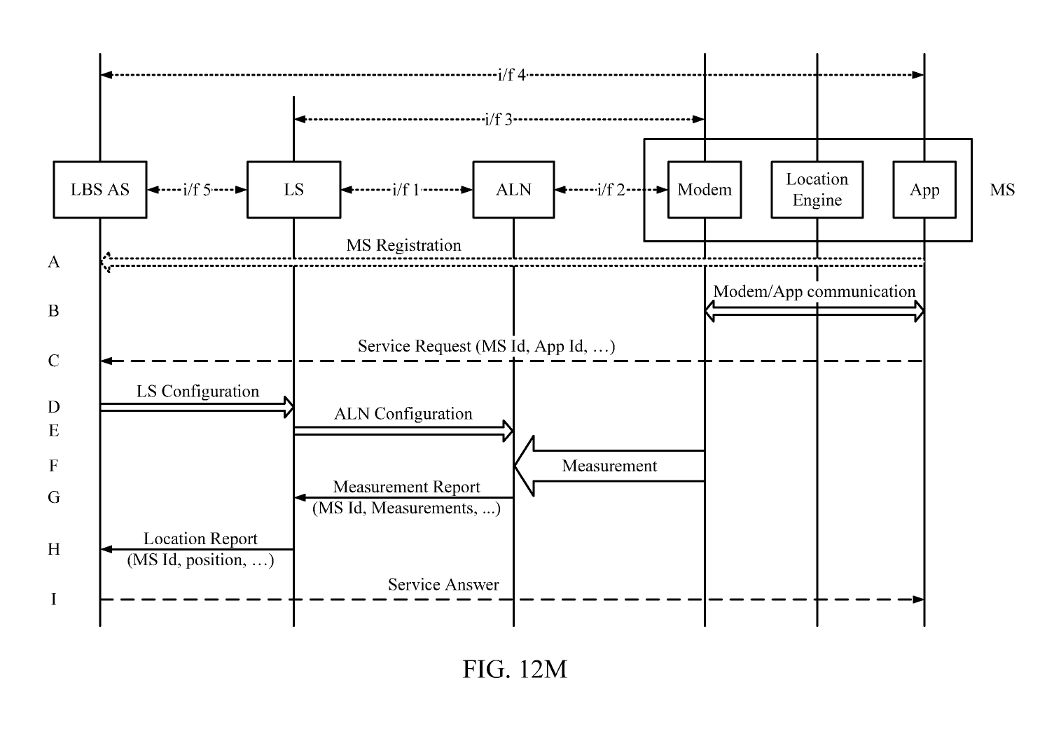

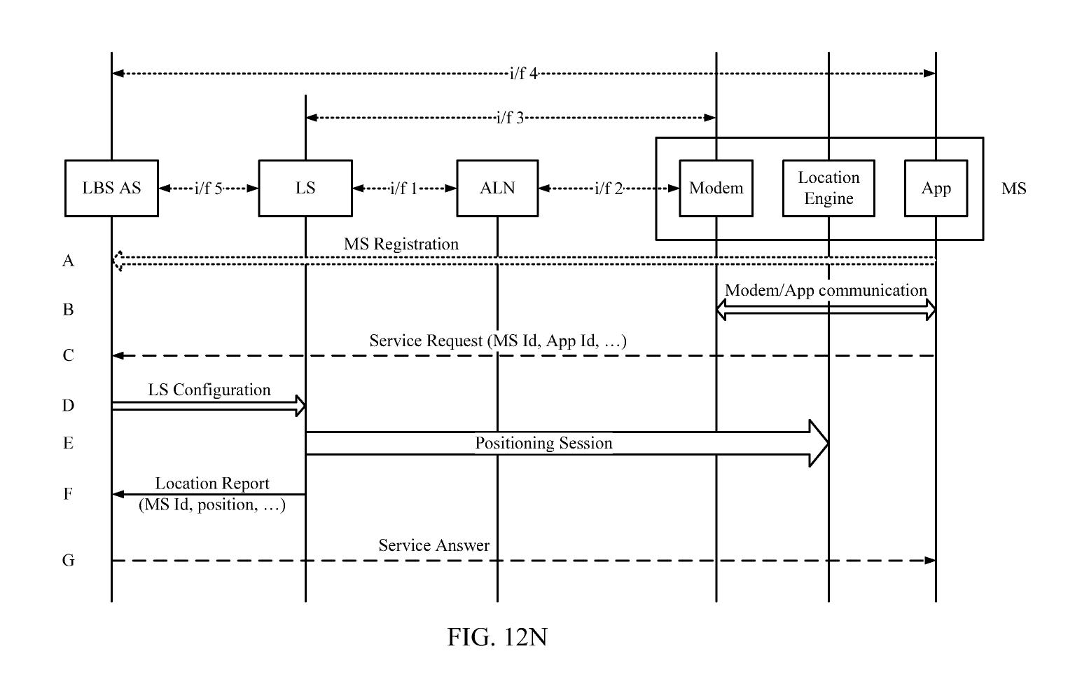

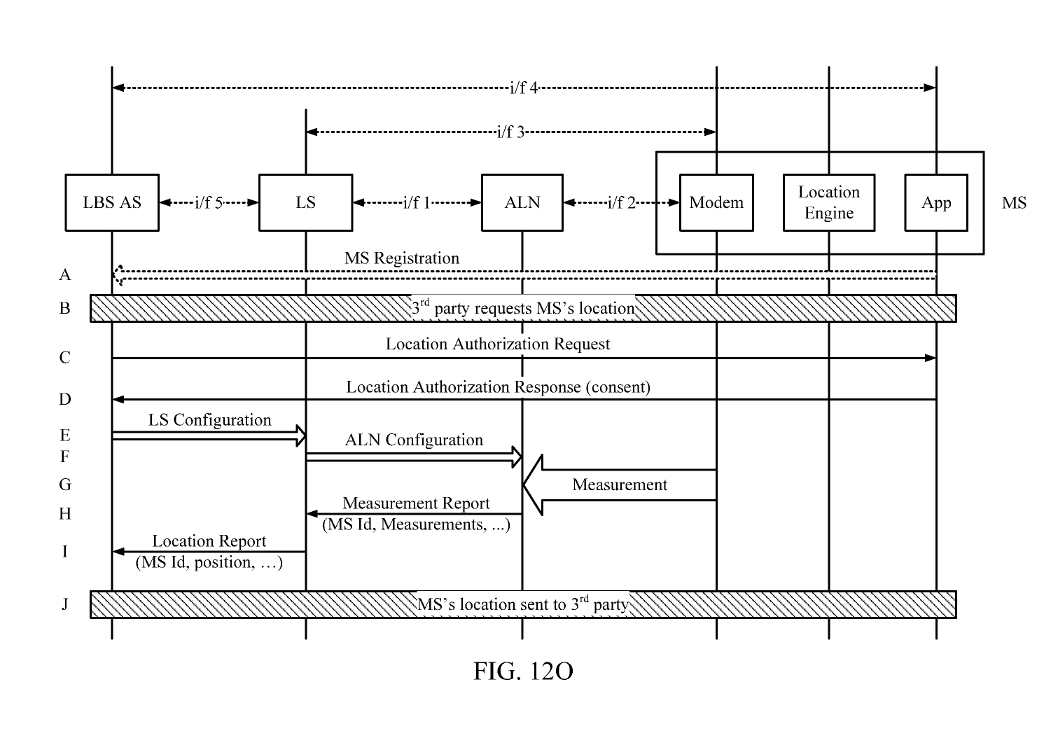

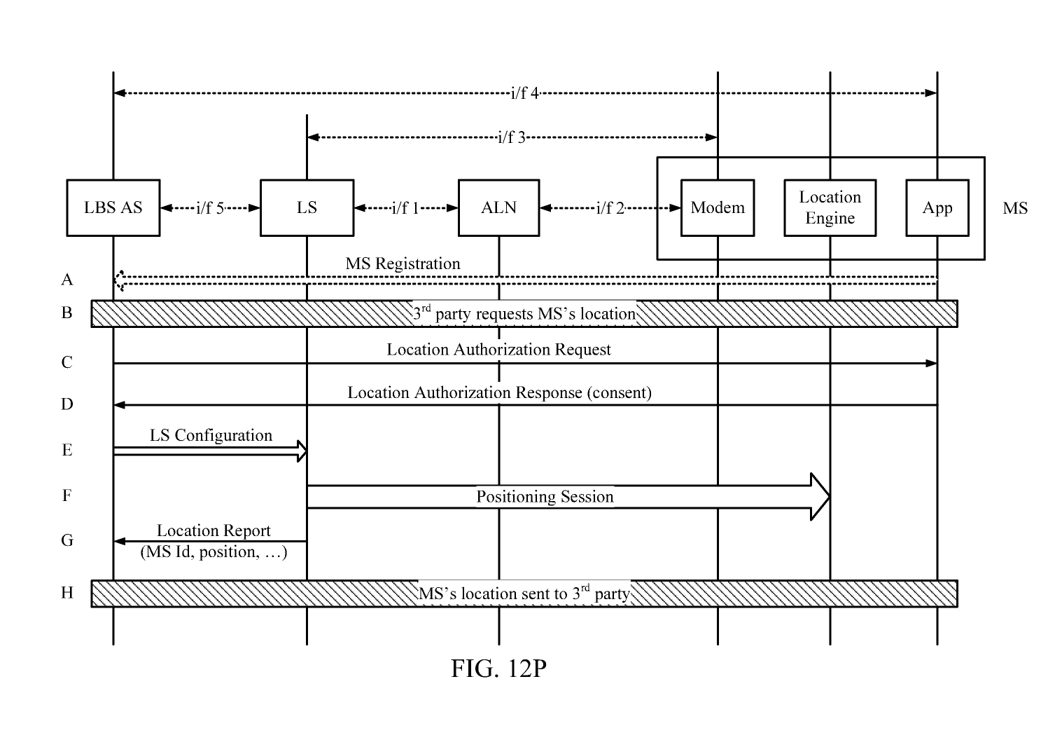

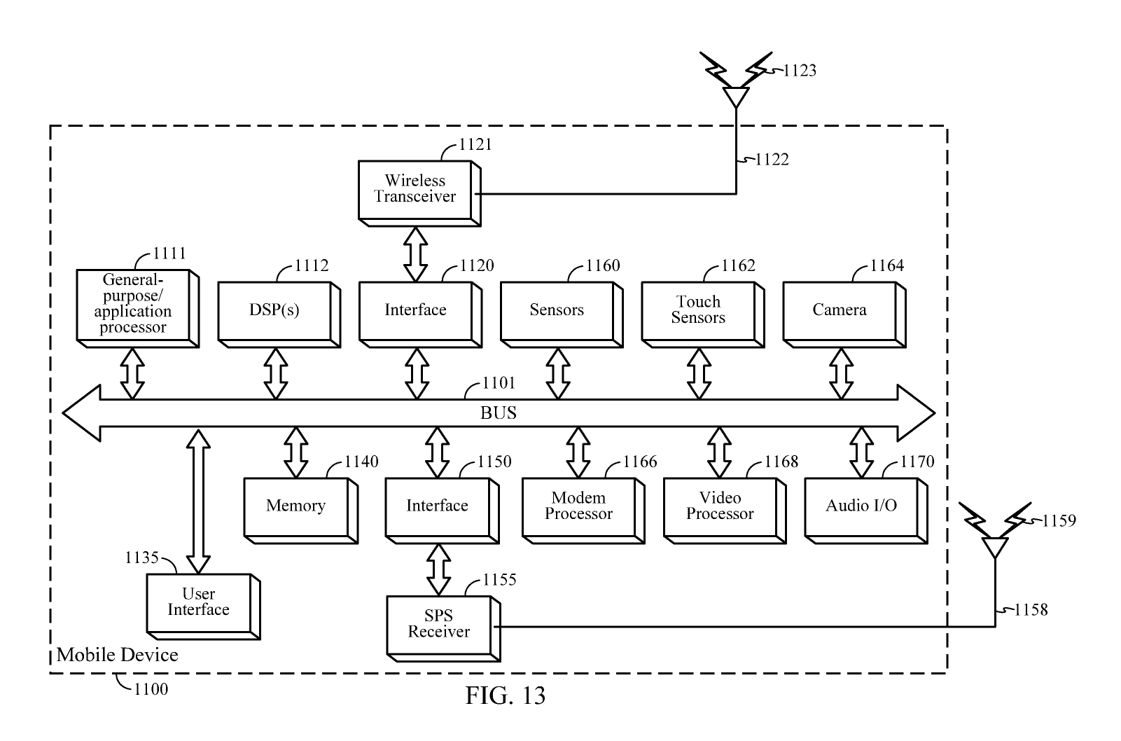

FIG. 12A is a message flow diagram illustrating a process of a method by one or more devices using MLP on message interface 220 in FIG. 10 to facilitate communication between an LS 206 and LBS AS 212 by applying one or more features of OMA MLP in accordance with an implementation. In one example, implementation, an LBS AS 212 may comprise an LCS client of the LS 206. It should be understood that aspects of communication between the LBS AS 212 and LS 206 as described with reference to FIG. 12A are not limited to the particular discussion of FIG. 12A but may be applied to communication between an LBS AS 212 and LS 206 as described above in connection with other message flow diagrams shown in FIGS. 2B, 3B, 4B, 5B, 6B, 6C, 6D and 6E. Here, at event A, a mobile device 204 may register with the LBS AS 212 for a particular service (and may provide a mobile device identity such as a MAC or IP address to LBS AS 212 and a set of supported or preferred services to LBS AS 212) which may entail, for example, providing the mobile device with location aware content (e.g., venue map with an estimated location of the mobile device) in response to the mobile device entering a venue.

At event B, the LBS AS 212 may send an MLP TLRR message to the LS 206 including unique identifiers (e.g. MAC address, IP address) of mobile devices of interest (e.g. mobile device 204) and an event type (tlrr_event) of ALN/entering that may indicate the event where a mobile device is detected by ALN 202 as entering a venue. Here, in this particular example, a single event may be selected such that only a first mobile device entry may be counted as an event. At event C, the LS may configure the ALN 202 to detect the one or more particular mobile devices and transmit a measurement report to the LS in response to the MS entering (or leaving) an area covered by ALN 202. At event D, the LS 206 may acknowledge the service request in a TLRA response message to LBS AS 212. At event E, a mobile device 204 of interest enters a venue (e.g., an area covered or served by the ALN 202). At event F, the ALN 202 may detect that one or more mobile devices (e.g. mobile device 204) have entered an area covered or served by the ALN 202 and perform measurements enabling estimation of locations of the mobile devices. After having obtained measurements enabling estimates of locations of the mobile devices, at event G the ALN 202 may transmit a message comprising the measurement results in a Measurement Report to the LS 206 including unique identifiers (e.g., MAC addresses, IP addresses) of the mobile devices. At event H, the LS 206 may transmit a message to the ALN DB 208 to request and obtain ALN Almanac data to assist or enable calculation of estimated locations of the mobile devices (e.g., mobile device 204). At event I, the LS 206 may compute estimated locations of the mobile devices and transmit a TLREP message to the LBS AS 212 including unique identifiers and estimated locations of the mobile devices. At event J, the LBS AS 212 may request map data from Map DB 210 to assist with providing location aware content based, at least in part, on the estimated locations of the mobile devices. At event K, the LBS AS 212 may provide location aware content to applications hosted on the mobile devices (e.g., mobile device 204) based, at least in part, on the estimated locations of the mobile devices received at event I. Events F through K may be repeated one or more times (not shown in FIG. 12) to report additional (e.g., new) mobile device locations to LBS AS 212 and enable further provision of location aware content by LBS AS 212 to mobile devices (e.g., mobile device 204). Events B through K may also or instead be repeated to enable LBS AS 212 to request other types of location reporting associated with different configuration instructions at event B (e.g., to enable LBS AS 212 to track mobile device 204 while within the venue and provide other location related services based on mobile device 204's current location).

In particular environments, various other use cases may be implemented using the network elements described previously for FIGS. 1B and 1C according to techniques described herein. Such example use cases are enumerated herein as use cases 1 through 9. In use case 1, a position or estimated location of a mobile device may be determined and location-sensitive content (e.g., maps) may be displayed to a user via an application or browser on the mobile device. In use case 2, a position or estimated location of a mobile device may be determined and location sensitive content may be provided to a user as in in use case 1 but the user may choose to authorize or not authorize sharing of the position or estimated location of the mobile device with a third party such as a venue owner in order to enable the user of the mobile device to obtain his location and location sensitive content. In use case 3, a position or estimated location of a mobile device and/or location sensitive content may only be made available to a specific trusted application in a mobile device.

In use case 4, a user may make an emergency call and then be located in response to a request from a public safety answering point (PSAP). In use case 5, a location of an asset may be tracked (and the asset may be potentially recovered). The tracked location may be forwarded to an inventory manager or asset tracking system.

In use case 6, entry in to or exit from an area bounded by a geofence may be detected to enable subsequent notification and action (e.g., when a user can only download a certain document while in an office and a geofence is used to detect entry to or departure from the office). In an alternative use case 7, entry into or departure from an area bounded by a relative geofence (e.g., entry into or departure from an area bounded by a geofence centered around another user) may be detected and subsequent action taken (e.g., a parent tracking the relative location of a child in a crowd with the parent acting as the relative geofence within which the child may move and with the parent being notified by an alarm if the relative geofence is breached by the child).

In use case 8, location enabled troubleshooting of WLAN connections may be performed. In use case 9, a user may determine his own position or estimated location and that of a third party provided that the third party grants permission to the user to receive the location of the third party. Exemplary message communication flows that enable use cases 1 to 9 are now described referring to FIGS. 12E through 12P that show interactions between or among elements in the architectures described earlier with reference to FIGS. 1A, 1B and 1C. Elements in FIGS. 12E through 12P may correspond to elements in the architecture 230 of FIG. 1B, the architecture 200 of FIG. 1C and to elements used in FIGS. 2B, 3B, 4B, 5B, 6B, 6C, 6D, 6E and 12A via the use of like names. It should be noted that the mobile device (or MS) in each figure is shown as comprising a modem, a location engine and an application (App) that may in some implementations be the true endpoints of certain interfaces supported by the mobile device (or MS). The sequence of events shown in and described for FIGS. 12E through 12P may occur in the order shown and described or may occur in some other order in some implementations. In addition, some events may occur concurrently in which case some events may start before other events and finish during or after these other events.

FIG. 12E is a message flow diagram of a process that may be used to implement the aforementioned use cases 1, 2 and 3 using a network based positioning approach according to an embodiment. At event A, an App on the MS may register with the LBS AS (e.g., the App may support getting directions to a gate at an airport). At event B, in response to the user of the MS interacting with the App (e.g. to receive gate directions at an airport), the App may request from the LBS AS location sensitive context (e.g., directions to the gate) and include identifiers of the MS and the App in its request. If applicable, the request may also indicate the user's consent that the LBS AS may share the user's position or estimated location with third parties (e.g., the venue owner). At event C, the LBS AS may send a request (e.g., LS Configuration message) for a single position fix for the MS to the LS. At event D, the LS may send a request (e.g., ALN Configuration message) for a single position fix for the MS to the ALN. At event E, the ALN may detect the presence of the MS (e.g. following interaction by the MS with some access point in the ALN) and may perform access or location network measurements of the MS (e.g., of signals transmitted by the MS). At event F, the ALN may transmit the obtained access or location network measurements in a measurement report to the LS. At event G, the LS may calculate an estimated location of the user (e.g., MS) based, at least in part, on the access or location network measurements and may transmit the result to the LBS AS in a location report. At event H, the LBS AS may provide the location sensitive content to the App on the MS (e.g. may provide directions to a gate at an airport based on the current MS location provided at event G). The App may then provide the location sensitive content to the user.

FIG. 12F is a message flow diagram of a process that may be used to implement the aforementioned use cases 1, 2 and 3 using a mobile based positioning approach according to an embodiment. At event A, an App on the MS may register with the LBS AS (e.g., app for getting directions to the gate at an airport). At event B, the App may request location sensitive content (e.g., directions to the gate) from the LBS AS and include identifiers of the MS and App in its request. If applicable, the request may also indicate a user's consent that the LBS AS may share its location with 3rd parties (e.g., venue owner, etc.). At event C, the LBS AS may transmit a request (e.g., LS Configuration message) for a single position fix for the MS to the LS. At event D, the LS may instigate a positioning session with a location engine on the MS (e.g. using the SUPL location solution) at the end of which the LS may obtain an estimated location or position of the MS. At event E, the LS may transmit the estimated location to the LBS AS in a Location Report. At event F, the LBS AS may provide location sensitive content to the App on the MS (e.g. may provide directions to a gate at an airport based on the current MS location provided at event E). The App may then provide the location sensitive content to the user.

FIG. 12G is a message flow diagram of a process that may be used to implement the aforementioned use case 4 using a network based positioning approach according to an embodiment. At event A, a user of an MS may place an emergency 911 call (E911 call). In response to the E911 call, at event B a public safety agency (e.g., represented by the LBS AS in this particular illustration) may submit a location request for the MS engaged in the E911 call to the LS (e.g., LS Configuration message). At event C, the LS may send a request (e.g., ALN Configuration message) for a single position fix for the MS to the ALN. At event D, the ALN may perform access or location network measurements of the MS. At event E, the ALN may transmit the access or location network measurements in a Measurement Report to the LS. At event F, the LS may calculate a position or estimated location of the MS based, at least in part, on the access or location network measurements, and transmit the result to the LBS AS in a Location Report.

FIG. 12H is a message flow diagram of a process that may be used to implement the aforementioned use case 4 using a mobile based positioning approach according to an embodiment. At event A, a user of an MS may place an E911 call. In response to the E911 call, at event B, a public safety agency (represented by the LBS AS in this particular illustration) may submit a location request for the MS engaged in the E911 call to the LS (e.g., LS Configuration message). At event C, the LS may instigate a positioning session (e.g. using the SUPL location solution) with a location engine on the MS at the end of which the LS may obtain the MS's position. At event D, the LS may transmit the position result to the LBS AS in a Location Report.

FIG. 12I is a message flow diagram of a process that may be used to implement the aforementioned use case 5 using a network based positioning approach according to an embodiment. At event A, an App on the MS may register with the LBS AS (in this case for asset tracking). At event B, the App may request asset tracking from the LBS AS and include identifiers of the MS and the App in its request. At event C, the LBS AS may transmit a request (e.g., LS Configuration message) for periodic position fixes for the MS to the LS. At event D, the LS may transmit a request (e.g., ALN Configuration message) for periodic position fixes for the MS to the ALN. At event E, the ALN may perform access or location network measurements of the MS (e.g., measurements of signals transmitted by the MS). At event F, the ALN may send the access or location network measurements of the MS in a Measurement Report to the LS. At event G, the LS may calculate an estimated location of the MS based, at least in part, on the access or location network measurements received and send the position result to the LBS AS in a Location Report. At event H, the LBS AS may update an access tracking system with the MS's location (not shown). If the App on the MS is responsible for updating the asset tracking system with the MS's most recent position, the LBS AS may return the position result to the App on the MS at event H. Events 1 through L may comprise a repetition of events E through H, respectively, in which the position of the MS is obtained following some periodic time interval. Similarly, events M through P may comprise a repetition of events 1 through L, respectively, following a further periodic time interval. In a particular implementation, periodic positioning may be repeated until the end of an asset tracking session has been reached.

FIG. 12J is a message flow diagram of a process that may be used to implement the aforementioned use case 5 using mobile based positioning according to an embodiment. At event A, an App on the MS may register with an LBS AS (in this case for asset tracking). At event B, the App may request asset tracking from the LBS AS and include identifiers of the MS and App in its request. At event C, the LBS AS may send a request (e.g., LS Configuration message) for periodic position fixes for the MS to the LS. At event D, the LS may instigate a positioning session (e.g. using SUPL) with a location engine on the MS at the end of which the LS may obtain the MS's position or estimated location. At event E, the LS may send the position result to the LBS AS in a Location Report. At event F, the LBS AS may update the access tracking system with the MS's location (not shown in FIG. 12J). If the App on the MS is responsible for updating the asset tracking system with the MS's most recent position, the LBS AS may return the position result to the App on the MS at event F. Events G through I may comprise a repetition of events D through F, respectively, following some periodic time interval. Events J through L may comprise a repetition of events G through I, respectively, following a further periodic time interval. Periodic positioning may be further repeated until the end of the asset tracking session has been reached.

FIG. 12K is a message flow diagram of a process that may be used to implement the aforementioned use cases 6 or 7 using network based positioning according to an embodiment. At event A, an App on the MS may register with the LBS AS (in this case for support of an absolute or relative geofence) and may later send a service request to the LBS AS to instigate the geofence (not shown in FIG. 12K). At event B, the LBS AS may initiate the geofence by sending a request (e.g., LS Configuration message) for geofence positioning to the LS. The LBS AS may include a definition of the geofence (absolute or relative) and any relevant geofence parameters in its request (e.g. such as a request to report when the MS enters or leaves the geofence). At event C, the LS may issue a detection request (e.g., ALN Configuration message) for the MS to the ALN. At event D, the MS may enter the venue. At event E, the ALN may detect a presence of the MS through access or location network measurements. At event F, the ALN may send the measurement results to the LS (e.g., Measurement Report) which may enable the LS to calculate the MS's position or estimated location. At event G, the LS may reconfigure the ALN to periodically obtain access or location network measurements of the MS. At event H, the ALN may perform access or location network measurements of the MS (e.g., measurements of signals transmitted by the MS). At event I, the ALN may send the measurement results to the LS based on which the LS may calculate the position or estimated location of the MS. Events H and I may be repeated to enable the LS to detect a geofence related event (e.g. such as the MS entering the geofence and/or leaving the geofence). At event J, the MS may breach the geofence by entry into or departure from an area bounded by the geofence. At event K, the ALN may perform access or location network measurements of the MS. At event L, the ALN may send measurement results to the LS based on which the LS may calculate a position of estimated location of the MS. At event M, the LS may detect that the geofence has been breached. At event N, the LS may inform the LBS AS that the geofence has been breached by sending a Location Report including the MS Id and the MS's position.

FIG. 12L is a message flow diagram a process that may be used to implement the aforementioned use cases 6 or 7 using mobile based positioning according to an embodiment. At event A, an App on the MS may register with the LBS AS (in this case for support of an absolute or relative geofence) and may later send a service request to the LBS AS to instigate the geofence (not shown in FIG. 12K). At event B, the LBS AS may initiate the geofence by transmitting a request (e.g., LS Configuration message) for geofence positioning to the LS. The LBS AS may include a definition of the geofence (absolute or relative) and any relevant geofence parameters in its request (e.g. such as a request to report when the MS enters or leaves the geofence). At event C, the LS may issue a detection request (e.g., ALN Configuration message) for the MS to the ALN. At event D, the MS may enter the venue. At event E, the ALN may detect the presence of the MS through access or location network measurements. At event F, the ALN may send the measurement results to the LS (Measurement Report), which may enable the LS to calculate the MS's position or estimated location. At event G, the LS may commence a positioning session with a location engine on the MS (e.g. using SUPL) in mobile centric mode in order to detect any geofence breach by the MS. The positioning session may simply deliver assistance data to the MS so that the MS can on its own detect any geofence breaches (a positioning session may also be used in order for the MS to report a geofence breach to the LS) or the positioning session may periodically calculate an estimated location or position of the MS and determine whether a geofence breach has occurred. The positioning session may use a network initiated triggered SUPL session according to OMA SUPL version 2.0, 2.1 or 3.0. Positioning sessions may be conducted between the LS and the location engine on an as needed basis and may form part of a single triggered positioning session in the case of SUPL. At event H, the MS may breach the geofence (entering or leaving). At event I, if the location engine on the MS detected the geofence breach on its own, a positioning session may be instigated by the location engine with the LS and used to report the geofence breach to the LS. Otherwise, the LS and the location engine on the MS may engage in a positioning session in order to detect at event J at the LS that the geofence has been breached. At event K, the LS may inform the LBS AS that the geofence has been breached by sending a Location Report including an identifier of the MS and the MS's position or estimated location.

FIG. 12M is a message flow diagram of a process that may be used to implement the aforementioned use case 8 using network based positioning according to an embodiment. At event A, an App on the MS may register with the LBS AS (in this case for WLAN trouble shooting). At event B, a modem and App on the MS may communicate to register problems with a WLAN. At event C, the App on the MS may request estimation of a location of the MS to an LBS AS in order to locate the WLAN problem (e.g., may be possible as long as the MS can still establish a data connection to the LBS AS). At events D through H, a position or estimated location of the MS may be determined as discussed for example for events C through G in FIG. 12E. At event I, the LBS AS may send an acknowledgement (Service Answer) back to the App on the MS.

FIG. 12N is a message flow diagram of a process that may be used to implement the aforementioned use case 8 using mobile based positioning according to an embodiment. At event A, an App on an MS may register with an LBS AS (e.g., in this case for WLAN trouble shooting). At event B, the modem and App on the MS may communicate to register problems with the WLAN. At event C, the App on the MS may initiate determination at an LBS AS of a position or estimated location of the MS in order to locate the WLAN problem (e.g., possible as long as the MS can establish a data connection to the LBS AS). At events D through F a position or estimated location of the MS may be determined as described for example for events C through E in FIG. 12F. At event G, the LBS AS may send an acknowledgement (e.g., Service Answer) back to the App on the MS.

FIG. 12O is a message flow diagram of a process that may be used to implement the aforementioned use case 9 using network based positioning according to an embodiment. At event A, an App on an MS may register with an LBS AS (e.g., for a third party location in this particular example). At event B, a third party may request the LBS AS for a position or estimated location of the MS. At event C, the LBS AS may request consent from the user (via the App) to provide the position of the user to the requesting third party. At event D, the user may give consent (via the App) to having its position or estimated location being determined on behalf of the third party. At events E through I, an estimated location or position of an MS may be determined as described for events C through G in FIG. 12E. At event J, the LBS AS may send a computed position or estimated location for the MS to the third party.

FIG. 12P is a message flow diagram of a process that may be used to implement the aforementioned use case 9 using mobile based positioning according to an embodiment. At event A, an App on an MS may register with an LBS AS (in this case for a third party location). At event B, a third party may request the LBS AS for a position or estimated location of the MS. At event C, the LBS AS may request consent from the user via the App. At event D, the user may give consent via the App to being located on behalf of the requesting third party. At events E through G, a position or estimated location of the MS may be determined as described for events C through E in FIG. 12F. At event H, the LBS AS may send a position or estimated location of the MS to the requesting third party.

FIG. 13 is a schematic diagram of a mobile device (e.g. mobile device 204) according to an embodiment. Mobile device 100 (FIG. 1A) may comprise one or more features of mobile device 1100 shown in FIG. 13. In certain embodiments, mobile device 1100 may also comprise a wireless transceiver 1121 which is capable of transmitting and receiving wireless signals 1123 via wireless antenna 1122 over a wireless communication network. Wireless transceiver 1121 may be connected to bus 1101 by a wireless transceiver bus interface 1120. Wireless transceiver bus interface 1120 may, in some embodiments be at least partially integrated with wireless transceiver 1121. Some embodiments may include multiple wireless transceivers 1121 and wireless antennas 1122 to enable transmitting and/or receiving signals according to corresponding multiple wireless communication standards such as, for example, versions of IEEE Std. 802.11, CDMA, WCDMA, LTE, UMTS, GSM, AMPS, Zigbee and Bluetooth, just to name a few examples.

Mobile device 1100 may also comprise SPS receiver 1155 capable of receiving and acquiring SPS signals 1159 via SPS antenna 1158. SPS receiver 1155 may also process, in whole or in part, acquired SPS signals 1159 for estimating a location of mobile device 1000. In some embodiments, general-purpose processor(s) 1111, memory 1140, DSP(s) 1112 and/or specialized processors (not shown) may also be utilized to process acquired SPS signals, in whole or in part, and/or calculate an estimated location of mobile device 1100, in conjunction with SPS receiver 1155. Storage of SPS or other signals (e.g., signals acquired from wireless transceiver 1121) for use in performing positioning operations may be performed in memory 1140 or registers (not shown). As such, general-purpose processor(s) 1111, memory 1140, DSP(s) 1112 and/or specialized processors may provide a location engine for use in processing measurements to estimate a location of mobile device 1100.

Also shown in FIG. 13, mobile device 1100 may comprise digital signal processor(s) (DSP(s)) 1112 connected to the bus 1101 by a bus interface 1110, general-purpose processor(s) 1111 connected to the bus 1101 by a bus interface 1110 and memory 1140. Bus interface 1110 may be integrated with the DSP(s) 1112, general-purpose processor(s) 1111 and memory 1140. In various embodiments, functions may be performed in response execution of one or more machine-readable instructions stored in memory 1140 such as on a computer-readable storage medium, such as RAM, ROM, FLASH, or disc drive, just to name a few example. The one or more instructions may be executable by general-purpose processor(s) 1111, specialized processors, or DSP(s) 1112. Memory 1140 may comprise a non-transitory processor-readable memory and/or a computer-readable memory that stores software code (programming code, instructions, etc.) that are executable by processor(s) 1111 and/or DSP(s) 1112 to perform functions described herein.

FIG. 12B is a flow diagram of a process 700 for providing location services. For example, actions set forth by process 700 may be performed by LBS AS 212. Also, particular implementations of process 700 may be illustrated in the message flow diagrams of FIGS. 2B, 4B, 6C, 6D and/or 12A. At block 702, one or more messages may be transmitted to an LS to configure the LS to detect a presence of a mobile device in a venue. At block 704, an LBS AS 212 may receive one or more messages from the LS comprising location parameters indicative of a location of the mobile device. Such location parameters may include, for example, an estimate of the location of the mobile device, measures of uncertainty or reliability of such estimates or measurements, indications of certain location related events for the mobile device such as the mobile device entering or leaving a certain geographic area such as a venue or a portion of a venue, just to provide a few examples. Block 706 may then provide location services to the mobile device based, at least in part, on the obtained location parameters (e.g., provide location aware content).

FIG. 12C is a flow diagram of a process 720 for providing location determination services. For example, actions set out in process 720 may be performed in whole or in part by LS 206. Also, particular implementations of process 720 may be illustrated in the message flow diagrams of FIGS. 2B, 3B, 4B, 5B, 6C, 6D and/or 12A. At block 722, one or more messages may be received from an LBS AS (e.g., LBS AS 212) comprising instructions to configure LS 206 to at least detect a presence of one or more mobile devices in a venue. At block 724, one or more messages may be transmitted to at least a portion of an ALN (e.g., ALN 202) to configure the ALN to detect the presence of the at least one of the one or more mobile devices in the venue based, at least in part, on the transmitted instructions. At block 726, one or more messages may be received from the ALN containing first location information sent by the ALN where the first location information is indicative of at least one of a presence or a location of the at least one of the one or more mobile devices. Optionally in block 726, LS 206 may engage in a positioning session with the at least one of the one or more mobile devices (e.g. using the OMA SUPL location solution). Block 728 may obtain an estimated location of the at least one of the one or more mobile devices based, at least in part, on the first location information and/or the positioning session. Block 730 may return second location information to the LBS AS based, at least in part, on the received second location information. For example, the second location information may comprise a computed estimate of a location of the at least one of the one or more mobile devices.

FIG. 12D is a flow diagram of a process 740 for obtaining location services (e.g., at a mobile device). For example, actions set out in process 740 may be performed in whole or in part by mobile device 204. Also, particular implementations of process 740 may be illustrated in the message flow diagram of FIGS. 6B and/or 6E. At block 742, a mobile device or an application in the mobile device may register with an LBS AS (e.g., LBS AS 212). At block 744, the mobile device or an application in the mobile device may detect entry of the mobile device into a venue. At block 746, the mobile device or an application in the mobile device may send a service request message to the LBS AS in response to detecting the entry of the mobile device into the venue. At block 748, the mobile device may engage in a positioning session with an LS where the LS obtains an estimate of a location of the mobile device. At block 750, the mobile device or an application in the mobile device may receive a location service from the LBS AS (e.g. such as receiving location aware map data content) based, at least in part, on the estimated location of the mobile device. [SE: the figures may need to be revised to reflect the above changes.]

Also shown in FIG. 13, a user interface 1135 may comprise any one of several devices such as, for example, a speaker, microphone, display device, vibration device, keyboard, touch screen, just to name a few examples. In a particular implementation, user interface 1135 may enable a user to interact with one or more applications hosted on mobile device 1100. For example, devices of user interface 1135 may store analog or digital signals on memory 1140 to be further processed by DSP(s) 1112 or general purpose processor 1111 in response to action from a user. Similarly, applications hosted on mobile device 1100 may store analog or digital signals on memory 1140 to present an output signal to a user. In another implementation, mobile device 1100 may optionally include a dedicated audio input/output (I/O) device 1170 comprising, for example, a dedicated speaker, microphone, digital to analog circuitry, analog to digital circuitry, amplifiers and/or gain control. It should be understood, however, that this is merely an example of how an audio I/O may be implemented in a mobile device, and that claimed subject matter is not limited in this respect. In another implementation, mobile device 1100 may comprise touch sensors 1162 responsive to touching or pressure on a keyboard or touch screen device.

Mobile device 1100 may also comprise a dedicated camera device 1164 for capturing still or moving imagery. Camera device 1164 may comprise, for example an imaging sensor (e.g., charge coupled device or CMOS imager), lens, analog to digital circuitry, frame buffers, just to name a few examples. In one implementation, additional processing, conditioning, encoding or compression of signals representing captured images may be performed at general purpose/application processor 1111 or DSP(s) 1112. Alternatively, a dedicated video processor 1168 may perform conditioning, encoding, compression or manipulation of signals representing captured images. Additionally, video processor 1168 may decode/decompress stored image data for presentation on a display device (not shown) on mobile device 1100.

Mobile device 1100 may also comprise sensors 1160 coupled to bus 1101 which may include, for example, inertial sensors and environment sensors that may enable mobile device 1100 to determine relative changes in location and/or current speed and heading. Inertial sensors of sensors 1160 may comprise, for example accelerometers (e.g., collectively responding to acceleration of mobile device 1100 in three dimensions), one or more gyroscopes or one or more magnetometers (e.g., to support one or more compass applications). Environment sensors of mobile device 1100 may comprise, for example, temperature sensors, barometric pressure sensors, ambient light sensors, camera imagers, microphones, just to name few examples. Sensors 1160 may generate analog or digital signals that may be stored in memory 1140 and processed by DPS(s) or general purpose application processor 1111 in support of one or more applications such as, for example, applications directed to positioning or navigation operations.

In a particular implementation, a digital map of an indoor area may be stored in a particular format in memory 1140. The digital map may have been obtained from messages containing navigation assistance data from a remote server. General purpose/application processor 1111 may execute instructions to processes the stored digital map to identify and classify component areas bounded by a perimeter of structures indicated in the digital map. As pointed out above, these executed instructions may specify identifying and characterizing egress segments in structures forming a perimeter bounding a component area and classifying the bounded component area based, at least in part, on a proportionality of a size of at least one identified egress segment to a size of at least one dimension of the bounded component area. In one implementation, a mobile device may further apply crowed sourced data (e.g., obtained from a location server) to confirm an inferences of an egress segment. For example, if there is a history of mobile devices moving through a feature presumed to be an egress segment, the feature may be confirmed as providing an egress segment.

In a particular implementation, mobile device 1100 may comprise a dedicated modem processor 1166 capable of performing baseband processing of signals received and down converted at wireless transceiver 1121 or SPS receiver 1155. Similarly, modem processor 1166 may perform baseband processing of signals to be up converted for transmission by wireless transceiver 1121. In alternative implementations, instead of having a dedicated modem processor, baseband processing may be performed by a general purpose processor or DSP (e.g., general purpose/application processor 1111 or DSP(s) 1112). It should be understood, however, that these are merely examples of structures that may perform baseband processing, and that claimed subject matter is not limited in this respect.

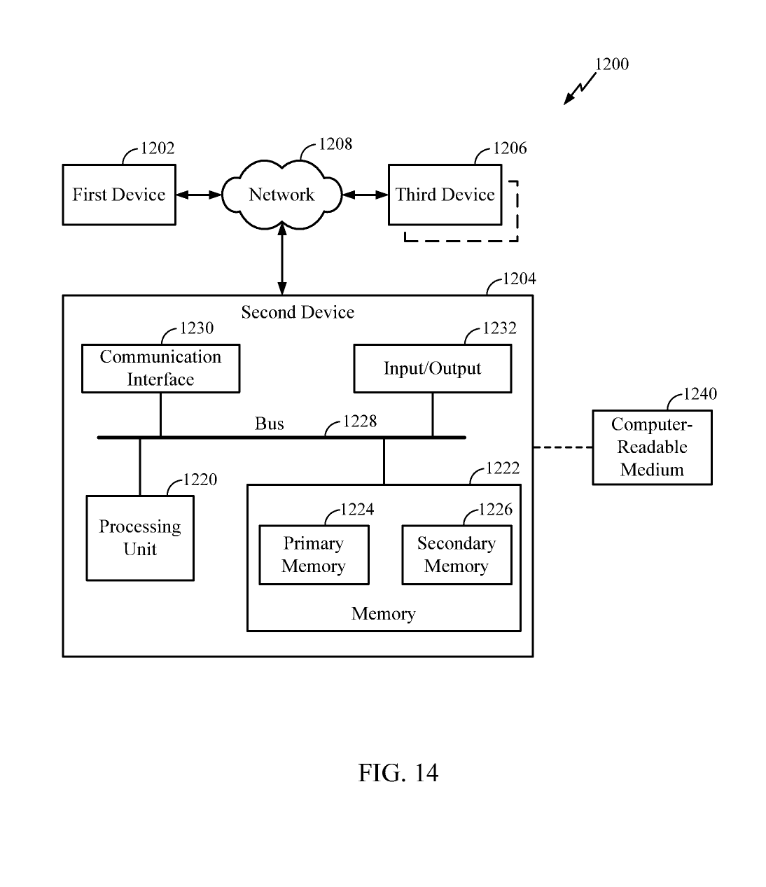

FIG. 14 is a schematic diagram illustrating an example system 1200 that may include one or more devices configurable to implement techniques or processes described above, for example, in connection with FIG. 1A. System 1200 may include, for example, a first device 1202, a second device 1204, and a third device 1206, which may be operatively coupled together through a wireless communications network 1208. In an aspect, first device 1202 may comprise a server capable of providing positioning assistance data such as, for example, a base station almanac. Also, in an aspect, wireless communications network 1208 may comprise one or more wireless access points, for example. However, claimed subject matter is not limited in scope in these respects.

First device 1202, second device 1204 and third device 1206, as shown in FIG. 14, may be representative of any device, appliance or machine (e.g., such as local transceiver 115, servers 140, 150 or 155 as shown in FIG. 1A or LS 206, LBS AS 212, ALN DB 208, Map DB 210 and/or one or more APs or Femto cells in ALN 202 as shown in FIG. 1C) that may be configurable to exchange data over wireless communications network 1208. By way of example but not limitation, any of first device 1202, second device 1204, or third device 1206 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or data storage service provider/system, a network service provider/system, an Internet or intranet service provider/system, a portal or search engine service provider/system, a wireless communication service provider/system; or any combination thereof. Any of the first, second, and third devices 1202, 1204, and 1206, respectively, may comprise one or more of a base station almanac server, a base station, or a mobile device in accordance with the examples described herein.

Similarly, wireless communications network 1208 (e.g., in a particular of implementation of network 130 shown in FIG. 1A), may be representative of one or more communication links, processes, or resources configurable to support the exchange of data between at least two of first device 1202, second device 1204, and third device 1206. By way of example but not limitation, wireless communications network 1208 may include wireless or wired communication links, telephone or telecommunications systems, data buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured of third device 1206, there may be additional like devices operatively coupled to wireless communications network 1208.

It is recognized that all or part of the various devices and networks shown in system 1200, and the processes and methods as further described herein, may be implemented using or otherwise including hardware, firmware, software, or any combination thereof.

Thus, by way of example but not limitation, second device 1204 may include at least one processing unit 1220 that is operatively coupled to a memory 1222 through a bus 1228.

Processing unit 1220 is representative of one or more circuits configurable to perform at least a portion of a data computing procedure or process. By way of example but not limitation, processing unit 1220 may include one or more processors, controllers, microprocessors, microcontrollers, application specific integrated circuits, digital signal processors, programmable logic devices, field programmable gate arrays, and the like, or any combination thereof.

Memory 1222 is representative of any data storage mechanism. Memory 1222 may include, for example, a primary memory 1224 or a secondary memory 1226. Primary memory 1224 may include, for example, a random access memory, read only memory, etc. While illustrated in this example as being separate from processing unit 1220, it should be understood that all or part of primary memory 1224 may be provided within or otherwise colocated/coupled with processing unit 1220.

In a particular implementation, a digital map of an indoor area may be stored in a particular format in memory 1222. Processing unit 1220 may execute instructions to processes the stored digital map to identify and classify component areas bounded by a perimeter of structures indicated in the digital map. As pointed out above, these executed instructions may specify identifying and characterizing egress segments in structures forming a perimeter bounding a component area and classifying the bounded component area based, at least in part, on a proportionality of a size of at least one identified egress segment to a size of at least one dimension of the bounded component area.

Secondary memory 1226 may include, for example, the same or similar type of memory as primary memory or one or more data storage devices or systems, such as, for example, a disk drive, an optical disc drive, a tape drive, a solid state memory drive, etc. In certain implementations, secondary memory 1226 may be operatively receptive of, or otherwise configurable to couple to, a computer-readable medium 1240. Computer-readable medium 1240 may include, for example, any non-transitory medium that can carry or make accessible data, code or instructions for one or more of the devices in system 1200. Computer-readable medium 1240 may also be referred to as a storage medium.

Second device 1204 may include, for example, a communication interface 1030 that provides for or otherwise supports the operative coupling of second device 1204 to at least wireless communications network 1208. By way of example but not limitation, communication interface 1230 may include a network interface device or card, a modem, a router, a switch, a transceiver, and the like.

Second device 1204 may include, for example, an input/output device 1232. Input/output device 1232 is representative of one or more devices or features that may be configurable to accept or otherwise introduce human or machine inputs, or one or more devices or features that may be configurable to deliver or otherwise provide for human or machine outputs. By way of example but not limitation, input/output device 1232 may include an operatively configured display, speaker, keyboard, mouse, trackball, touch screen, data port, etc.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, microcontrollers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a SingleCarrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“DAMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femtocell, utilized to extend cellular telephone service into a business or home. In such an implementation, one or more mobile devices may communicate with a femtocell via a code division multiple access (“CDMA”) cellular communication protocol, for example, and the femtocell may provide the mobile device access to a larger cellular telecommunication network by way of another broadband network such as the Internet.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

What is claimed is:

1. A method for providing location services in a venue at a Location Based Services Application Server (LBS AS) comprising:
transmitting one or more messages to a location server (LS) to configure the LS to detect a presence of a mobile device in the venue;
receiving one or more messages from the LS comprising location parameters indicative of a location of the mobile device; and
providing location services based on the received location parameters.

2. The method of claim 1, wherein the location services are provided to the mobile device.

3. The method of claim 2, wherein the location services comprise at least one of navigation assistance, direction finding or map provisioning.

4. The method of claim 1, wherein said location parameters comprise one or more measurement values enabling computation of an estimated location of the mobile device.

5. The method of claim 1, wherein the location services comprise provision of visitor analytics data to the venue.

6. The method of claim 1, wherein the received location parameters comprise at least one of an estimated location of the mobile device or an identity of the mobile device.

7. The method of claim 1 wherein configuring the LS comprises providing the LS with at least one of an identity for the mobile device or trigger events for sending the location parameters.

8. The method of claim 7, wherein the trigger events comprise at least one of detecting entry of the mobile device to the venue, a periodic time interval, entry to or departure from a particular area by the mobile device, or a change in an estimated location of the mobile device.

9. The method of claim 1, wherein configuring the LS and receiving the location parameters are performed using messages defined substantially according to an Open Mobile Alliance (OMA) Mobile Location Protocol (MLP).

10. The method of claim 1, and further comprising:
re-configuring the LS for the mobile device in response to the received location parameters;
receiving additional location parameters for the mobile device sent from the LS based, at least in part, on the re-configuration; and
providing additional location services based, at least in part, on the additional location parameters.

11. The method of claim 10, wherein re-configuring the LS comprises providing new trigger events for sending the additional location parameters.

12. The method of claim 11, wherein the new trigger events comprise at least one of a periodic time interval, entry to or departure from a particular area by the mobile device, or a change in the location of the mobile device.

13. The method of claim 2, wherein providing the location services further comprises providing venue map data.

14. The method of claim 13, wherein the map data is requested and obtained from a Map database.

15. A Location Based Services Application Server (LBS AS) comprising:
a communication interface to transmit messages to and receive messages from a communication network;
one or more processors to:
initiate transmission of one or more messages through said communication interface to a location server (LS) to configure the LS to detect a presence of a mobile device in a venue;
obtain one or more messages received at said communication interface from the LS comprising location parameters indicative of a location of the mobile device; and
initiate provisioning of location services based on the obtained location parameters.

16. An article comprising:
a non-transitory storage medium comprising machine-readable instructions stored thereon which are executable by a special purpose computing apparatus of a Location Based Application Server (LBS AS) to:
initiate transmission of one or more messages through a communication network to a location server (LS) to configure the LS to detect a presence of a mobile device in a venue;
obtain one or more messages received from the LS through the communication network comprising location parameters indicative of a location of the mobile device; and
initiate provisioning of location services based, at least in part, on the obtained location parameters.

17. A Location Based Services Application Server (LBS AS) comprising:
means for transmitting one or more messages to a location server (LS) to configure the LS to detect a presence of a mobile device in the venue;
means for receiving one or more messages from the LS comprising location parameters indicative of a location of the mobile device; and
means for providing location services based on the received location parameters.

18. A method for providing location services in a venue at a Location Server (LS) comprising:
receiving one or more messages from a Location Based Services Application Server (LBS AS) comprising instructions to configure a location server (LS) to at least detect a presence of one or more mobile devices in said venue;
transmitting one or more messages to at least a portion of an access/location network (ALN) to configure said ALN to detect said presence of said at least one of the one or more mobile devices in the venue based, at least in part, on said instructions;
receiving one or more messages from said ALN comprising first location information sent by the ALN, said first location information being indicative of a location of at least one of the one or more mobile devices;
obtaining second location information for the at least one of the one or more mobile devices based, at least in part, on the first location information; and
returning second location information to the LBS AS.

19. The method of claim 18, wherein the second location information comprises at least one of an estimated location of at least one of said one or more mobile devices or an identifier of at least one of the one or more mobile devices.

20. The method of claim 18, wherein the first location information comprises at least one of an identifier of at least one of the one or more mobile devices or measurements of signals received at the ALN from at least one of the one or more mobile devices.

21. The method of claim 18, wherein configuring the ALN comprises providing the ALN with at least one of an identifier of at least one mobile device or trigger events for sending the first location information.

22. The method of claim 21, wherein the trigger events comprise at least one of detecting a mobile device entering the venue, a periodic time interval or a change in a signal measurement of a signal transmitted from a mobile device.

23. The method of claim 18, wherein the instructions comprise at least one of an identifier of at least one of the one or more mobile devices or trigger events for returning the second location information.

24. The method of claim 23, wherein the trigger events comprise at least one of detection of a mobile device in the venue, a periodic timer event, entry to or departure from a particular area by a mobile device, or a change in the location of a mobile device.

25. The method of claim 18, wherein receiving the instructions and returning the second location information are performed using messages defined substantially according to an Open Mobile Alliance (OMA) Mobile Location Protocol (MLP).

26. The method of claim 18, wherein the second location information comprises a location estimate for at least one mobile device.

27. The method of claim 26, wherein obtaining the location estimate for the at least one mobile device further comprises obtaining ALN almanac data.

28. The method of claim 27, wherein the ALN almanac data is requested and obtained from an ALN database.

29. The method of claim 18, wherein the ALN comprises at least one of an IEEE 802.11 access point (AP), a Bluetooth AP or a femto cell.

30. The method of claim 29, wherein the femto cell supports providing service according to at least one of Code Division Multiple Access (CDMA), Wideband CDMA (WCDMA), Long Term Evolution LTE) or High Rate Packet Data (HRPD).

31. The method of claim 26, wherein obtaining the location estimate for the at least one mobile device further comprises invoking a positioning session with the at least one mobile device.

32. The method of claim 31, wherein the positioning session comprises at least one of an OMA Secure User Plane Location (SUPL) session or a positioning session according to a 3rd Generation Partnership Project (3GPP) or 3GPP2 control plane location solution.

33. A location server comprising:
a communication interface to transmit messages to and receive messages from a communication network;
one or more processors to:
obtain one or more messages from a Location Based Services Application Server (LBS AS) at said communication interface comprising instructions to configure a location server (LS) to at least detect a presence of one or more mobile devices in a venue;
initiate transmission of one or more messages through said communication interface to at least a portion of an access/location network (ALN) to configure said ALN to detect said presence of said at least one of the one or more mobile devices in the venue based, at least in part, on said instructions;
obtain one or more messages from said ALN through said communication interface comprising first location information sent by the ALN, said first location information being indicative of a location of at least one of the one or more mobile devices;
obtain second location information for the at least one of the one or more mobile devices based, at least in part, on the first location information; and
initiate transmission of said second location information through said communication interface to the LBS AS.

34. An article comprising:
a non-transitory storage medium comprising machine-readable instructions stored thereon which are executable by a special purpose computing apparatus of a location server to:
obtain one or more messages from a Location Based Services Application Server (LBS AS) comprising instructions to configure a location server (LS) to at least detect a presence of one or more mobile devices in a venue;
initiate transmission of one or more messages to at least a portion of an access/location network (ALN) to configure said ALN to detect said presence of said at least one of the one or more mobile devices in the venue based, at least in part, on said instructions;
obtain one or more messages from said ALN comprising first location information sent by the ALN, said first location information being indicative of a location of at least one of the one or more mobile devices;
obtain second location information for the at least one of the one or more mobile devices based, at least in part, on the first location information; and
initiate transmission of said second location information to the LBS AS.

35. A location server comprising:
means for receiving one or more messages from a Location Based Services Application Server (LBS AS) comprising instructions to configure a location server (LS) to at least detect a presence of one or more mobile devices in a venue;
means for transmitting one or more messages to at least a portion of an access/location network (ALN) to configure said ALN to detect said presence of said at least one of the one or more mobile devices in the venue based, at least in part, on said instructions;
means for receiving one or more messages from said ALN comprising first location information sent by the ALN, said first location information being indicative of a location of at least one of the one or more mobile devices;
means for obtaining second location for the at least one of the one or more mobile devices based, at least in part, on the first location information; and
means for returning second location information to the LBS AS.

36. A method for obtaining a location service in a venue by a mobile device comprising:
registering said mobile device with a Location Based Services Application Server (LBS AS);
detecting an entry of the mobile device to the venue;
sending a service request message to the LBS AS in response to detecting the entry;
engaging in a positioning session with a location server (LS), wherein the LS obtains an estimated location of the mobile device; and
receiving the location service from the LBS AS based, at least in part, on said estimated location of the mobile device.

37. The method of claim 36, wherein the mobile device originates the positioning session and provides the estimated location to the LBS AS in the service request message.

38. The method of claim 36, wherein the LS invokes the positioning session based at least in part on the service request message sent to the LBS AS.

39. The method of claim 36, wherein registering with the LBS AS comprises providing the LBS AS with at least one of an identifier of positioning capabilities for the mobile device or service preferences for the mobile device.

40. The method of claim 36, wherein the service request message comprises at least one of an identifier of the mobile device, a specific service being requested or positioning capabilities of the mobile device.

41. The method of claim 36, wherein the positioning session comprises at least one of an OMA Secure User Plane Location (SUPL) session, or a positioning session according to a 3rd Generation Partnership Project (3GPP) or 3GPP2 control plane location solution.

42. The method of claim 36, wherein detecting entry of said mobile device comprises acquisition of a signal transmitted by at least one of a radio frequency ID tag, WiFi Access Point or a Femtocell.

43. The method of claim 36, and further comprising:
receiving positioning assistance data from a remote server;
computing said estimated location based, at least in part, on said positioning assistance data; and
transmitting said computed estimated location to said LS.

44. A mobile device comprising:
a transceiver to transmit messages to and receive messages from a communication network;
one or more processors to:
initiate transmission of one or more messages through said transceiver to register said mobile device with a Location Based Services Application Server (LBS AS);
detect an entry of the mobile device to a venue;
initiate transmission of a service request message through said transceiver to said LBS AS in response to detecting the entry;
engage in a positioning session with a location server (LS), wherein the LS obtains an estimate of a location of the mobile device; and
receive location service from the LBS AS based, at least in part, on said estimate of said location of the mobile device.

45. An article comprising:
a storage medium comprising machine-readable instructions stored thereon which are executable by a special purpose computing apparatus of a mobile device to:
register said mobile device with a Location Based Services Application Server (LBS AS);
detect an entry of the mobile device to the venue;
initiate transmission of a service request message to the LBS AS in response to detecting the entry;
engage in a positioning session with a location server (LS), wherein the LS obtains an estimate of a location of the mobile device; and
receive a location service from the LBS AS based, at least in part, on said estimate of said location of the mobile device.

46. An apparatus comprising:
means for registering a mobile device with a Location Based Services Application Server (LBS AS);
means for detecting an entry of the mobile device to the venue;
means for sending a service request message to the LBS AS in response to detecting the entry;
means for engaging in a positioning session with a location server (LS), wherein the LS obtains an estimate of a location of the mobile device; and
means for receiving a location service from the LBS AS based, at least in part, on said estimate of said location of the mobile device.
